(19) United States
(12) Patent Application Publication
(10) Pub. No.: US 2017/0351134 A1
(43) Pub. Date: Dec. 7, 2017

(54) PROJECTION MEMBER AND METHOD FOR MANUFACTURING PROJECTION MEMBER

(71) Applicant: Sharp Kabushiki Kaisha, Sakai City, Osaka (JP)

(72) Inventors: Takafumi SHIMATANI, Sakai City (JP); Naru USUKURA, Sakai City (JP); Hiromi KATOH, Sakai City (JP); Youzo FUJIMURA, Sakai City (JP)

(21) Appl. No.: 15/537,070

(22) PCT Filed: Dec. 11, 2015
(86) PCT No.: PCT/JP2015/084815

§ 371 Date: Jun. 16, 2017

(30) Foreign Application Priority Data
Dec. 18, 2014 (JP) 2014-256441

(51) Int. Cl. G02F 1/137; G02F 1/1335; G02F 1/1347

(52) U.S. Cl. CPC G02F 1/13718; G02F 1/1347; G02F 1/133514; G02F 2001/13478

(57) ABSTRACT

A combiner 12 includes a cholesteric liquid crystal layer 17 that imparts an optical effect to light, and a cholesteric liquid crystal layer carrier 18 of a plate shape that is an optical functional layer carrier having a plate surface with the cholesteric liquid crystal layer 17 disposed thereon, being subjected to biaxial stretching in such a manner that one of two intersecting directions along the plate surface is a low stretching direction in which a stretch ratio is relatively low and that the other is a high stretching direction in which the stretch ratio is relatively high, and being subjected to biaxial deformation to have the plate surface deformed into a curved shape in such a manner that a large elongation amount direction in which the amount of elongation by deformation is relatively large matches the low stretching direction and that a small elongation amount direction in which the amount of elongation by deformation is relatively small matches the high stretching direction.

### TECHNICAL FIELD

The present invention relates to a projection member and a method for manufacturing a projection member.

### BACKGROUND ART

In the related art, known is a reflective liquid crystal display device that performs displaying by reflecting extraneous light such as sunlight or indoor illumination light, and one example thereof is disclosed in PTL 1. In PTL 1, disclosed is a stacked color cholesteric liquid crystal display element in which a first blue liquid crystal layer, a second green liquid crystal layer, and a third red liquid crystal layer are stacked in order from an element observation side. The stacked color cholesteric liquid crystal display element includes a green cut filter layer that is arranged between the green liquid crystal layer and the red liquid crystal layer and selectively absorbs light of a wavelength of less than or equal to 600 nm, thereby being capable of removing noise light of unnecessary color.

### CITATION LIST

### Patent Literature

PTL 1: International Publication No. 2007/004286

### Technical Problem

A color cholesteric liquid crystal display element such as that disclosed in above PTL 1 may be used in a combiner for reflecting and projecting light from a picture source in a head-up display. The picture projected by the combiner may be required to be displayed in an enlarged manner in the head-up display. However, if enlarged display function is added to the combiner in the configuration in which the above color cholesteric liquid crystal display element is used in the combiner, degradation of display quality may be caused.

### SUMMARY OF INVENTION

The present invention is conceived on the basis of above matters, and an object thereof is to reduce degradation of display quality.

### Solution to Problem

A projection member of the present invention includes an optical functional layer that imparts an optical effect to light; and an optical functional layer carrier of a plate shape that has a plate surface with the optical functional layer disposed thereon, is subjected to biaxial stretching or uniaxial stretching in such a manner that one of two intersecting directions along the plate surface is a low stretching direction in which a stretch ratio is relatively low or a non-stretching direction in which stretching is not performed and that the other is a high stretching direction in which the stretch ratio is relatively high or a stretching direction in which stretching is performed, and is subjected to biaxial deformation or uniaxial deformation to have the plate surface deformed into a curved shape in such a manner that a large elongation amount direction in which the amount of elongation by deformation is relatively large or a deformation direction in which deformation is generated matches the low stretching direction or the non-stretching direction and that a small elongation amount direction in which the amount of elongation by deformation is relatively small or a non-deformation direction in which deformation is not generated matches the high stretching direction or the stretching direction.

Accordingly, since the optical functional layer carrier of a plate shape in which the optical functional layer imparting an optical effect to light is disposed on the plate surface is subjected to biaxial stretching or uniaxial stretching, the optical functional layer carrier can acquire sufficient strength or the like. In addition, since the optical functional layer carrier is subjected to biaxial deformation or uniaxial deformation to have the plate surface of a curved shape, a projected picture by light to which an optical effect is imparted by the optical functional layer disposed on the plate surface can be visually recognized by a user in an enlarged form.

In the case of biaxial deformation of the optical functional layer carrier, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the optical functional layer carrier is suitably relieved, and creases and the like are unlikely to be generated in the optical functional layer. In the case of uniaxial deformation of the optical functional layer carrier, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the optical functional layer carrier is suitably relieved, and creases and the like are unlikely to be generated in the optical functional layer. Accordingly, display quality related to the projected picture by light to which an optical effect is imparted by the optical functional layer is unlikely to be degraded.

The following configurations are preferable as embodiments of the projection member of the present invention.

(1) The optical functional layer is a light reflection layer that reflects light. Accordingly, the light reflection layer reflecting light enables a projected picture by reflective light to be visually recognized by the user. Since creases and the like are unlikely to be generated in the light reflection layer, display quality related to the projected picture based on reflective light is unlikely to be degraded.

(2) The light reflection layer is configured of a cholesteric liquid crystal layer that selectively reflects any one of left handed circularly-polarized light and right handed circularly-polarized light in a specific wavelength range. Accordingly, the cholesteric liquid crystal layer selectively reflecting any one of left handed circularly-polarized light and right handed circularly-polarized light in a specific wavelength range enables the projected picture by reflective light to be visually recognized by the user. Since creases and the like are unlikely to be generated in the cholesteric liquid crystal layer, display quality related to the projected picture based on reflective light is unlikely to be degraded.

(3) The cholesteric liquid crystal layer has a stack structure of a first cholesteric liquid crystal layer and a second cholesteric liquid crystal layer selectively reflecting the same circularly-polarized light as the first cholesteric liquid crystal layer and includes a ½ wavelength retardation plate that is arranged in a form of being interposed between the first cholesteric liquid crystal layer and the second cholesteric liquid crystal layer and converts any one of left handed circularly-polarized light and right handed circularly-polarized light into another circularly-polarized light, and the ½ wavelength retardation plate is subjected to biaxial stretching or uniaxial stretching in such a manner that one of two intersecting directions along a plate surface thereof is the low stretching direction or the non-stretching direction and that the other is the high stretching direction or the stretching direction, and furthermore, is subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction. Accordingly, since the ½ wavelength retardation plate arranged in the form of being interposed between the first cholesteric liquid crystal layer and the second cholesteric liquid crystal layer can convert any one of left handed circularly-polarized light and right handed circularly-polarized light into another circularly-polarized light, the first cholesteric liquid crystal layer and the second cholesteric liquid crystal layer that selectively reflect the same circularly-polarized light can efficiently reflect light to be used in projection, and the efficiency of use of light is excellent. In addition, in the case of biaxial deformation of the ½ wavelength retardation plate, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation generated by deformation is unlikely to cause phase modulation. In the case of uniaxial deformation of the ½ wavelength retardation plate, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation generated by deformation is unlikely to cause phase modulation. Accordingly, since the ½ wavelength retardation plate can properly exhibit optical performance, display quality related to a projected picture by light to which an optical effect is imparted by the ½ wavelength retardation plate is unlikely to be degraded.

(4) The projection member includes a second optical functional layer that imparts an optical effect to light; and a second optical functional layer carrier that has a plate surface with the second optical functional layer disposed thereon, is directly or indirectly bonded to the optical functional layer carrier, is subjected to biaxial stretching or uniaxial stretching in such a manner that one of two intersecting directions along the plate surface is the low stretching direction or the non-stretching direction and that the other is the high stretching direction or the stretching direction, and furthermore, is subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction. Accordingly, since the second optical functional layer carrier of a plate shape in which the second optical functional layer imparting an optical effect to light is disposed on the plate surface is subjected to biaxial stretching or uniaxial stretching, the second optical functional layer carrier can acquire sufficient strength or the like. In addition, the second optical functional layer carrier is directly or indirectly bonded to the optical functional layer carrier and is subjected to biaxial deformation or uniaxial deformation as follows. That is, in the case of biaxial deformation of the second optical functional layer carrier, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the second optical functional layer carrier is suitably relieved, and creases and the like are unlikely to be generated in the second optical functional layer. In the case of uniaxial deformation of the second optical functional layer carrier, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the second optical functional layer carrier is suitably relieved, and creases and the like are unlikely to be generated in the second optical functional layer. Accordingly, the optical performance of the second optical functional layer can be favorably secured.

(5) The second optical functional layer is configured of any of an antireflection layer that prevents reflection of light, an ultraviolet ray absorption layer that selectively absorbs ultraviolet rays, and an infrared ray absorption layer that selectively absorbs infrared rays. Accordingly, the optical performance of the second optical functional layer configured of any of the antireflection layer, the ultraviolet ray absorption layer, and the infrared ray absorption layer can be favorably secured.

(6) The projection member includes a substrate of a plate shape that has a larger plate thickness than the optical functional layer carrier, is directly or indirectly bonded to the optical functional layer carrier or the optical functional layer, and is subjected to biaxial deformation or uniaxial deformation in such a manner that one of two intersecting directions along a plate surface thereof is the large elongation amount direction or the deformation direction and that the other is the small elongation amount direction or the non-deformation direction. Accordingly, the substrate that has a plate shape of a larger plate thickness than the optical functional layer carrier independently functions to maintain the shape of the projection member in a state after biaxial deformation or uniaxial deformation.

(7) A recess portion of which a plan view shape is a circular shape, an elliptic shape, or a grid shape in a case of the biaxial deformation of the substrate and of which the plan view shape is a straight linear shape extending in a form of following the deformation direction or a grid shape in a case of the uniaxial deformation of the substrate is disposed in the substrate. The substrate, since having a plate shape of a larger plate thickness than the optical functional layer carrier, is unlikely to be subjected to biaxial deformation or uniaxial deformation and is subjected to relatively great stress by deformation compared with the optical functional layer carrier. Thus, the stress may adversely affect the optical functional layer carrier and the optical functional layer. Regarding this point, the recess portion is disposed in the substrate, and the plan view shape of the recess portion is a circular shape, an elliptic shape, or a grid shape in the case of biaxial deformation of the substrate. Thus, biaxial deformation of the substrate can be facilitated. In the case of uniaxial deformation of the substrate, the recess portion is disposed in such a manner that the plan view shape of the recess portion is a straight linear shape extending in the form of following the deformation direction or a grid shape. Thus, uniaxial deformation of the substrate can be facilitated. Accordingly, stress that may be exerted by deformation on the substrate is relieved, and the stress is unlikely to affect the optical functional layer carrier and the optical functional layer. Thus, creases and the like are unlikely to be generated in the optical functional layer.

(8) A recess portion of which a plan view shape is a circular shape, an elliptic shape, or a grid shape in a case of the biaxial deformation of the optical functional layer carrier and of which the plan view shape is a straight linear shape extending in a form of following the deformation direction or a grid shape in a case of the uniaxial deformation of the optical functional layer carrier is disposed in the optical functional layer carrier. Accordingly, since the plan view shape of the recess portion is a circular shape, an elliptic shape, or a grid shape in the case of biaxial deformation of the optical functional layer carrier, biaxial deformation of the optical functional layer carrier can be facilitated. In the case of uniaxial deformation of the optical functional layer carrier, the recess portion is disposed in such a manner that the plan view shape of the recess portion is a straight linear shape extending in the form of following the deformation direction or a grid shape. Thus, uniaxial deformation of the optical functional layer carrier can be facilitated. Accordingly, stress that may be exerted by deformation on the optical functional layer carrier is relieved, and creases and the like are unlikely to be generated in the optical functional layer disposed on the plate surface of the optical functional layer carrier.

(9) The recess portion is filled with a transparent resin material that has the same refractive index as the substrate or the optical functional layer carrier. Accordingly, filling the recess portion with the transparent resin material having the same refractive index as the substrate or the optical functional layer carrier makes diffuse reflection unlikely to be generated in the interface of the recess portion. Accordingly, display quality is more unlikely to be degraded.

(10) The substrate or the optical functional layer carrier, in which the recess portion is disposed, is arranged on the opposite side of the optical functional layer from a side where the light is supplied. Accordingly, an optical effect is imparted to light before the recess portion by the optical functional layer. Accordingly, the optical performance of the optical functional layer being degraded by the recess portion is avoided.

A method for manufacturing a projection member of the present invention includes a stretching step of performing biaxial stretching or uniaxial stretching of an optical functional layer carrier of a plate shape in such a manner that one of two intersecting directions along a plate surface of the optical functional layer carrier is a low stretching direction in which a stretch ratio is relatively low or a non-stretching direction in which stretching is not performed and that the other is a high stretching direction in which the stretch ratio is relatively high or a stretching direction in which stretching is performed; an optical functional layer forming step of forming an optical functional layer on the plate surface of the optical functional layer carrier in a flat state; and a deforming step of deforming the optical functional layer carrier along with the optical functional layer to make the plate surface have a curved shape by biaxial deformation or uniaxial deformation in such a manner that a large elongation amount direction in which the amount of elongation by deformation is relatively large or a deformation direction in which deformation is generated matches the low stretching direction or the non-stretching direction and that a small elongation amount direction in which the amount of elongation by deformation is relatively small or a non-deformation direction in which deformation is not generated matches the high stretching direction or the stretching direction.

Accordingly, since the optical functional layer carrier of a plate shape in which the optical functional layer imparting an optical effect to light is disposed on the plate surface is subjected to biaxial stretching or uniaxial stretching in the stretching step, the optical functional layer carrier can acquire sufficient strength or the like. In addition, since the optical functional layer carrier is subjected to biaxial deformation or uniaxial deformation to have the plate surface of a curved shape in the deforming step, a projected picture by light to which an optical effect is imparted by the optical functional layer disposed on the plate surface can be visually recognized by a user in an enlarged form.

In the deforming step, in the case of biaxial deformation of the optical functional layer carrier, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the optical functional layer carrier is suitably relieved, and creases and the like are unlikely to be generated in the optical functional layer. In the deforming step, in the case of uniaxial deformation of the optical functional layer carrier, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the optical functional layer carrier is suitably relieved, and creases and the like are unlikely to be generated in the optical functional layer. Accordingly, display quality related to the projected picture by light to which an optical effect is imparted by the optical functional layer is unlikely to be degraded.

The following configurations are preferable as embodiments of the method for manufacturing a projection member of the present invention.

(1) The method for manufacturing a projection member includes a substrate bonding step of directly or indirectly bonding the optical functional layer to a substrate of a plate shape having a larger plate thickness than the optical functional layer carrier, the substrate bonding step being performed between the optical functional layer forming step and the deforming step; and a carrier detaching step of detaching the optical functional layer carrier from the optical functional layer, the carrier detaching step being performed after at least the deforming step has been performed. Accordingly, since, in the substrate bonding step, the substrate having a plate shape of a larger plate thickness than the optical functional layer carrier, is directly or indirectly bonded to the optical functional layer, the optical functional layer is held by the substrate even if the carrier detaching step is performed after the deforming step to detach the optical functional layer carrier from the optical functional layer. Accordingly, the projection member can be thin and lightweight. In the deforming step, the optical functional layer carrier makes creases and the like unlikely to be generated in the optical functional layer.

(2) The method for manufacturing a projection member includes a substrate bonding step of directly or indirectly bonding the optical functional layer carrier or the optical functional layer to a substrate of a plate shape having a larger plate thickness than the optical functional layer carrier, the substrate bonding step being performed between the optical functional layer forming step and the deforming step; a recess portion forming step of forming a recess portion in at least any one of a plate surface of the optical functional layer carrier on the opposite side from the optical functional layer side and a plate surface of the substrate on the opposite side from the optical functional layer carrier or optical functional layer side, the recess portion forming step being performed prior to at least the deforming step, the plan view shape of the recess portion being a circular shape, an elliptic shape, or a grid shape in a case of the biaxial deformation in the deforming step, and the plan view shape of the recess portion being a straight linear shape extending in a form of following the deformation direction or a grid shape in a case of the uniaxial deformation in the deforming step; and a recess portion removing step of removing the recess portion, the recess portion removing step being performed after at least the deforming step has been performed. Accordingly, the recess portion that is formed in at least any one of the plate surface of the optical functional layer carrier on the opposite side from the optical functional layer side and the plate surface of the substrate on the opposite side from the optical functional layer carrier or optical functional layer side in the recess portion forming step can facilitate biaxial deformation of at least any one of the optical functional layer carrier and the substrate in the deforming step since the plan view shape of the recess portion is a circular shape, an elliptic shape, or a grid shape in the case of biaxial deformation of the optical functional layer carrier in the deforming step. In the case of uniaxial deformation of the optical functional layer carrier in the deforming step, the recess portion of which the plan view shape is a straight linear shape extending in the form in the deformation direction or a grid shape is disposed. Thus, the recess portion can facilitate uniaxial deformation of at least any one of the optical functional layer carrier and the substrate in the deforming step. Accordingly, stress that may be exerted by deformation on the optical functional layer carrier is relieved, and creases and the like are unlikely to be generated in the optical functional layer disposed on the plate surface of the optical functional layer carrier. In the recess portion removing step that is performed after at least the deforming step, the recess portion is removed. Thus, diffuse reflection of light being caused by the recess portion can be avoided, and degradation of display quality is further reduced.

(3) In the stretching step, the optical functional layer carrier is heated to a predetermined heat setting temperature, and in the deforming step, the optical functional layer carrier and the optical functional layer are subjected to thermal pressing in a temperature environment of higher than or equal to a glass transition temperature of the optical functional layer carrier and less than or equal to the heat setting temperature in the stretching step. If the temperature environment in thermal pressing performed in the deforming step is lower than the glass transition temperature of the optical functional layer carrier, the deformed shape of the optical functional layer carrier is unlikely to be maintained. Conversely, if the temperature environment is higher than the heat setting temperature in the stretching step, contraction may be generated in the optical functional layer carrier. Regarding this point, in the deforming step, as described above, the optical functional layer carrier and the optical functional layer are subjected to thermal pressing in a temperature environment of higher than or equal to the glass transition temperature of the optical functional layer carrier and less than or equal to the heat setting temperature in the stretching step. Thus, the deformed shape of the optical functional layer carrier can be maintained, and contraction being generated in the optical functional layer carrier can be avoided.

### Advantageous Effects of Invention

According to the present invention, degradation of display quality can be reduced.

### BRIEF DESCRIPTION OF DRAWINGS

FIG. 1 is a side view illustrating a schematic configuration of a head-up display according to Embodiment 1 of the present invention in a state of being mounted in an automobile.

FIG. 2 is a side view illustrating a positional relationship between a combiner and a projection device constituting the head-up display.

FIG. 3 is a plan view of the combiner.

FIG. 4 is a long edge side view of the combiner.

FIG. 5 is a perspective view of a light reflection unit constituting the combiner.

FIG. 6 is a short edge side sectional view of the light reflection unit.

FIG. 7 is a long edge side sectional view of the light reflection unit.

FIG. 8 is a table illustrating numerical values such as an exterior shape and physical properties related to the combiner.

FIG. 9 is a plan view illustrating a step of performing biaxial stretching of a cholesteric liquid crystal layer carrier (stretching step).

FIG. 10 is a short edge side sectional view illustrating a step of forming a cholesteric liquid crystal layer on a plate surface of the cholesteric liquid crystal layer carrier (cholesteric liquid crystal layer forming step).

FIG. 11 is a short edge side sectional view illustrating a state before bonding of the cholesteric liquid crystal layer carrier and a substrate (substrate bonding step).

FIG. 12 is a short edge side sectional view illustrating a state after bonding of the cholesteric liquid crystal layer carrier and the substrate (substrate bonding step).

FIG. 13 is a short edge side sectional view illustrating a step of performing biaxial deformation of the light reflection unit (deforming step).

FIG. 14 is a short edge side sectional view of a light reflection unit constituting a combiner according to Embodiment 2 of the present invention.

FIG. 15 is a long edge side sectional view of the light reflection unit.

FIG. 16 is a bottom view of the light reflection unit.

FIG. 17 is a sectional view illustrating a step of forming a recess portion in the plate surface of a substrate (recess portion forming step).

FIG. 18 is a sectional view illustrating a state of a cholesteric liquid crystal layer carrier being bonded to the substrate in which the recess portion is formed (substrate bonding step).

FIG. 19 is a sectional view illustrating a step of performing biaxial deformation of the light reflection unit (deforming step).

FIG. 20 is a short edge side sectional view of a light reflection unit constituting a combiner according to Embodiment 3 of the present invention.

FIG. 21 is a short edge side sectional view of a light reflection unit constituting a combiner according to Embodiment 4 of the present invention and is a sectional view illustrating a state before removal of a recess portion.

FIG. 22 is a sectional view illustrating a state of the recess portion being removed.

FIG. 23 is a short edge side sectional view of a light reflection unit constituting a combiner according to Embodiment 5 of the present invention.

FIG. 24 is a sectional view illustrating a state before biaxial deformation of a light reflection unit.

FIG. 25 is a short edge side sectional view of a light reflection unit constituting a combiner according to Embodiment 6 of the present invention.

FIG. 26 is a short edge side sectional view of a light reflection unit constituting a combiner according to Embodiment 7 of the present invention.

FIG. 27 is a short edge side sectional view of a light reflection unit constituting a combiner according to Embodiment 8 of the present invention.

FIG. 28 is a short edge side sectional view of a light reflection unit constituting a combiner according to Embodiment 9 of the present invention.

FIG. 29 is a short edge side sectional view of a light reflection unit constituting a combiner according to Embodiment 10 of the present invention.

FIG. 30 is a short edge side sectional view of a light reflection unit constituting a combiner according to Embodiment 11 of the present invention.

FIG. 31 is a short edge side sectional view illustrating a state before biaxial deformation of a light reflection unit constituting a combiner according to Embodiment 12 of the present invention.

FIG. 32 is a short edge side sectional view illustrating a step of performing biaxial deformation of the light reflection unit.

FIG. 33 is a short edge side sectional view of a light reflection unit constituting a combiner according to Embodiment 13 of the present invention.

FIG. 34 is a short edge side sectional view of a light reflection unit constituting a combiner according to Embodiment 14 of the present invention.

FIG. 35 is a short edge side sectional view of a light reflection unit constituting a combiner according to Embodiment 15 of the present invention.

FIG. 36 is a short edge side sectional view of a light reflection unit constituting a combiner according to Embodiment 16 of the present invention.

FIG. 37 is a short edge side sectional view illustrating a state before biaxial deformation of a light reflection unit constituting a combiner according to Embodiment 17 of the present invention.

FIG. 38 is a short edge side sectional view illustrating a step of performing biaxial deformation of the light reflection unit.

FIG. 39 is a short edge side sectional view illustrating a step of removing a cholesteric liquid crystal layer carrier and an antireflection coat carrier from the light reflection unit.

FIG. 40 is a short edge side sectional view of a light reflection unit constituting a combiner according to Embodiment 18 of the present invention.

FIG. 41 is a short edge side sectional view of a light reflection unit constituting a combiner according to Embodiment 19 of the present invention.

FIG. 42 is a short edge side sectional view of a light reflection unit constituting a combiner according to Embodiment 20 of the present invention.

FIG. 43 is a bottom view of a light reflection unit constituting a combiner according to Embodiment 21 of the present invention.

FIG. 44 is a short edge side sectional view of the light reflection unit.

FIG. 45 is a long edge side sectional view of the light reflection unit.

FIG. 46 is a bottom view of a light reflection unit constituting a combiner according to Embodiment 22 of the present invention.

FIG. 47 is a short edge side sectional view of the light reflection unit.

FIG. 48 is a long edge side sectional view of the light reflection unit.

FIG. 49 is a perspective view of a light reflection unit constituting a combiner according to Embodiment 23 of the present invention.

FIG. 50 is a bottom view of the light reflection unit.

FIG. 51 is a perspective view of a light reflection unit constituting a combiner according to Embodiment 24 of the present invention.

FIG. 52 is a bottom view of the light reflection unit.

FIG. 53 is a bottom view of a light reflection unit constituting a combiner according to Embodiment 25 of the present invention.

### DESCRIPTION OF EMBODIMENTS

### Embodiment 1

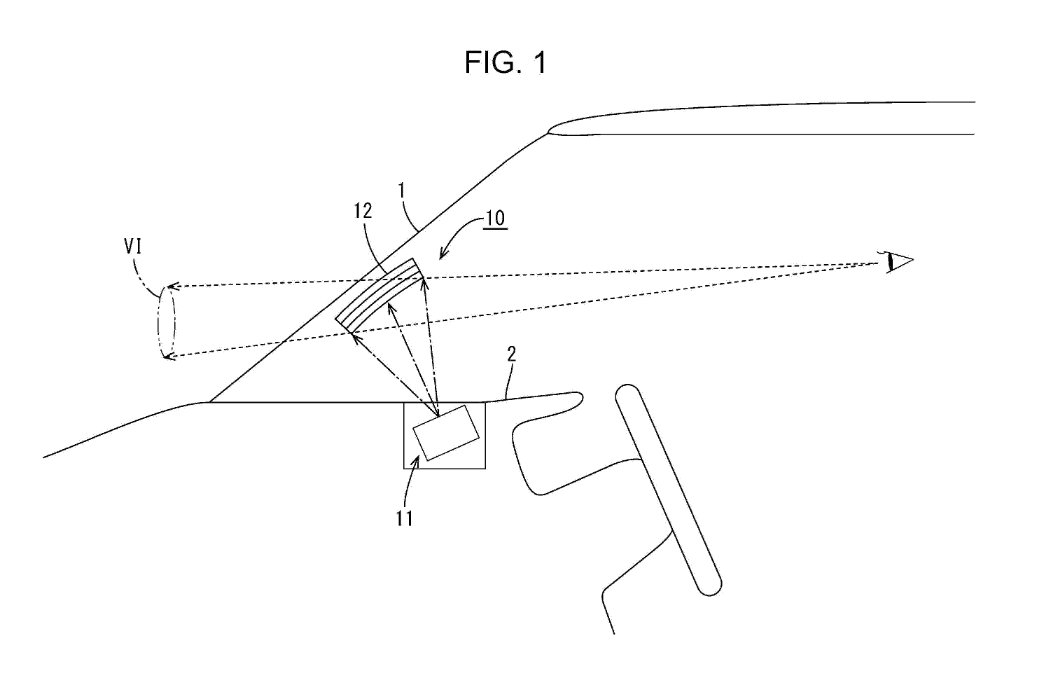

Embodiment 1 of the present invention will be described with FIG. 1 to FIG. 13. The present embodiment will illustrate a head-up display (projection display device) 10 that is mounted in an automobile. The head-up display 10 displays various types of information such as a driving speed, various alerts, and map information over a windshield 1 as if a virtual image VI exists in the front field of view of a driver at the time of driving, thereby being capable of reducing movements of the line of sight of the driver during driving.

As illustrated in FIG. 1, the head-up display 10 is configured of a projection device 11 that is accommodated in a dashboard 2 and projects a picture, and a combiner (projection member) 12 that is arranged in the form of facing the windshield 1 and projects the picture projected from the projection device 11 to be observed as the virtual image VI by an observer such as the driver. The combiner 12 is arranged in the form (backwards inclined attitude) of being parallel to the windshield 1 that is arranged to be inclined backwards from the vertical direction, and the projection device 11 is arranged in the dashboard 2 in the form of forming an angle of elevation with respect to the combiner 12.

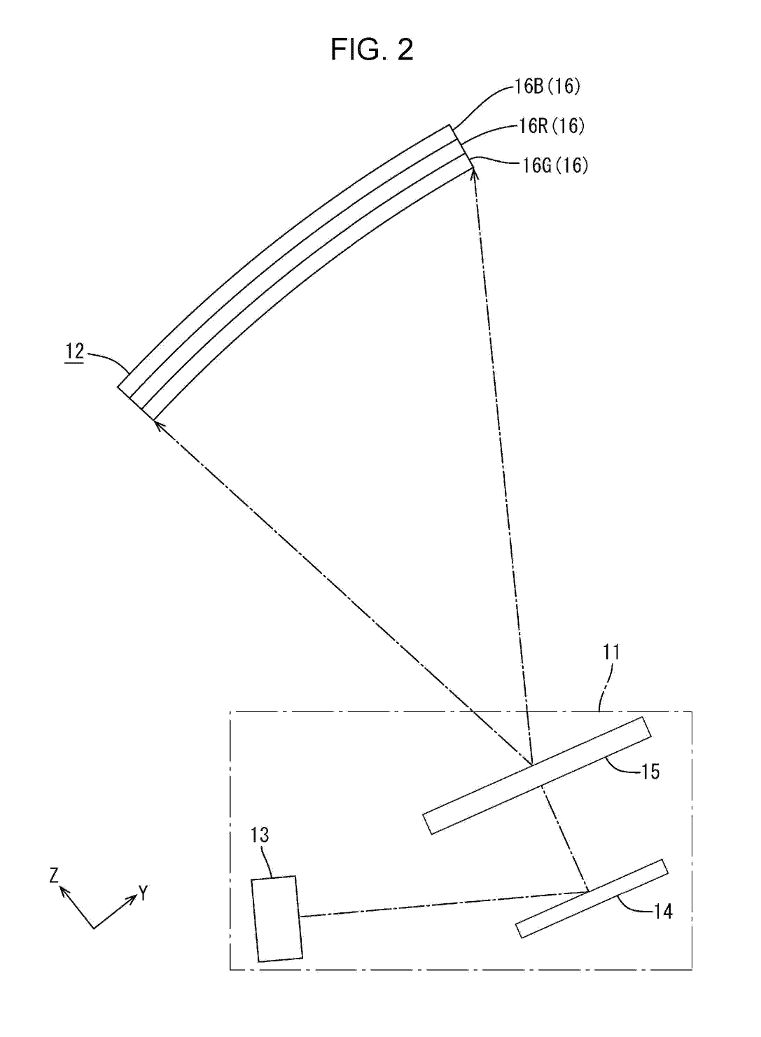

As illustrated in FIG. 2, the projection device 11 is configured of a laser diode (illuminant) 13, a MEMS mirror element (display element) 14 that displays a picture by using light from the laser diode 13, and a screen 15 to which the picture displayed on the MEMS mirror element 14 is projected in an enlarged form. The “MEMS” referred hereto is “micro electro mechanical systems”. FIG. 2 illustrates the head-up display 10 in an attitude where the height direction of the drawing matches the height direction (a direction that is orthogonal with respect to the horizontal direction) of the combiner 12.

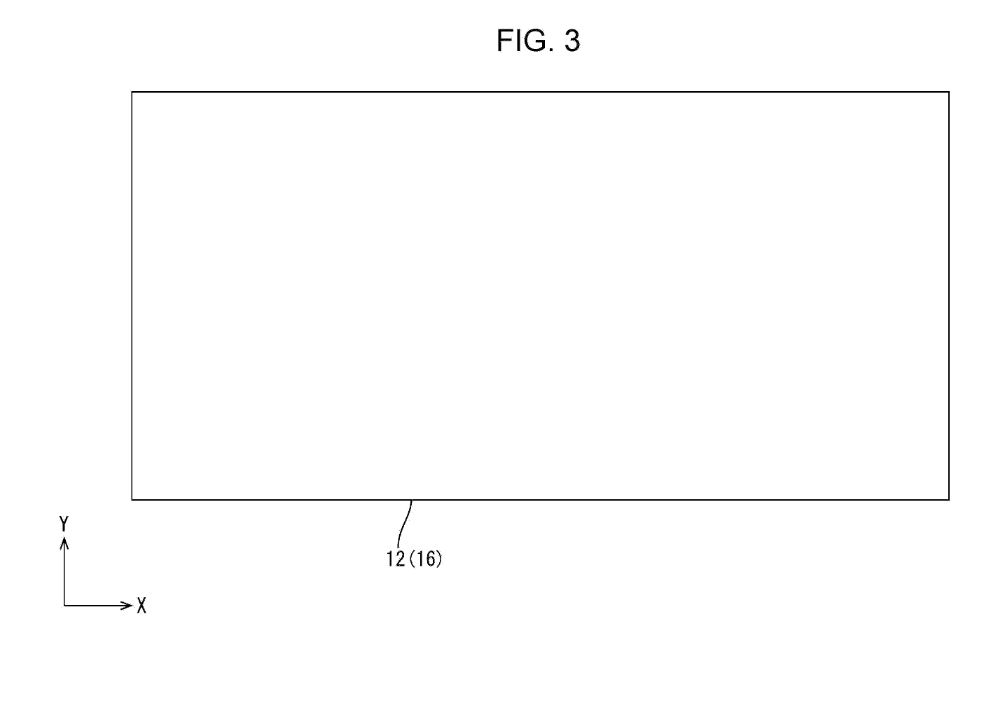

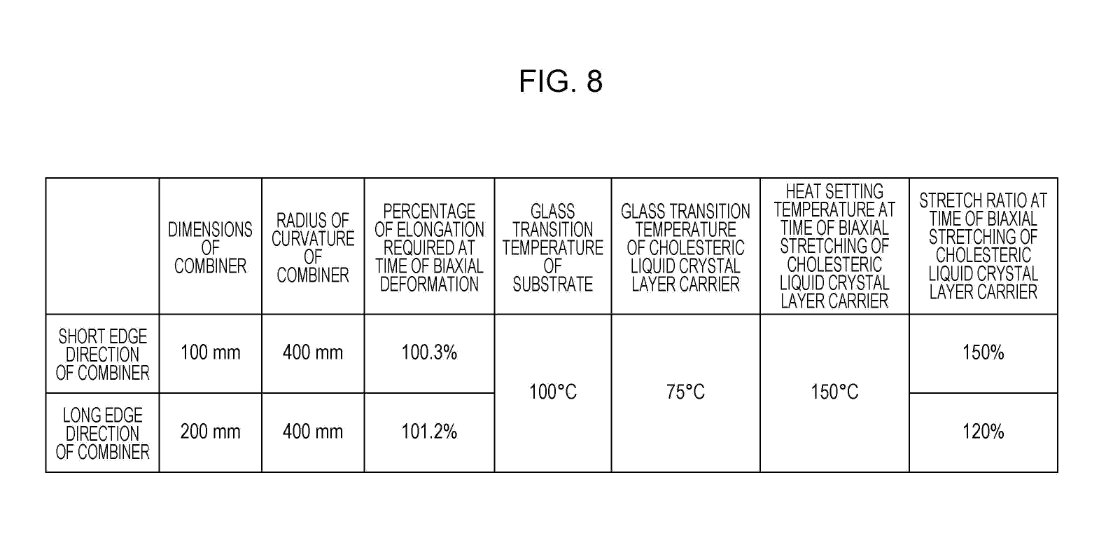

As illustrated in FIG. 1, the combiner 12 is arranged in a position slightly separated inwards from the windshield 1 and is supported in the position by being attached to, for example, a support component disposed on the dashboard 2 or a sun visor (none is illustrated). As illustrated in FIG. 3, the combiner 12 has a widthwise long rectangular shape (quadrangular shape) that resembles the area of view (eye-box) of the observer such as the driver. Regarding specific dimensions, the combiner 12 has a long edge dimension of, for example, approximately 200 mm and a short edge dimension of, for example, 100 mm (refer to FIG. 8). The “widthwise long rectangular shape” referred hereto is a rectangular shape that has a long edge direction (width direction) matching the horizontal direction and a short edge direction (height direction) matching the direction orthogonal with respect to the horizontal direction. The reason why the area of view of the observer has a widthwise long rectangular shape is that two pupils (eyes) of the observer are linearly arranged in the horizontal direction. A detailed configuration of the combiner 12 will be described later. The long edge direction of the combiner 12 (light reflection unit 16) is set as an X axis direction, and the short edge direction thereof is set as a Y axis direction. Furthermore, the thickness direction (a direction that is orthogonal with respect to the long edge direction and the short edge direction) of the combiner 12 (light reflection unit 16) is set as a Z axis direction. Each axis direction is illustrated in each drawing (except for FIG. 1 and FIG. 8).

As illustrated in FIG. 2, the laser diode 13 includes a red laser diode element that emits red light of a wavelength included in a red wavelength range (approximately 600 nm to approximately 780 nm), a green laser diode element that emits green light of a wavelength included a green wavelength range (approximately 500 nm to approximately 570 nm), and a blue laser diode element that emits blue light of a wavelength included in a blue wavelength range (approximately 420 nm to approximately 500 nm). Each laser diode element of each color constituting the laser diode 13 incorporates a resonator that resonates light by multiple reflections, and the emitted light thereof is coherent light as a beam having a wavelength and a phase aligned and is also linearly polarized light. The laser diode 13 emits red light, green light, and blue light in a predetermined order at predetermined timings. The light emission intensities of each color of the laser diode 13 are adjusted in such a manner that a picture displayed by the red light, the green light, and the blue light has a specific white balance. The laser diode elements of each color which are light emission sources are not illustrated.

As illustrated in FIG. 2, the MEMS mirror element 14 is configured by producing a single mirror and a driving unit for driving the mirror on a substrate by MEMS technology. The mirror has a circular shape having a diameter of, for example, approximately a few tenths of a millimeter to a few millimeters and can reflect light from the laser diode 13 with a reflective surface as a specular surface. The driving unit axially supports the mirror with two orthogonal axis units and can freely tilt the mirror by electromagnetic force or electrostatic force. The MEMS mirror element 14, by controlling tilting of the mirror with the driving unit, emits light toward the screen 15 in the form of two-dimensionally scanning the screen 15 and thus can project a two-dimensional picture to the screen 15. It is preferable to arrange a polarized light conversion unit (not illustrated) for conversion of the linearly polarized light emitted from the laser diode 13 into any one of left handed circularly-polarized light and right handed circularly-polarized light in the form of being interposed between the MEMS mirror element 14 and the laser diode 13. The polarized light conversion unit is configured of, for example, a retardation plate that generates a retardation of ¼ wavelengths (¼ wavelength retardation plate).

As illustrated in FIG. 2, the screen 15 projects the light emitted from the MEMS mirror element 14 and projects the projected picture to the combiner 12. The screen 15 functions as a secondary illuminant and imparts optical effects to the light from the MEMS mirror element 14 in such a manner that the area of irradiation on the projection surface of the combiner 12 has a widthwise long rectangular shape.

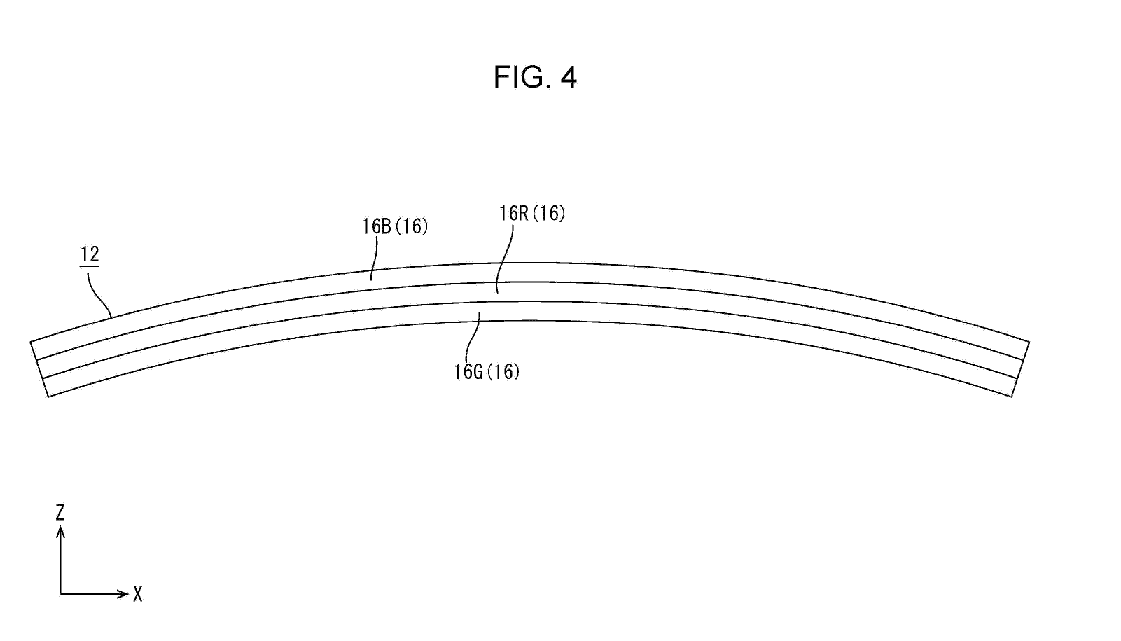

Next, the combiner 12 will be described in detail. As illustrated in FIG. 2 and FIG. 4, the combiner 12 has a configuration in which three light reflection units (unit projection units) 16 that respectively selectively reflect light of different wavelength ranges are stacked in the thickness direction. Specifically, the combiner 12 includes, in a stacked form, a red light reflection unit 16R that mainly selectively reflects light of a wavelength range belonging to red (red light), a green light reflection unit 16G that mainly selectively reflects light of a wavelength range belonging to green (green light), and a blue light reflection unit 16B that mainly selectively reflects light of a wavelength range belonging to blue (blue light). The light reflection units 16R, 16G, and 16B of each color are bonded by a bonding layer (not illustrated) that is configured of an adhesive or the like. Any of the light reflection units 16 of each color constituting the combiner 12 has a cholesteric liquid crystal layer 17. The cholesteric liquid crystal layer 17 has a periodic structure in which liquid crystal molecules are aligned in layers and each of the layers is rotated at a specific angle to form a helical pattern formed by stacked molecules, and thus can selectively reflect light of a specific wavelength based on the pitch of the helix of the liquid crystal molecules. The cholesteric liquid crystal layer 17 is acquired by adding a chiral material to a nematic liquid crystal material to align the stacked molecules in a twisting shape (helical shape). Adjusting the amount or the like of the added chiral material can appropriately change the pitch of the helix, that is, the wavelength of selectively reflected light (the peak wavelength of a peak included in a reflection spectrum). At this point, in order to adjust the half width of the peak included in the reflection spectra of the light reflection units 16R, 16G, and 16B of each color, for example, the numerical value of the pitch of the helix of the liquid crystal molecules included in the cholesteric liquid crystal layer 17 or the ratio of contained liquid crystal molecules having a different numerical value of the pitch of the helix may be adjusted. The cholesteric liquid crystal layer 17 has polarized light selectivity that selectively reflects circularly-polarized light matching the circling direction of the liquid crystal molecules in a helical shape, that is, only one of left handed circularly-polarized light and right handed circularly-polarized light. In addition, the cholesteric liquid crystal layer 17 has incidence angle selectivity that selectively reflects only light having an angle of incidence within a specific range.

Accordingly, the combiner 12 is a reflection member having wavelength selectivity, transmits extraneous light that does not match the respective reflection spectra of the light reflection units 16R, 16G, and 16B, and projects light reflected by each of the light reflection units 16R, 16G, and 16B to the pupils of the observer as illustrated in FIG. 1. Thus, the virtual image VI that is projected by the reflective light can be observed by the observer with high luminance, and an image of the front outside of the windshield 1 based on the extraneous light transmitted by the combiner 12 can be favorably observed with high transmittance. At least 70% or higher transmittance of extraneous light (external visible light) is secured for the combiner 12 to meet the safety regulations of Road Transport Vehicle Act in Japan. Each of the light reflection units 16R, 16G, and 16B constituting the combiner 12 absorbs a predetermined proportion of light in transmission of light that does not match the reflection spectrum. The light absorbances of each of the light reflection units 16R, 16G, and 16B vary according to the wavelength of light and tend to increase on a shorter wavelength side and conversely decrease on a longer wavelength side. Specifically, the light absorbances of each of the light reflection units 16R, 16G, and 16B are respectively, for example, approximately 20% for red light, approximately 25% for green light, and approximately 30% for blue light.

The light emission intensity of extraneous light does not have wavelength dependency in a reflection liquid crystal display device that generally uses extraneous light to perform displaying. Thus, if a blue liquid crystal layer of the highest absorbance that reflects blue light is arranged on the most element observation side in a color cholesteric liquid crystal display element used in the reflection liquid crystal display device, blue light being absorbed by a green liquid crystal layer and a red liquid crystal layer is avoided, and the intensity of extraneous light used in display is increased. However, as in the present embodiment, in the head-up display 10 that uses the laser diode 13 having a specific light emission spectrum as an illuminant, using a color cholesteric liquid crystal display element, as a combiner, that has the same arrangement and configuration as the above reflection liquid crystal display device may conversely decrease the intensity of light used in display. Specifically, the light emission intensity of the laser diode 13 that supplies light to the MEMS mirror element 14 has wavelength dependency and tends to include green light in largest proportion to maintain the white balance of the displayed picture. Meanwhile, absorbing of light by each of the light reflection units 16R, 16G, and 16B constituting the combiner 12 also has wavelength dependency, and light reflected by one of the light reflection units 16R, 16G, and 16B that is arranged far from the MEMS mirror element 14 is absorbed by another that is arranged near the MEMS mirror element 14, and the intensity thereof tends to decrease. From these matters, if the color cholesteric liquid crystal display element included in the above reflection liquid crystal display device is used as a combiner, particularly the intensity of green light is decreased, and brightness related to the displayed picture may be decreased.

Therefore, regarding the stacking order of the light reflection units 16R, 16G, and 16B, the combiner 12 according to the present embodiment is configured in such a manner that the green light reflection unit 16G is arranged nearest the MEMS mirror element 14 (laser diode 13) and the observer. According to such a configuration, green light that is included in largest proportion in the light emitted from the laser diode 13 to maintain the white balance of the displayed picture can be efficiently reflected by the green light reflection unit 16G that is nearest the MEMS mirror element 14 and the observer. In other words, green light that has the highest intensity being absorbed by the light reflection units 16R and 16B is avoided by arranging the red light reflection unit 16R and the blue light reflection unit 16B farther from the MEMS mirror element 14 and the observer than the green light reflection unit 16G. Accordingly, the intensity of light used in display can be increased with the white balance favorably maintained. In addition, since green light has high relative visibility compared with red light and blue light, increasing the intensity of light as above improves luminance. Regarding the stacking order of the light reflection units 16R, 16G, and 16B, the blue light reflection unit 16B in the combiner 12 is arranged farthest from the MEMS mirror element 14 and the observer. That is, the light reflection units 16R, 16G, and 16B constituting the combiner 12 are arranged to be linearly stacked on each other in the nearest order of the green light reflection unit 16G, the red light reflection unit 16R, and the blue light reflection unit 16B from the MEMS mirror element 14 and the observer. The red light reflection unit 16R is arranged to be sandwiched between the green light reflection unit 16G, which is nearest the MEMS mirror element 14 and the observer, and the blue light reflection unit 16B which is farthest from the MEMS mirror element 14 and the observer.

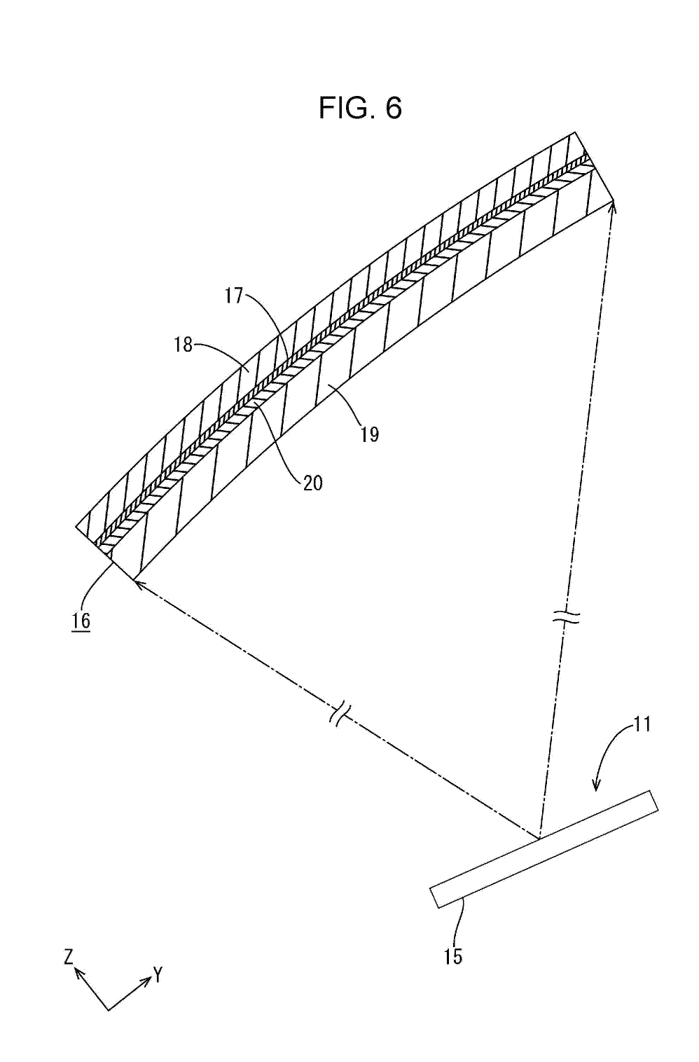

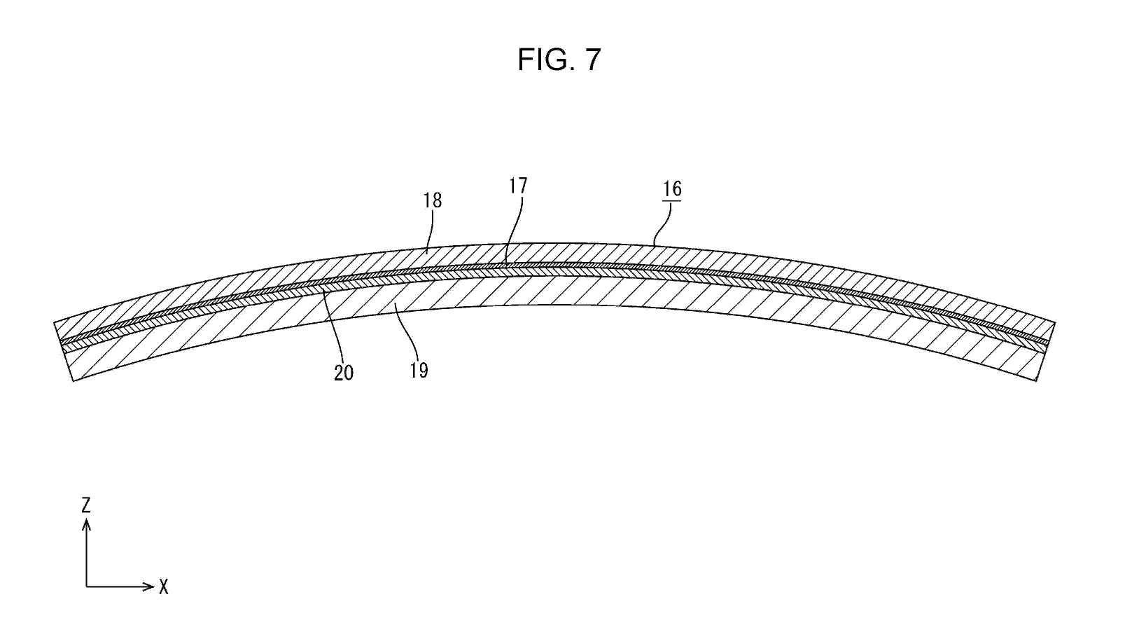

Next, a further detailed configuration of the light reflection unit 16 constituting the combiner 12 will be described. The following configuration of the light reflection unit 16 is common to the light reflection units 16R, 16G, and 16B of each color. As illustrated in FIG. 6 and FIG. 7, the light reflection unit 16 is configured in such a manner that the above cholesteric liquid crystal layer (a light reflection layer or a wavelength-selective reflection layer) 17, a cholesteric liquid crystal layer carrier (light reflection layer carrier) 18 that has a plate surface with the cholesteric liquid crystal layer 17 disposed thereon, a substrate 19 that is indirectly bonded to the cholesteric liquid crystal layer carrier 18, and transparent adhesive layer 20 for maintaining the state of the substrate 19 being bonded to the cholesteric liquid crystal layer carrier 18 are stacked in the thickness direction.

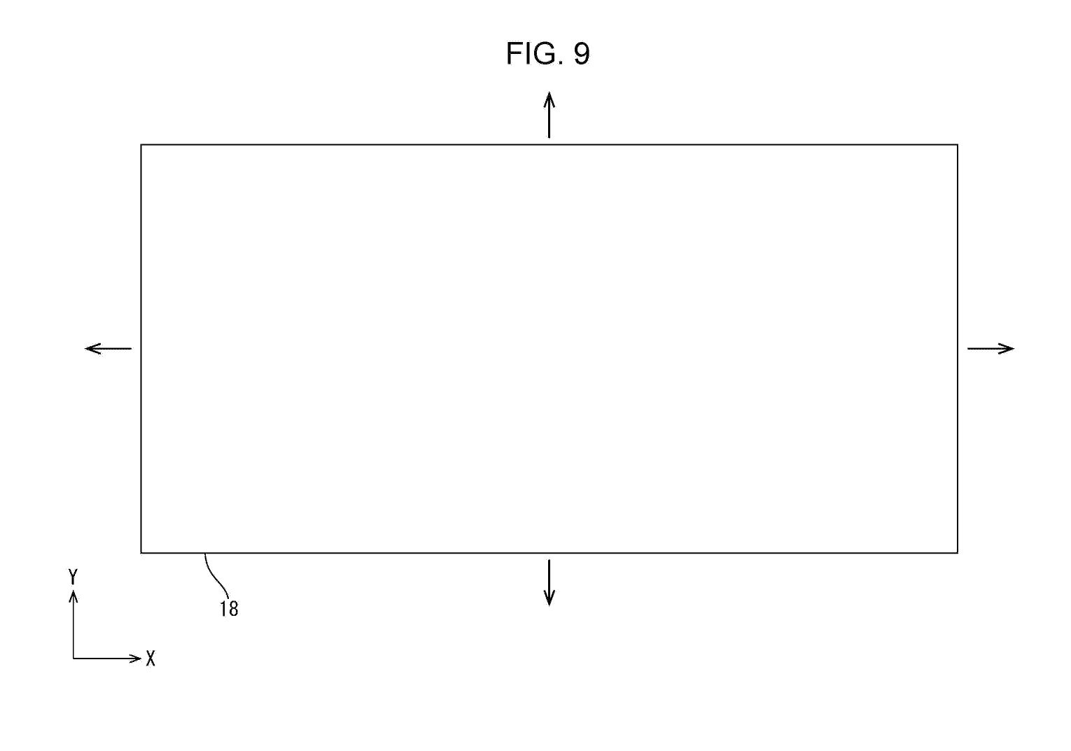

The cholesteric liquid crystal layer carrier 18 is configured of a synthetic resin material such as polyethylene terephthalate (PET), has excellent light transmissivity, and is almost transparent. The glass transition temperature of the synthetic resin material (PET) constituting the cholesteric liquid crystal layer carrier 18 is, for example, approximately 75° C. (refer to FIG. 8). As illustrated in FIG. 3, the plan view shape of the cholesteric liquid crystal layer carrier 18 is a widthwise long rectangular shape in the same manner as the combiner 12, and the cholesteric liquid crystal layer carrier 18 has a plate shape having a predetermined plate thickness. The cholesteric liquid crystal layer carrier 18 acquires high mechanical strength or the like by being subjected to stretching, so-called biaxial stretching, in two orthogonal directions along the plate surface thereof, that is, the short edge direction (Y axis direction) and the long edge direction (X axis direction) (refer to FIG. 9). The cholesteric liquid crystal layer carrier 18 has a stretch ratio (extensibility) varying according to two stretching directions, that is, stretch anisotropy, and has the stretch ratio in the short edge direction (Y axis direction) larger than the stretch ratio in the long edge direction (X axis direction). That is, the cholesteric liquid crystal layer carrier 18 has the short edge direction (Y axis direction) matching a high stretching direction and has the long edge direction (X axis direction) matching a low stretching direction. The “stretch ratio” referred hereto is the ratio of dimensions after stretching with the dimensions of the cholesteric liquid crystal layer carrier 18 before stretching as a reference (100%). Specifically, the cholesteric liquid crystal layer carrier 18 has a stretch ratio of, for example, approximately 150% in the short edge direction and has a stretch ratio of, for example, approximately 120% in the long edge direction (refer to FIG. 8). Furthermore, when the cholesteric liquid crystal layer carrier 18 is subjected to biaxial stretching, the cholesteric liquid crystal layer carrier 18 is heated to a temperature (hereinafter, referred to as a heat setting temperature) higher than the glass transition temperature thereof, and the heat setting temperature is, for example, approximately 150° C. (refer to FIG. 8). As illustrated in FIG. 6, the above cholesteric liquid crystal layer 17 is disposed in almost even thickness across almost the entire area of the plate surface, of both of the outer and inner plate surfaces of the cholesteric liquid crystal layer carrier 18, that faces a side (a substrate 19 side; a lower right side illustrated in FIG. 6) where light is supplied by the projection device 11. The plate thickness of the cholesteric liquid crystal layer carrier 18 is, for example, approximately 100 μm, and the thickness of the cholesteric liquid crystal layer 17 is, for example, approximately 3 μm.

The substrate 19 is configured of a synthetic resin material such as an acrylic resin (polymethyl methacrylate (PMMA) or the like), has excellent light transmissivity, and is almost transparent. The glass transition temperature of the synthetic resin material (PMMA) constituting the substrate 19 is, for example, approximately 100° C. (refer to FIG. 8). As illustrated in FIG. 3, the plan view shape of the substrate 19 is a widthwise long rectangular shape in the same manner as the combiner 12 (cholesteric liquid crystal layer carrier 18), and the substrate 19 has a plate shape of which the plate thickness is larger than the plate thickness of the cholesteric liquid crystal layer carrier 18. Specifically, the plate thickness of the substrate 19 is, for example, approximately 4 mm. Accordingly, the substrate 19 independently has function of securing the mechanical strength of the combiner 12 and function of maintaining the shape of the combiner 12. The transparent adhesive layer 20 is configured of a double-sided tape member that has excellent light transmissivity and is almost transparent, such as an optical clear adhesive (OCA) tape. The transparent adhesive layer 20 is disposed on the plate surface, of both of the outer and inner plate surfaces of the substrate 19, facing the opposite side from a side where light is supplied by the projection device 11, and is directly bonded to the cholesteric liquid crystal layer 17, thereby enabling indirect bonding of the cholesteric liquid crystal layer carrier 18 to the substrate 19. That is, the transparent adhesive layer 20 is arranged in the form of being interposed between the substrate 19 and the cholesteric liquid crystal layer 17. The thickness of the transparent adhesive layer 20 is, for example, approximately 25 μm.

Accordingly, as illustrated in FIG. 6, the light reflection unit 16 is configured by stacking the substrate 19, the transparent adhesive layer 20, the cholesteric liquid crystal layer 17, and the cholesteric liquid crystal layer carrier 18 in this order from the side where light is supplied by the projection device 11. In addition, the thickness dimensions of each constituent member of the light reflection unit 16 are larger in the order of the cholesteric liquid crystal layer 17, the transparent adhesive layer 20, the cholesteric liquid crystal layer carrier 18, and the substrate 19.

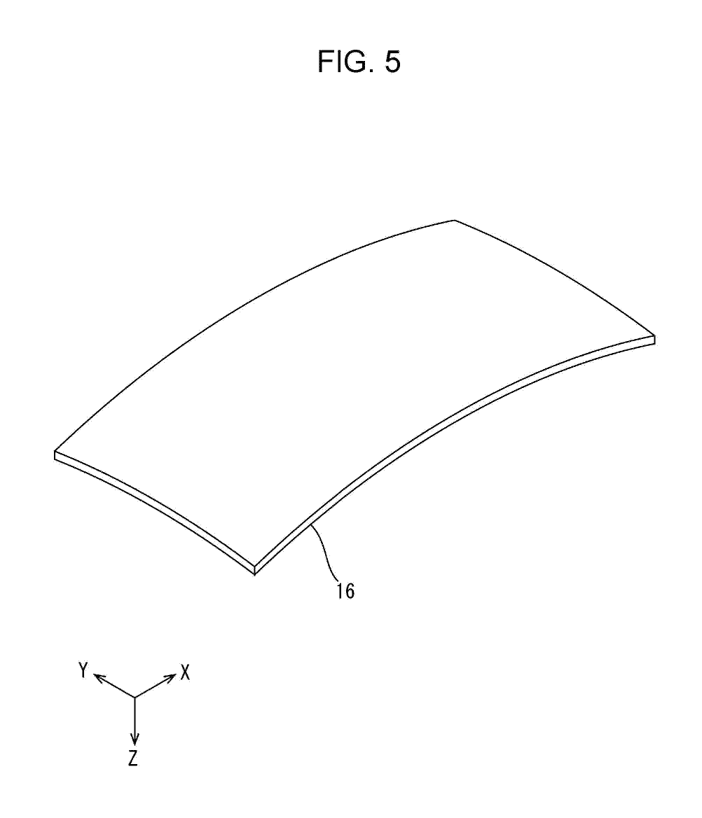

The combiner 12 and each light reflection unit 16 constituting the combiner 12 have a plate surface of an approximately spherical shape (curved shape) as illustrated in FIG. 2, FIG. 4, and FIG. 5. Therefore, the cholesteric liquid crystal layer 17, the cholesteric liquid crystal layer carrier 18, the substrate 19, and the transparent adhesive layer 20 constituting the light reflection unit 16 also have an approximately spherical shape. The light reflection unit 16 (the cholesteric liquid crystal layer carrier 18 and the substrate 19) is subjected to deformation, so-called biaxial deformation, along each deformation axis of two orthogonal directions along the plate surface thereof, that is, the short edge direction and the long edge direction, as a first deformation axis and a second deformation axis by thermal pressing or the like performed in manufacturing processes. The light reflection unit 16 has a curvature and a radius of curvature in the short edge direction (Y axis direction) almost the same as a curvature and a radius of curvature in the long edge direction (X axis direction). Specifically, the radii of curvature of the combiner 12 and the light reflection unit 16 are, for example, approximately 400 mm in any of the short edge direction and the long edge direction (refer to FIG. 8). That is, the combiner 12 and the light reflection unit 16 are said to have a plate surface of an approximately spherical shape that has omnidirectionally the same radius of curvature. Thus, the cholesteric liquid crystal layer carrier 18 constituting the light reflection unit 16 has the percentage of elongation and the amount of elongation by biaxial deformation varying in the long edge direction and in the short edge direction, and the percentage of elongation and the amount of elongation in the long edge direction are larger than the percentage of elongation and the amount of elongation in the short edge direction. Specifically, the percentage of elongation that is required at the time of biaxial deformation of the cholesteric liquid crystal layer carrier 18 is, for example, approximately 100.3% in the short edge direction and is, for example, approximately 101.2% in the long edge direction (refer to FIG. 8).

That is, the cholesteric liquid crystal layer carrier 18 is said to be subjected to biaxial deformation in such a manner that a large elongation amount direction in which the amount of elongation by deformation is relatively large matches the long edge direction (X axis direction), that is, the low stretching direction at the time of biaxial stretching, and that a small elongation amount direction in which the amount of elongation by deformation is relatively small matches the short edge direction (Y axis direction), that is, the high stretching direction at the time of biaxial stretching. In a stage after biaxial stretching, the cholesteric liquid crystal layer carrier 18 is relatively likely to be elongated to larger than or equal to the stretch ratio in the low stretching direction since having a relatively low stretch ratio in the low stretching direction and is relatively unlikely to be elongated to larger than or equal to the stretch ratio in the high stretching direction since having a relatively high stretch ratio in the high stretching direction. In other words, the cholesteric liquid crystal layer carrier 18 has relatively large room for further elongation (elongation potential) in the low stretching direction and has relatively small room for further elongation in the high stretching direction. While, at the time of performing biaxial deformation, the cholesteric liquid crystal layer carrier 18 is elongated and deformed in each of the two directions, the small elongation amount direction in which the amount of elongation is relatively small matches the high stretching direction in which elongation is relatively unlikely to be generated, and the large elongation amount direction in which the amount of elongation is relatively large matches the low stretching direction in which elongation is relatively likely to be generated. Thus, elongation in the large elongation amount direction is smoothly performed, and elongation in the small elongation amount direction is sufficiently performed. Accordingly, stress that may be exerted by biaxial deformation on the cholesteric liquid crystal layer carrier is suitably relieved, and creases and the like are unlikely to be generated in the cholesteric liquid crystal layer 17 disposed on the plate surface of the cholesteric liquid crystal layer carrier 18. Accordingly, display quality related to a projected picture displayed on the basis of light to which a reflection effect is imparted by the cholesteric liquid crystal layer 17 is unlikely to be degraded.

Next, a method for manufacturing particularly the combiner 12 in the head-up display 10 of the above configuration will be described. The method for manufacturing the combiner 12 includes a stretching step of performing biaxial stretching of the cholesteric liquid crystal layer carrier 18, a cholesteric liquid crystal layer forming step (optical functional layer forming step) of forming the cholesteric liquid crystal layer 17 in the cholesteric liquid crystal layer carrier 18, a substrate bonding step of bonding the cholesteric liquid crystal layer carrier 18 and the substrate 19, a deforming step of performing biaxial deformation of the light reflection unit 16, and a light reflection unit bonding step of bonding each light reflection unit 16. Hereinafter, the method for manufacturing the combiner 12 will be described by using FIG. 9 to FIG. 13. While these drawings representatively illustrate a short edge side sectional configuration of the light reflection unit 16, the long edge side sectional configuration of the light reflection unit 16 is the same as those drawings and will not be illustrated.

In the stretching step, as illustrated in FIG. 9, the cholesteric liquid crystal layer carrier 18 before stretching that is configured of a synthetic resin material (PET) is stretched in each of the short edge direction (Y axis direction) and the long edge direction (X axis direction). At this point, the cholesteric liquid crystal layer carrier 18 is heated to the heat setting temperature (for example, approximately 150° C.) over the glass transition temperature thereof (for example, approximately 75° C.) and is subjected to biaxial stretching. Accordingly, stretching is smoothly performed (refer to FIG. 8). The cholesteric liquid crystal layer carrier 18 is cooled after stretching, thereby having fixed dimensions in the stretched state. At this point, the stretch ratio of the cholesteric liquid crystal layer carrier 18 is approximately 150% in the short edge direction and is approximately 120% in the long edge direction. Therefore, the short edge direction of the cholesteric liquid crystal layer carrier 18 is the high stretching direction in which the stretch ratio is relatively high, and the long edge direction thereof is the low stretching direction in which the stretch ratio is relatively low.

When the cholesteric liquid crystal layer carrier 18 is manufactured, a large base material may be molded and subjected to biaxial stretching, and then, individual cholesteric liquid crystal layer carriers 18 may be separated and acquired from the base material. In this case as well, the short edge direction of the cholesteric liquid crystal layer carrier 18 matches the high stretching direction, and the long edge direction thereof matches the low stretching direction.

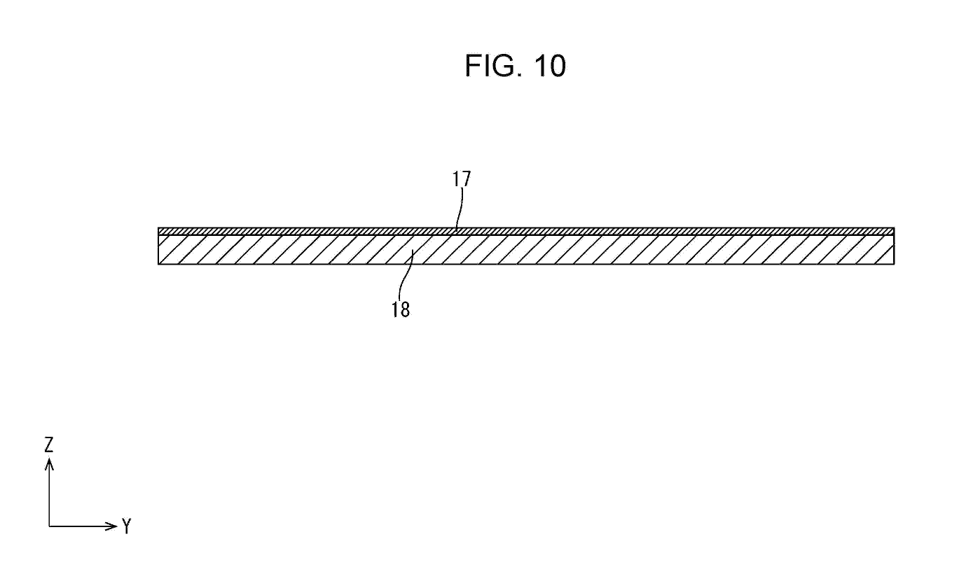

In the cholesteric liquid crystal layer forming step, as illustrated in FIG. 10, a cholesteric liquid crystal material is applied onto almost the entire area of the plate surface of the cholesteric liquid crystal layer carrier 18, which is subjected to biaxial stretching through the stretching step, and solidified, and the cholesteric liquid crystal layer 17 is formed. The cholesteric liquid crystal layer 17 has a film shape in almost even thickness across the entire area thereof.

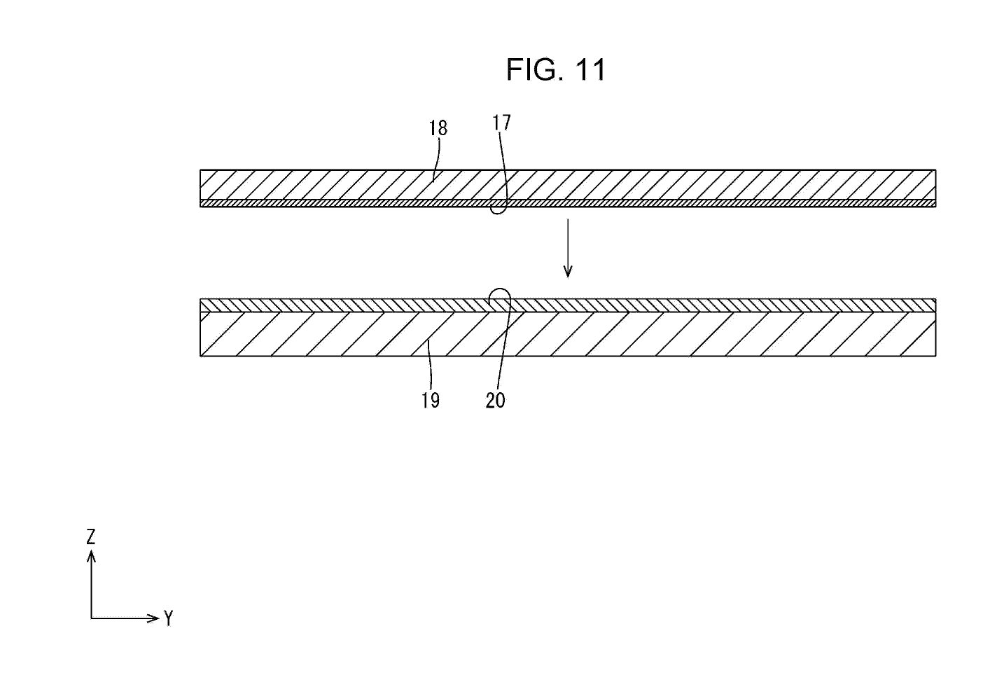

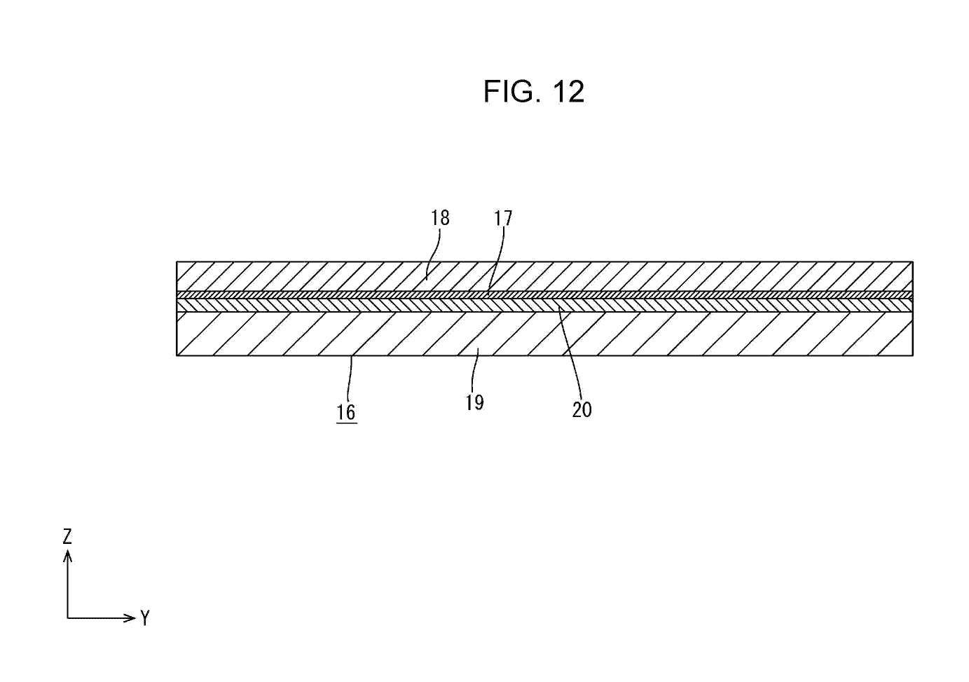

In the substrate bonding step, as illustrated in FIG. 11, the cholesteric liquid crystal layer carrier 18 in which the cholesteric liquid crystal layer 17 is formed through the above cholesteric liquid crystal layer forming step is bonded to the substrate 19 through the transparent adhesive layer 20. Specifically, the transparent adhesive layer 20 is previously bonded onto almost the entire area of the plate surface of the substrate 19. In this state, the surface of the cholesteric liquid crystal layer carrier 18 where the cholesteric liquid crystal layer 17 is formed is directed to the surface of the substrate 19 where the transparent adhesive layer 20 is bonded, and both of the facing surfaces are brought into close contact with each other. Thus, as illustrated in FIG. 12, the cholesteric liquid crystal layer carrier 18 and the substrate 19 are bonded, and the light reflection unit 16 is acquired.

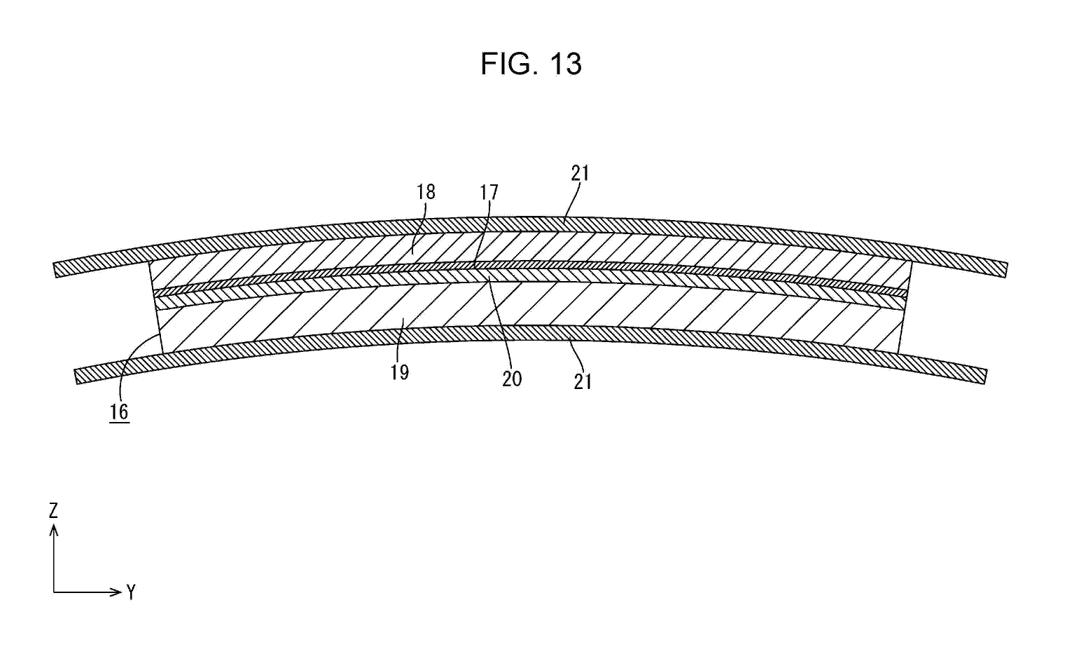

In the deforming step, the light reflection unit 16, which is acquired through the above substrate bonding step, with the plate surface thereof in a flat state (refer to FIG. 12) is subjected to biaxial deformation by thermal pressing. Specifically, as illustrated in FIG. 13, the light reflection unit 16 with the plate surface thereof in a flat state is sandwiched in the plate thickness direction between one pair of press molds 21 having a plate surface of an approximately spherical shape, and is pressed with a predetermined pressure. The surface of the press mold 21 that is in contact with the light reflection unit 16 has an approximately spherical shape omnidirectionally having the same radius of curvature (for example, approximately 400 mm). At this point, the light reflection unit 16 is subjected to thermal pressing in a temperature environment of larger than or equal to each glass transition temperature of the cholesteric liquid crystal layer carrier 18 and the substrate 19 and less than or equal to the heat setting temperature of the cholesteric liquid crystal layer carrier 18 at the time of biaxial stretching. Specifically, it is preferable to perform thermal pressing in a temperature environment of, for example, approximately 130° C. Accordingly, in a state after biaxial deformation, the three-dimensional shapes of the cholesteric liquid crystal layer carrier 18 and the substrate 19, which constitute the light reflection unit 16, after biaxial deformation are suitably maintained, and biaxial deformation generating contraction is avoided.

When the light reflection unit 16 is subjected to biaxial deformation, the cholesteric liquid crystal layer carrier 18 is relatively greatly elongated in the long edge direction (X axis direction), which is the large elongation amount direction, and is relatively less elongated in the short edge direction (Y axis direction) which is the small elongation amount direction. The cholesteric liquid crystal layer carrier 18 has the low stretching direction at the time of biaxial stretching, that is, the direction in which the elongation potential is great, matching the large elongation amount direction and has the high stretching direction at the time of biaxial stretching, that is, the direction in which the elongation potential is small, matching the small elongation amount direction. Thus, elongation in the large elongation amount direction is smoothly performed, and elongation in the small elongation amount direction is sufficiently performed. Accordingly, biaxial deformation is unlikely to generate creases and the like in the cholesteric liquid crystal layer 17 disposed on the plate surface of the cholesteric liquid crystal layer carrier 18. Small deformation such as creases being unlikely to be generated in the cholesteric liquid crystal layer 17 makes distortion unlikely to be generated in the traveling direction of reflective light from the cholesteric liquid crystal layer 17. Thus, display quality related to the picture projected by the combiner 12 is unlikely to be degraded. The light reflection units 16, which are subjected to biaxial deformation as above, that exhibit different colors are bonded in the above order by a bonding layer, not illustrated, in the light reflection unit bonding step, and the combiner 12 subjected to biaxial deformation is manufactured (refer to FIG. 2 and FIG. 4).

As described heretofore, the combiner (projection member) 12 of the present embodiment includes the cholesteric liquid crystal layer 17 that is an optical functional layer imparting an optical effect to light, and the cholesteric liquid crystal layer carrier 18 that is an optical functional layer carrier of a plate shape having a plate surface with the cholesteric liquid crystal layer 17, which is the optical functional layer, disposed thereon, being subjected to biaxial stretching or uniaxial stretching in such a manner that one of two intersecting directions along the plate surface is the low stretching direction in which the stretch ratio is relatively low or is a non-stretching direction in which stretching is not performed and that the other is the high stretching direction in which the stretch ratio is relatively high or is a stretching direction in which stretching is performed, and being subjected to biaxial deformation or uniaxial deformation to have the plate surface deformed into a curved shape in such a manner that the large elongation amount direction in which the amount of elongation by deformation is relatively large or a deformation direction in which deformation is generated matches the low stretching direction or the non-stretching direction and that the small elongation amount direction in which the amount of elongation by deformation is relatively small or a non-deformation direction in which deformation is not generated matches the high stretching direction or the stretching direction.

Accordingly, since the cholesteric liquid crystal layer carrier 18 which is the optical functional layer carrier of a plate shape in which the cholesteric liquid crystal layer 17, which is the optical functional layer imparting an optical effect to light, is disposed on the plate surface is subjected to biaxial stretching or uniaxial stretching, the cholesteric liquid crystal layer carrier 18 can acquire sufficient strength or the like. In addition, the cholesteric liquid crystal layer carrier 18 which is the optical functional layer carrier is subjected to biaxial deformation or uniaxial deformation to have the plate surface of a curved shape. Thus, a projected picture by light to which an optical effect is imparted by the cholesteric liquid crystal layer 17, which is the optical functional layer disposed on the plate surface, can be visually recognized by a user in an enlarged form.

In the case of biaxial deformation of the cholesteric liquid crystal layer carrier 18 which is the optical functional layer carrier, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the cholesteric liquid crystal layer carrier 18, which is the optical functional layer carrier, is suitably relieved, and creases and the like are unlikely to be generated in the cholesteric liquid crystal layer 17 which is the optical functional layer. In the case of uniaxial deformation of the cholesteric liquid crystal layer carrier 18 which is the optical functional layer carrier, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the cholesteric liquid crystal layer carrier 18, which is the optical functional layer carrier, is suitably relieved, and creases and the like are unlikely to be generated in the cholesteric liquid crystal layer 17 which is the optical functional layer. Accordingly, display quality related to the projected picture by light to which an optical effect is imparted by the cholesteric liquid crystal layer 17, which is the optical functional layer, is unlikely to be degraded.

The cholesteric liquid crystal layer 17 which is the optical functional layer is a light reflection layer that reflects light. Accordingly, the light reflection layer reflecting light enables a projected picture by reflective light to be visually recognized by the user. Since creases and the like are unlikely to be generated in the light reflection layer, display quality related to the projected picture based on reflective light is unlikely to be degraded.

The light reflection layer is configured of the cholesteric liquid crystal layer 17 that selectively reflects any one of left handed circularly-polarized light and right handed circularly-polarized light in a specific wavelength range. Accordingly, the cholesteric liquid crystal layer 17 selectively reflecting any one of left handed circularly-polarized light and right handed circularly-polarized light in a specific wavelength range enables the projected picture by reflective light to be visually recognized by the user. Since creases and the like are unlikely to be generated in the cholesteric liquid crystal layer 17, display quality related to the projected picture based on reflective light is unlikely to be degraded.

The combiner 12 includes the substrate 19 that has a plate shape of a larger plate thickness than the cholesteric liquid crystal layer carrier 18 which is the optical functional layer carrier, is directly or indirectly bonded to the cholesteric liquid crystal layer carrier 18 which is the optical functional layer carrier or the cholesteric liquid crystal layer 17 which is the optical functional layer, and is subjected to biaxial deformation or uniaxial deformation in such a manner that one of two intersecting directions along a plate surface of the substrate 19 is the large elongation amount direction or the deformation direction and that the other is the small elongation amount direction or the non-deformation direction. Accordingly, the substrate 19 that has a plate shape of a larger plate thickness than the cholesteric liquid crystal layer carrier 18, which is the optical functional layer carrier, independently functions to maintain the shape of the combiner 12 in a state after biaxial deformation or uniaxial deformation.

Next, the method for manufacturing the combiner 12 of the present embodiment includes the stretching step of performing biaxial stretching or uniaxial stretching of the cholesteric liquid crystal layer carrier 18, which is the optical functional layer carrier of a plate shape, in such a manner that one of two intersecting directions along the plate surface of the cholesteric liquid crystal layer carrier 18 is the low stretching direction in which the stretch ratio is relatively low or is the non-stretching direction in which stretching is not performed and that the other is the high stretching direction in which the stretch ratio is relatively high or is the stretching direction in which stretching is performed; the cholesteric liquid crystal layer, which is the optical functional layer, forming step (optical functional layer forming step) of forming the cholesteric liquid crystal layer 17, which is the optical functional layer, on the plate surface of the cholesteric liquid crystal layer carrier 18, which is the optical functional layer carrier, in a flat state; and the deforming step of deforming the cholesteric liquid crystal layer carrier 18, which is the optical functional layer carrier, along with the cholesteric liquid crystal layer 17, which is the optical functional layer, to make the plate surface have a curved shape by biaxial deformation or uniaxial deformation in such a manner that the large elongation amount direction in which the amount of elongation by deformation is relatively large or the deformation direction in which deformation is generated matches the low stretching direction or the non-stretching direction and that the small elongation amount direction in which the amount of elongation by deformation is relatively small or the non-deformation direction in which deformation is not generated matches the high stretching direction or the stretching direction.

Accordingly, since the cholesteric liquid crystal layer carrier 18 which is the optical functional layer carrier of a plate shape in which the cholesteric liquid crystal layer 17, which is the optical functional layer imparting an optical effect to light, is disposed on the plate surface is subjected to biaxial stretching or uniaxial stretching in the stretching step, the cholesteric liquid crystal layer carrier 18 can acquire sufficient strength or the like. In addition, the cholesteric liquid crystal layer carrier 18 which is the optical functional layer carrier is subjected to biaxial deformation or uniaxial deformation to have the plate surface of a curved shape in the deforming step. Thus, a projected picture by light to which an optical effect is imparted by the cholesteric liquid crystal layer 17, which is the optical functional layer disposed on the plate surface, can be visually recognized by the user in an enlarged form.

In the case of biaxial deformation of the cholesteric liquid crystal layer carrier 18, which is the optical functional layer carrier, in the deforming step, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the cholesteric liquid crystal layer carrier 18, which is the optical functional layer carrier, is suitably relieved, and creases and the like are unlikely to be generated in the cholesteric liquid crystal layer 17 which is the optical functional layer. In the case of uniaxial deformation of the cholesteric liquid crystal layer carrier 18, which is the optical functional layer carrier, in the deforming step, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the cholesteric liquid crystal layer carrier 18, which is the optical functional layer carrier, is suitably relieved, and creases and the like are unlikely to be generated in the cholesteric liquid crystal layer 17 which is the optical functional layer. Accordingly, display quality related to the projected picture by light to which an optical effect is imparted by the cholesteric liquid crystal layer 17, which is the optical functional layer, is unlikely to be degraded.

In the stretching step, the cholesteric liquid crystal layer carrier 18 which is the optical functional layer carrier is heated to a predetermined heat setting temperature. In the deforming step, the cholesteric liquid crystal layer carrier 18, which is the optical functional layer carrier, and the cholesteric liquid crystal layer 17, which is the optical functional layer, are subjected to thermal pressing in a temperature environment of higher than or equal to the glass transition temperature of the cholesteric liquid crystal layer carrier 18, which is the optical functional layer carrier, and less than or equal to the heat setting temperature in the stretching step. If the temperature environment in thermal pressing performed in the deforming step is lower than the glass transition temperature of the cholesteric liquid crystal layer carrier which is the optical functional layer carrier, the deformed shape of the cholesteric liquid crystal layer carrier 18 which is the optical functional layer carrier is unlikely to be maintained. Conversely, if the temperature environment is higher than the heat setting temperature in the stretching step, contraction may be generated in the cholesteric liquid crystal layer carrier 18 which is the optical functional layer carrier. Regarding this point, in the deforming step, as described above, the cholesteric liquid crystal layer carrier 18, which is the optical functional layer carrier, and the cholesteric liquid crystal layer 17, which is the optical functional layer, are subjected to thermal pressing in a temperature environment of higher than or equal to the glass transition temperature of the cholesteric liquid crystal layer carrier 18, which is the optical functional layer carrier, and less than or equal to the heat setting temperature in the stretching step. Thus, the deformed shape of the cholesteric liquid crystal layer carrier 18 which is the optical functional layer carrier can be maintained, and contraction being generated in the cholesteric liquid crystal layer carrier 18 which is the optical functional layer carrier can be avoided.

### Embodiment 2

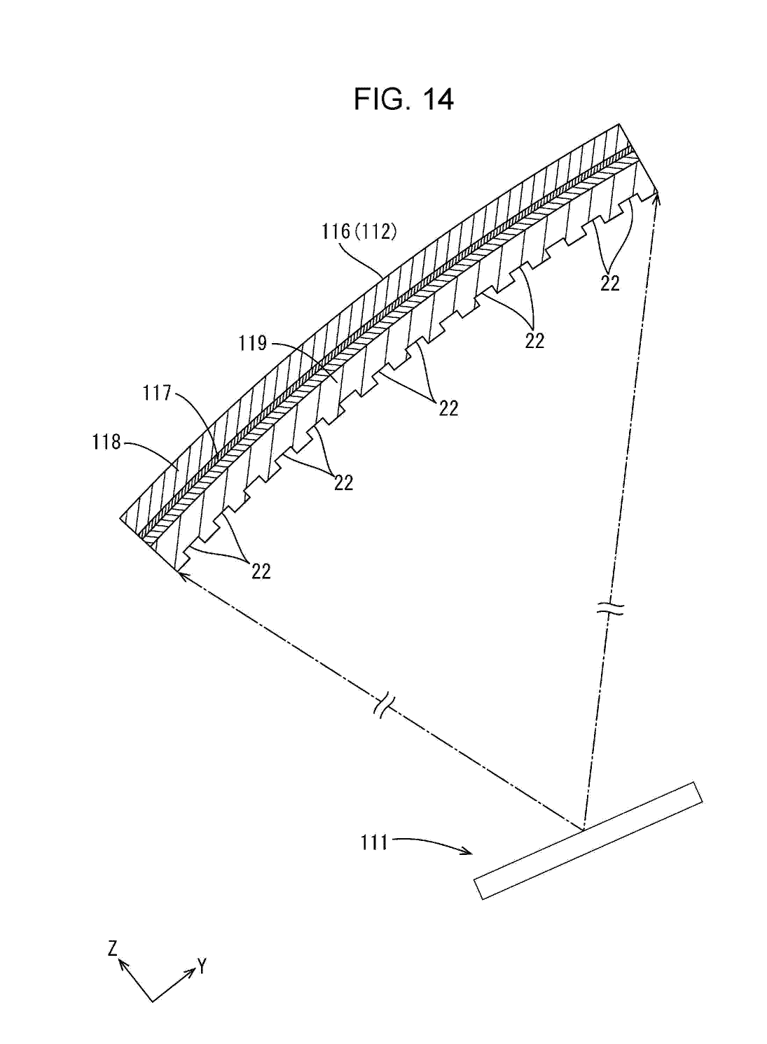

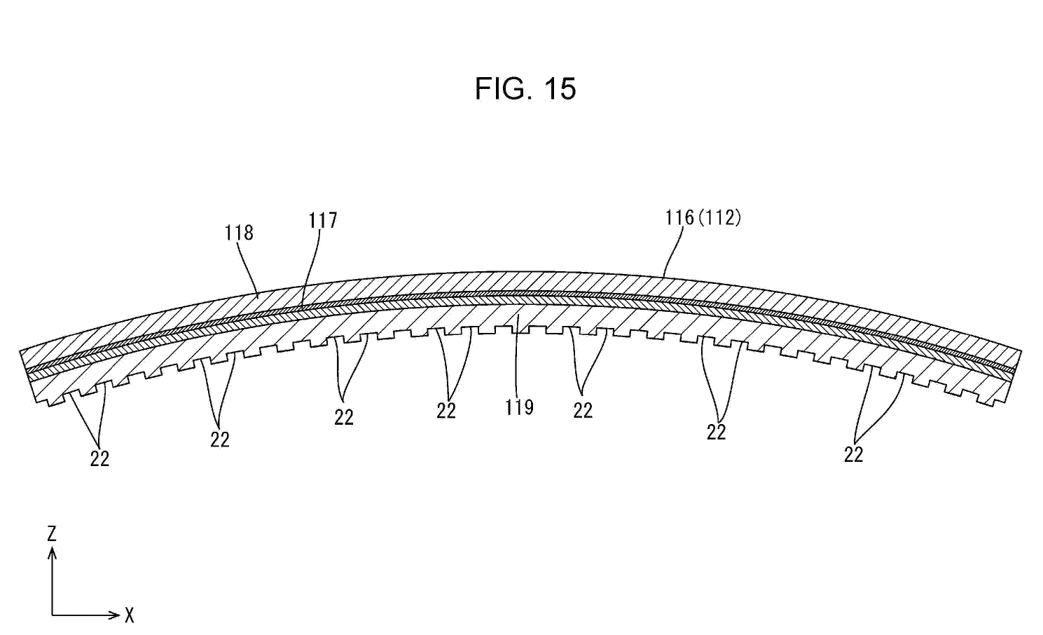

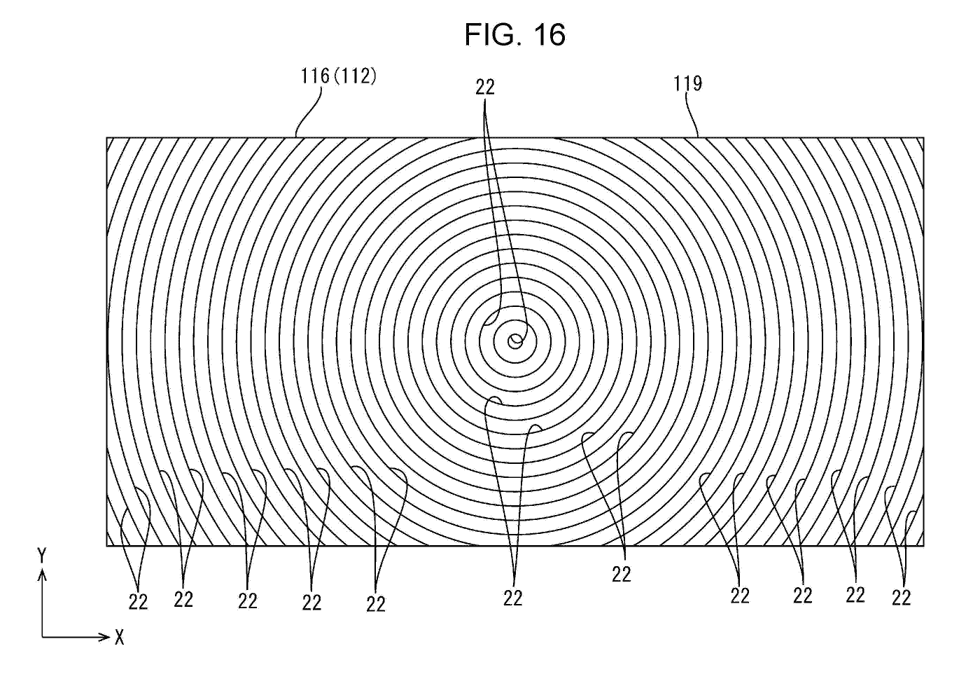

Embodiment 2 of the present invention will be described with FIG. 14 to FIG. 19. Embodiment 2 illustrates disposing a recess portion 22 in the plate surface of a substrate 119. Duplicate descriptions of the same structures and effects as above Embodiment 1 will not be provided.

As illustrated in FIG. 14 to FIG. 16, the recess portion 22 for facilitating biaxial deformation of the substrate 119 is disposed in the plate surface of the substrate 119 that constitutes a light reflection unit 116 according to the present embodiment. The recess portion 22 is disposed on the plate surface, of both of the outer and inner plate surfaces of the substrate 119, that is on the opposite side (a side where light is supplied by a projection device 111) from a cholesteric liquid crystal layer 117 and cholesteric liquid crystal layer carrier 118 side. The plan view shape of the recess portion 22 is a circularly annular shape (donut shape) that has a constant width along the entire circumference thereof, and the recess portion 22 is arranged to have the center thereof matching the center (a position where two diagonals intersect with each other) of the plate surface of the substrate 119, that is, concentrically arranged. The recess portion 22 has the same diameter dimension in the short edge direction (Y axis direction) and the long edge direction (X axis direction) of the light reflection unit 116 and has a true circularly annular shape of a constant diameter dimension along the entire circumference. Accordingly, the substrate 119 has isotropic deformability by the recess portion 22. The reason of employing such a configuration is that the radius of curvature in the short edge direction is the same as the radius of curvature in the long edge direction in the light reflection unit 116 subjected to biaxial deformation. The recess portion 22 is arranged in plural numbers intermittently linearly in the diameter direction. The diameter dimension is smaller near the center of the plate surface of the substrate 119. The diameter dimension is larger away from the center. The plan view shape of the recess portion 22, of the plurality of recess portions 22, that is arranged at the center of the plate surface of the substrate 119 is a circular shape. The adjacent recess portions 22 have almost equal arrangement intervals and are arranged at equal pitches. Specifically, 14 recess portions 22 in the short edge direction and 25 recess portions 22 in the long edge direction in the substrate 119 are linearly arranged, and the arrangement interval is approximately 7 mm. The recess portion 22 has a constant width dimension across the entire area thereof in the depth direction (Z axis direction). Therefore, the sectional shape of a part of the substrate 119 that has a protruding shape in a part where the recess portion is not formed (recess portion non-formation portion) is a quadrangular shape (block shape). The depth dimension of the recess portion 22 is, for example, approximately 1 mm. In other words, the depth dimension of the recess portion 22 is approximately ¼ of the plate thickness dimension of the substrate 119 (for example, approximately 4 mm). Thus, the thickness dimension of a part of the substrate 119 where the recess portion 22 is formed, that is, a recess portion formation portion, is approximately ¾ (for example, approximately 3 mm) of the plate thickness dimension (the thickness dimension of the recess portion non-formation portion in which the recess portion 22 is not formed) of the substrate 119.

The substrate 119, since having a larger plate thickness than the cholesteric liquid crystal layer carrier 118, is relatively unlikely to be deformed and tends to be subjected to relatively great stress compared with the cholesteric liquid crystal layer carrier 118 when the light reflection unit 116 is subjected to biaxial deformation by thermal pressing. Meanwhile, if the recess portion 22 that has a concentric shape is formed in the plate surface of the substrate 119, the part of the substrate 119 where the recess portion 22 is formed (recess portion formation portion) has a small thickness compared with the part where the recess portion 22 is not formed (recess portion non-formation portion). Thus, when the light reflection unit 116 is subjected to biaxial deformation, biaxial deformation is likely to be generated in the substrate 119 along the plan view shape of the recess portion 22, and stress that may be exerted on the substrate 119 by deformation is relieved. Accordingly, stress on the substrate 119 is unlikely to affect the cholesteric liquid crystal layer 117 and the cholesteric liquid crystal layer carrier 118, and creases and the like are unlikely to be generated in the cholesteric liquid crystal layer 117.

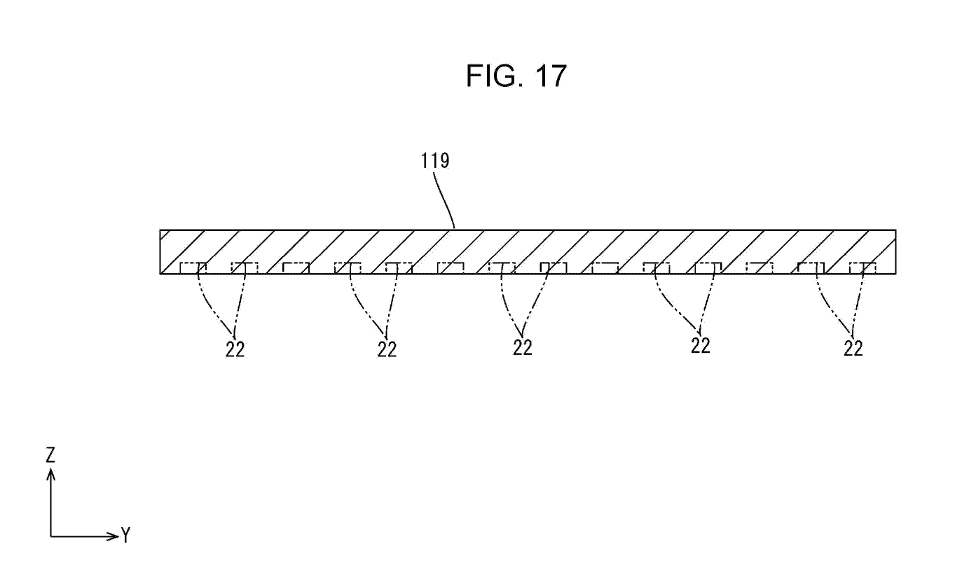

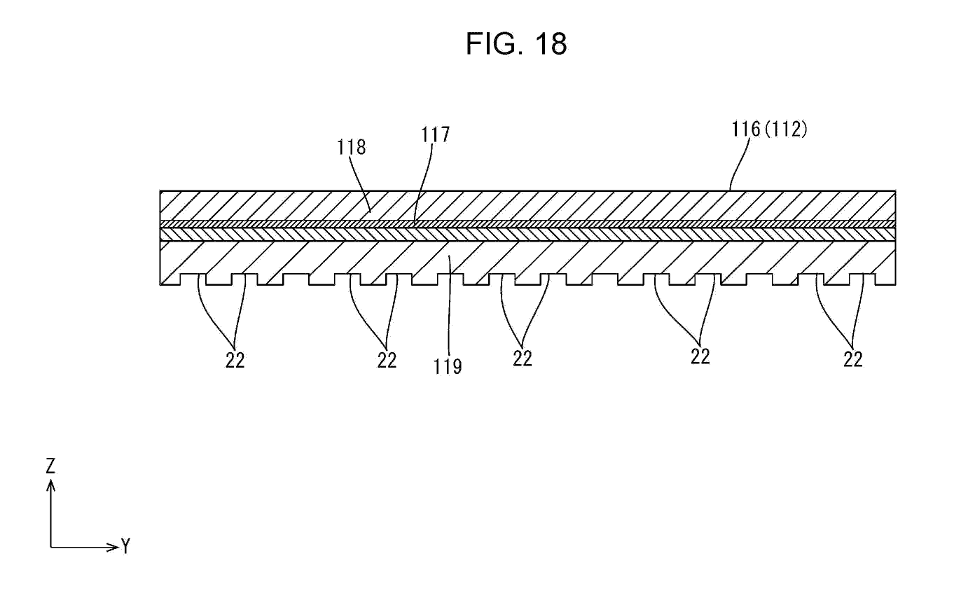

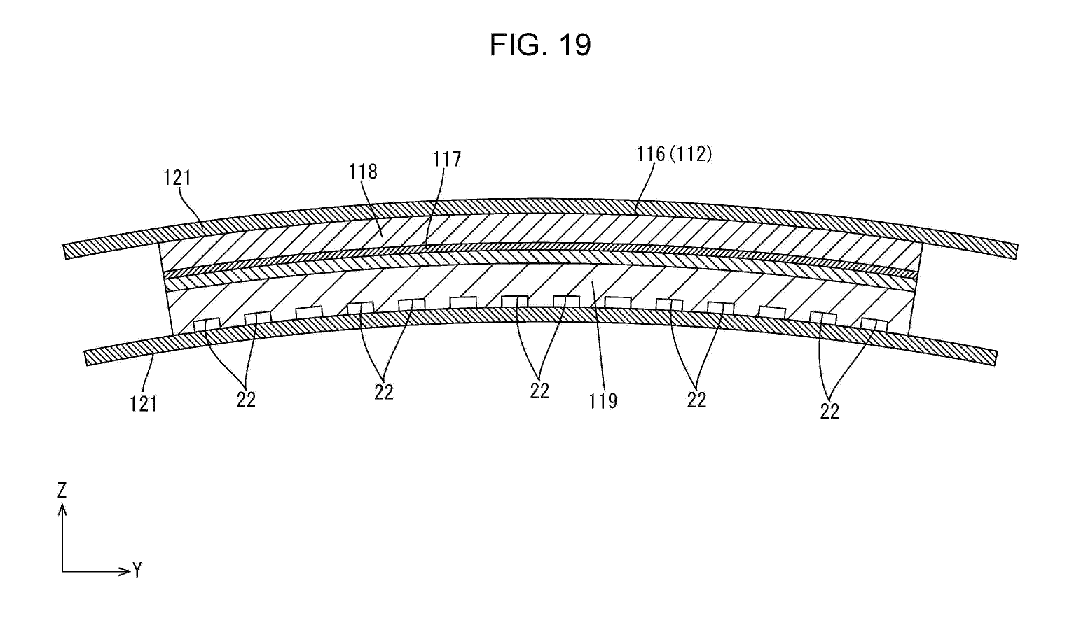

A method for manufacturing the light reflection unit 116 of such a configuration is acquired by adding the following step to the manufacturing method disclosed in above Embodiment 1. That is, the method for manufacturing the light reflection unit 116 includes a recess portion forming step of forming the recess portion 22 in the plate surface of the substrate 119 prior to the substrate bonding step (deforming step). In the recess portion forming step, as illustrated in FIG. 17, the recess portion 22 illustrated by a double-dot chain line in the drawing is formed by cutting the plate surface of a single side of the manufactured substrate 119 with a cutting device not illustrated. After the recess portion forming step is finished, the substrate bonding step is performed to bond, as illustrated in FIG. 18, the cholesteric liquid crystal layer 117 and the cholesteric liquid crystal layer carrier 118 to the plate surface of the substrate 119 on the opposite side from the surface thereof where the recess portion 22 is formed. Then, in the deforming step, as illustrated in FIG. 19, the light reflection unit 116 is sandwiched between one pair of press molds 121 and subjected to thermal pressing. At this point, since the recess portion 22 of which the plan view shape is a circularly annular shape is formed in the plate surface of the substrate 119, biaxial deformation of the substrate 119 is facilitated, and generation of stress is reduced. Specifically, while the substrate 119 is subjected to biaxial deformation in such a manner that the surface thereof where the recess portion 22 is formed has a convex shape, the recess portion formation portion has a smaller thickness than the recess portion non-formation portion in the substrate 119. Thus, biaxial deformation is easily performed along the plan view shape of the recess portion 22. The parts of the recess portion non-formation portions having a protruding shape are released into the recess portion 22 to decrease the interval therebetween, and stress that is consequently exerted is relieved. Accordingly, small deformation such as creases caused by stress on the substrate 119 is unlikely to be generated in the cholesteric liquid crystal layer 117. Thus, distortion is unlikely to be generated in the traveling direction of reflective light from the cholesteric liquid crystal layer 117, and display quality related to the picture projected by a combiner 112 is unlikely to be degraded.

As described heretofore, according to the present embodiment, the recess portion 22 of which the plan view shape is a circular shape, an elliptic shape, or a grid shape in the case of biaxial deformation and is a straight linear shape extending in the form of following the deformation direction or a grid shape in the case of uniaxial deformation is disposed in the substrate 119. The substrate 119, since having a plate shape of a larger plate thickness than the cholesteric liquid crystal layer carrier 118 which is the optical functional layer carrier, is unlikely to be subjected to biaxial deformation or uniaxial deformation and is subjected to relatively great stress by deformation compared with the cholesteric liquid crystal layer carrier 118, which is the optical functional layer carrier. Thus, the stress may affect the cholesteric liquid crystal layer carrier 118 which is the optical functional layer carrier and the cholesteric liquid crystal layer 117 which is the optical functional layer. Regarding this point, the recess portion 22 is disposed in the substrate 119, and the plan view shape of the recess portion 22 is a circular shape, an elliptic shape, or a grid shape in the case of biaxial deformation of the substrate 119. Thus, biaxial deformation of the substrate 119 can be facilitated. In the case of uniaxial deformation of the substrate 119, the recess portion 22 is disposed in such a manner that the plan view shape of the recess portion 22 is a straight linear shape extending in the form of following the deformation direction or a grid shape. Thus, uniaxial deformation of the substrate 119 can be facilitated. Accordingly, stress that may be exerted by deformation on the substrate 119 is relieved, and the stress is unlikely to affect the cholesteric liquid crystal layer carrier 118 which is the optical functional layer carrier and the cholesteric liquid crystal layer 117 which is the optical functional layer. Thus, creases and the like are unlikely to be generated in the cholesteric liquid crystal layer 117 which is the optical functional layer.

### Embodiment 3

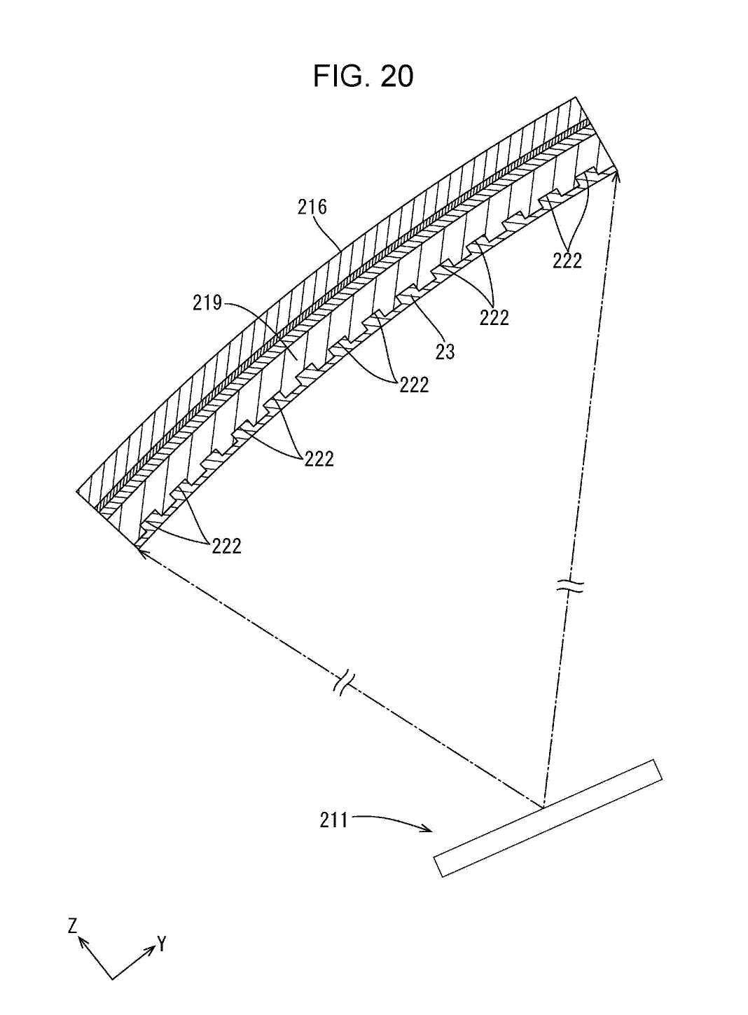

Embodiment 3 of the present invention will be described with FIG. 20. Embodiment 3 illustrates filling a recess portion 222 with a transparent resin material 23 from above Embodiment 2. Duplicate descriptions of the same structures and effects as above Embodiment 2 will not be provided.

As illustrated in FIG. 20, the transparent resin material 23 is disposed in the form of filling a recess portion 222 in a substrate 219 according to the present embodiment. The transparent resin material 23 fills all recess portions 222 and is disposed in the form of covering almost the entire area of the plate surface of the substrate 219. The outermost surface of the transparent resin material 23 has a spherical shape that is parallel to the plate surface of the substrate 219. The transparent resin material 23 is configured of a synthetic resin material that has excellent light transmissivity and is almost transparent, and the refractive index of the transparent resin material 23 is almost the same as that of a synthetic resin material constituting the substrate 219. Specifically, the transparent resin material 23 is configured of an acrylic resin (PMMA or the like) having a refractive index of, for example, approximately 1.49 and is preferably configured of the same material as the substrate 219. Accordingly, when light of irradiation from a projection device 211 is transmitted by the transparent resin material 23 and the substrate 219, diffuse reflection is unlikely to be generated in the interface between the transparent resin material 23 and the substrate 219. Accordingly, display quality is more unlikely to be degraded. The synthetic resin material constituting the transparent resin material is also an ultraviolet-curable resin material that is cured by ultraviolet rays.

In order to dispose the transparent resin material 23 of such a configuration, manufacturing steps of the light reflection unit 216 include a transparent resin material filling step of filling with the transparent resin material 23. The transparent resin material filling step is performed after the deforming step is finished. The transparent resin material 23 in a state of being uncured and having sufficient fluidity is applied to the surface of the substrate 219 where the recess portion 222 is formed, and the recess portion 222 is filled with the transparent resin material 23. Then, the applied transparent resin material 23 is irradiated with ultraviolet rays, and the transparent resin material 23 is cured.

As described heretofore, according to the present embodiment, the recess portion 222 is filled with the transparent resin material 23 having the same refractive index as the substrate 219 or a cholesteric liquid crystal layer carrier 218 which is the optical functional layer carrier. Accordingly, filling the recess portion 222 with the transparent resin material 23 having the same refractive index as the substrate 219 or the cholesteric liquid crystal layer carrier 218, which is the optical functional layer carrier, makes diffuse reflection unlikely to be generated in the interface of the recess portion 222. Accordingly, display quality is more unlikely to be degraded.

### Embodiment 4

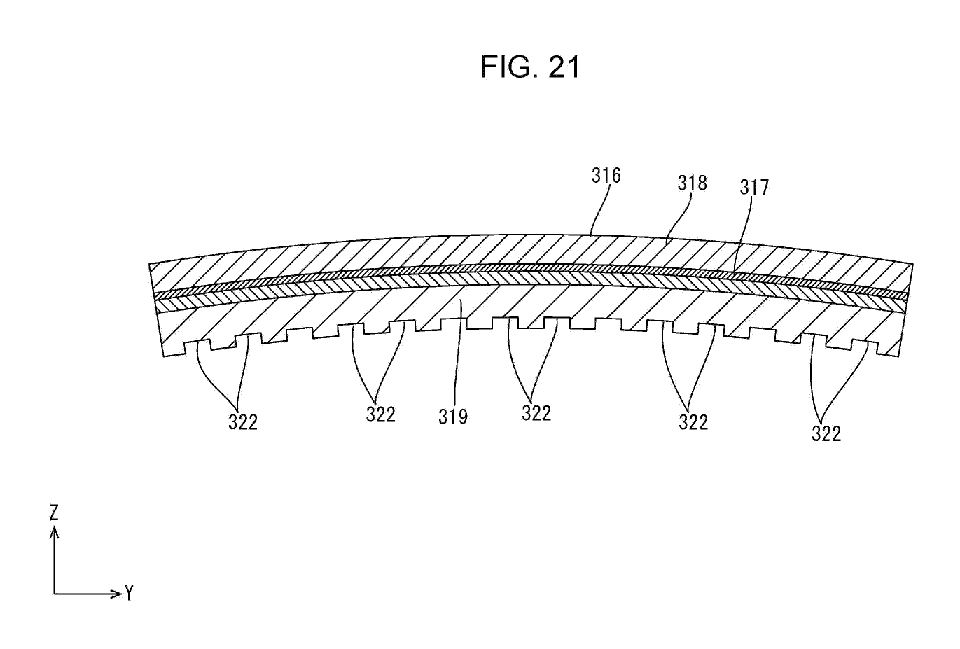

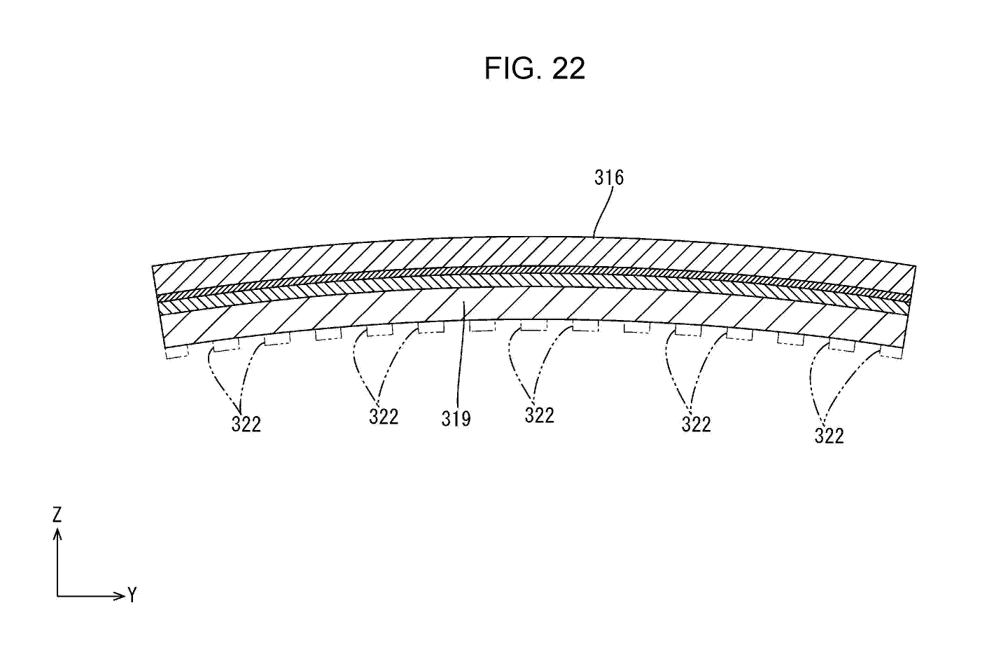

Embodiment 4 of the present invention will be described with FIG. 21 or FIG. 22. Embodiment 4 illustrates removing a recess portion 322 after the deforming step from above Embodiment 2. Duplicate descriptions of the same structures and effects as above Embodiment 2 will not be provided.

As illustrated in FIG. 21 and FIG. 22, a method for manufacturing a light reflection unit 316 according to the present embodiment includes a recess portion removing step of removing the recess portion 322 after at least the deforming step. When the deforming step is performed, as illustrated in FIG. 21, the recess portion 322 is disposed in the plate surface of a substrate 319, and biaxial deformation of the substrate 319 is facilitated. In the recess portion removing step that is performed after the deforming step, as illustrated in FIG. 22, a part of a protruding shape constituting the recess portion 322 is removed by performing polishing of the surface of the substrate 319, in the light reflection unit 316 in a state after biaxial deformation, where the recess portion 322 is formed. Accordingly, the recess portion 322 is also removed. Accordingly, the light reflection unit 316 can be thin, generation of diffuse reflection of light that may be caused by the recess portion 322 can be reduced, and the surface of the substrate 319 can be leveled.

As described heretofore, according to the present embodiment, included are the substrate bonding step of directly or indirectly bonding the substrate 319 having a plate shape of a larger plate thickness than the cholesteric liquid crystal layer carrier 318, which is the optical functional layer carrier, to the cholesteric liquid crystal layer carrier 318, which is the optical functional layer carrier, or to the cholesteric liquid crystal layer 317, which is the optical functional layer, the substrate bonding step being performed between the cholesteric liquid crystal layer, which is the optical functional layer, forming step (optical functional layer forming step) and the deforming step; the recess portion forming step of forming the recess portion 322 in at least any one of the plate surface of the cholesteric liquid crystal layer carrier 318, which is the optical functional layer carrier, on the opposite side from the cholesteric liquid crystal layer 317, which is the optical functional layer, side and the plate surface of the substrate 319 on the opposite side from the cholesteric liquid crystal layer carrier 318, which is the optical functional layer carrier, side or the cholesteric liquid crystal layer 317, which is the optical functional layer, side, the recess portion forming step being performed prior to at least the deforming step, the plan view shape of the recess portion 322 being a circular shape, an elliptic shape, or a grid shape in the case of biaxial deformation in the deforming step, and the plan view shape of the recess portion 322 being a straight linear shape extending in the form in the deformation direction or a grid shape in the case of uniaxial deformation in the deforming step; and the recess portion removing step of removing the recess portion 322, the recess portion removing step being performed after at least the deforming step. Accordingly, the recess portion 322 that is formed in at least any one of the plate surface of the cholesteric liquid crystal layer carrier 318, which is the optical functional layer carrier, on the opposite side from the cholesteric liquid crystal layer 317, which is the optical functional layer, side and the plate surface of the substrate 319 on the opposite side from the cholesteric liquid crystal layer carrier 318, which is the optical functional layer carrier, side or the cholesteric liquid crystal layer 317, which is the optical functional layer, side in the recess portion forming step can facilitate biaxial deformation of at least any one of the cholesteric liquid crystal layer carrier 318, which is the optical functional layer carrier, and the substrate 319 in the deforming step since the plan view shape of the recess portion 322 is a circular shape, an elliptic shape, or a grid shape in the case of biaxial deformation of the cholesteric liquid crystal layer carrier 318, which is the optical functional layer carrier, in the deforming step. In the case of uniaxial deformation of the cholesteric liquid crystal layer carrier 318, which is the optical functional layer carrier, in the deforming step, the recess portion 322 of which the plan view shape is a straight linear shape extending in the form in the deformation direction or a grid shape is disposed. Thus, the recess portion 322 can facilitate uniaxial deformation of at least any one of the cholesteric liquid crystal layer carrier 318, which is the optical functional layer carrier, and the substrate 319 in the deforming step. Accordingly, since stress that may be exerted by deformation on the cholesteric liquid crystal layer carrier 318 which is the optical functional layer carrier is relieved, creases and the like are unlikely to be generated in the cholesteric liquid crystal layer 317, which is the optical functional layer, disposed on the plate surface of the cholesteric liquid crystal layer carrier 318 which is the optical functional layer carrier. In the recess portion removing step that is performed after at least the deforming step, the recess portion 322 is removed. Thus, diffuse reflection of light being caused by the recess portion 322 can be avoided, and degradation of display quality is further reduced.

### Embodiment 5

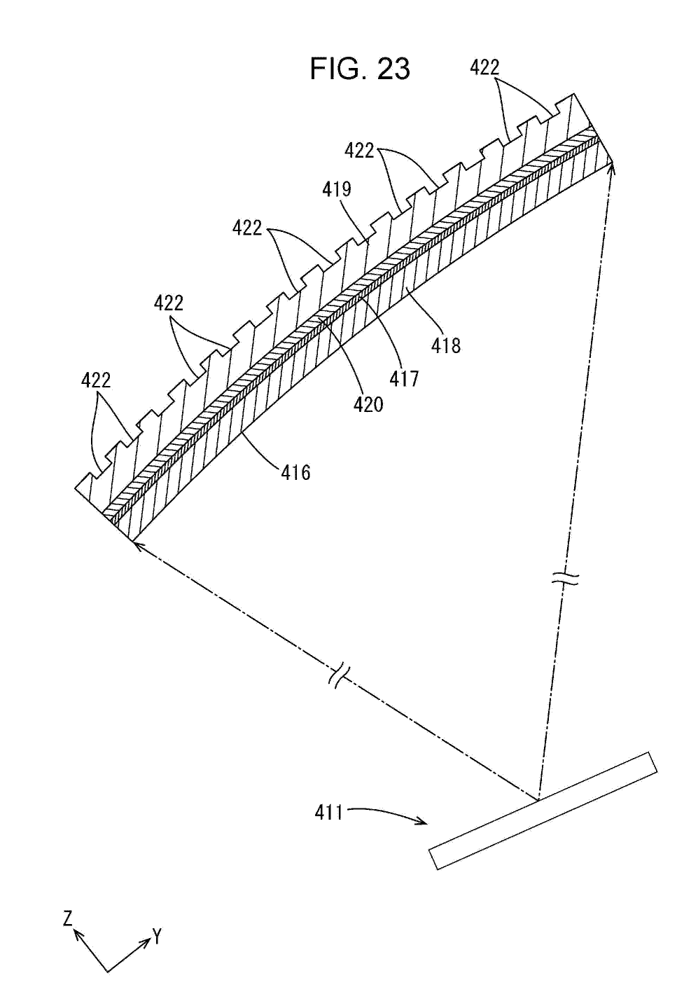

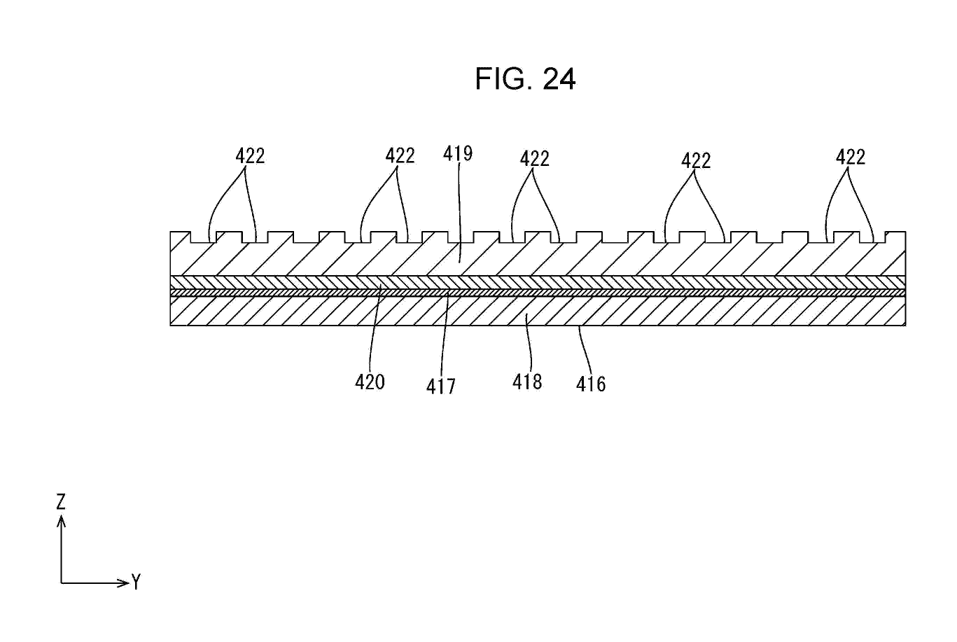

Embodiment 5 of the present invention will be described with FIG. 23 or FIG. 24. Embodiment 5 illustrates opposite arrangement of a cholesteric liquid crystal layer carrier 418 and a substrate 419 from above Embodiment 2. Duplicate descriptions of the same structures and effects as above Embodiment 2 will not be provided.

In a light reflection unit 416 according to the present embodiment, as illustrated in FIG. 23, the cholesteric liquid crystal layer carrier 418 is arranged on a side where light is supplied by a projection device 411, and the substrate 419 is arranged on the opposite side from the side where light is supplied by the projection device 411. The arrangement of the cholesteric liquid crystal layer carrier 418 and the substrate 419 is configured to be opposite to that disclosed in above Embodiment 2. That is, the light reflection unit 416 is configured by stacking the cholesteric liquid crystal layer carrier 418, a cholesteric liquid crystal layer 417, a transparent adhesive layer 420, and the substrate 419 in this order from the side where light is supplied by the projection device 411. The substrate 419 is arranged to be the farthest in a view from the projection device 411. A recess portion 422 is disposed in the plate surface of the substrate 419 on the opposite side from the side where light is supplied by the projection device 411. With such a configuration, light from the projection device 411 is reflected by the cholesteric liquid crystal layer 417 in a stage before reaching the substrate 419, and a virtual image is projected. Therefore, since light that is used in the projected picture does not hit the recess portion 422 of the substrate 419, the light is not subjected to diffuse reflection by the recess portion 422. Accordingly, display quality related to the projected picture is more unlikely to be degraded.

In a method for manufacturing the light reflection unit 416, as illustrated in FIG. 24, when the deforming step is performed after the substrate bonding step, the substrate 419 is subjected to biaxial deformation in such a manner that the surface thereof where the recess portion 422 is formed has a convex shape (refer to FIG. 23). At this point, the recess portion formation portion having a smaller thickness than the recess portion non-formation portion in the substrate 419 allows biaxial deformation to be easily performed along the plan view shape of the recess portion 422. The recess portion formation portion is deformed in such a manner that the interval between the parts of the recess portion non-formation portions having a protruding shape is increased, and stress that is consequently exerted is relieved.

As described heretofore, according to the present embodiment, the substrate 419 in which the recess portion 422 is disposed is arranged on the opposite side of the cholesteric liquid crystal layer 417, which is the optical functional layer, from the side where light is supplied. Accordingly, an optical effect is imparted to light before the recess portion 422 by the cholesteric liquid crystal layer 417 which is the optical functional layer. Accordingly, the optical performance of the cholesteric liquid crystal layer 417, which is the optical functional layer, being degraded by the recess portion 422 is avoided.

### Embodiment 6

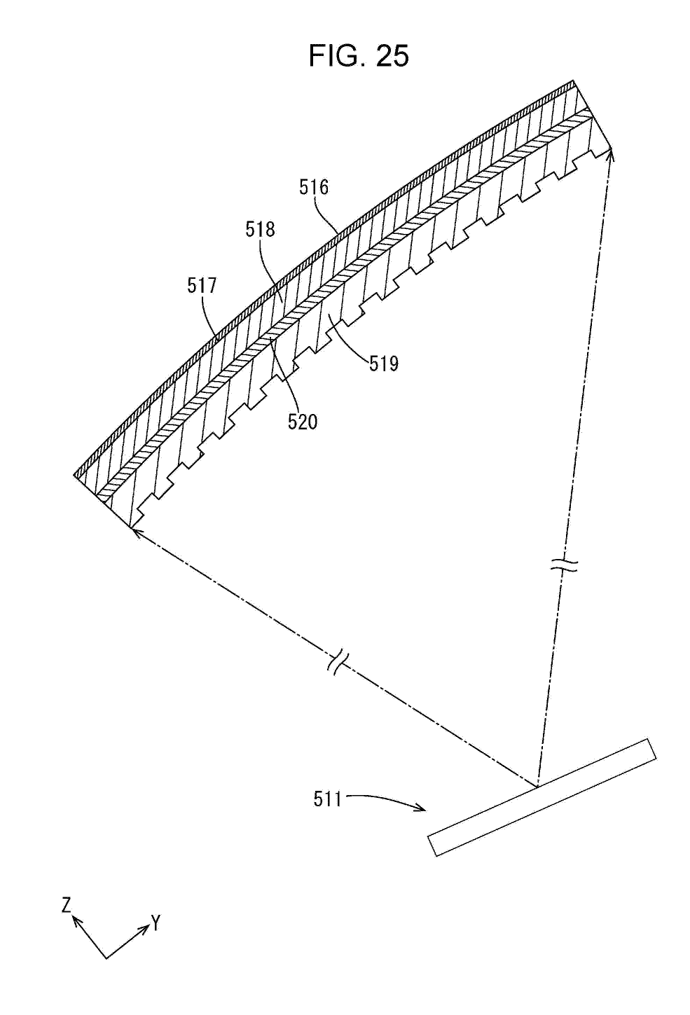

Embodiment 6 of the present invention will be described with FIG. 25. Embodiment 6 illustrates opposite arrangement of a cholesteric liquid crystal layer 517 and a cholesteric liquid crystal layer carrier 518 from above Embodiment 2. Duplicate descriptions of the same structures and effects as above Embodiment 2 will not be provided.

In a light reflection unit 516 according to the present embodiment, as illustrated in FIG. 25, the cholesteric liquid crystal layer carrier 518 is arranged on a side where light is supplied by a projection device 511, and the cholesteric liquid crystal layer 517 is arranged on the opposite side from the side where light is supplied by the projection device 511. The arrangement of the cholesteric liquid crystal layer 517 and the cholesteric liquid crystal layer carrier 518 is configured to be opposite to that disclosed in above Embodiment 2. That is, the light reflection unit 516 is configured by stacking a substrate 519, a transparent adhesive layer 520, the cholesteric liquid crystal layer carrier 518, and the cholesteric liquid crystal layer 517 in this order from the side where light is supplied by the projection device 511. The cholesteric liquid crystal layer 517 is arranged to be the farthest in a view from the projection device 511.

### Embodiment 7

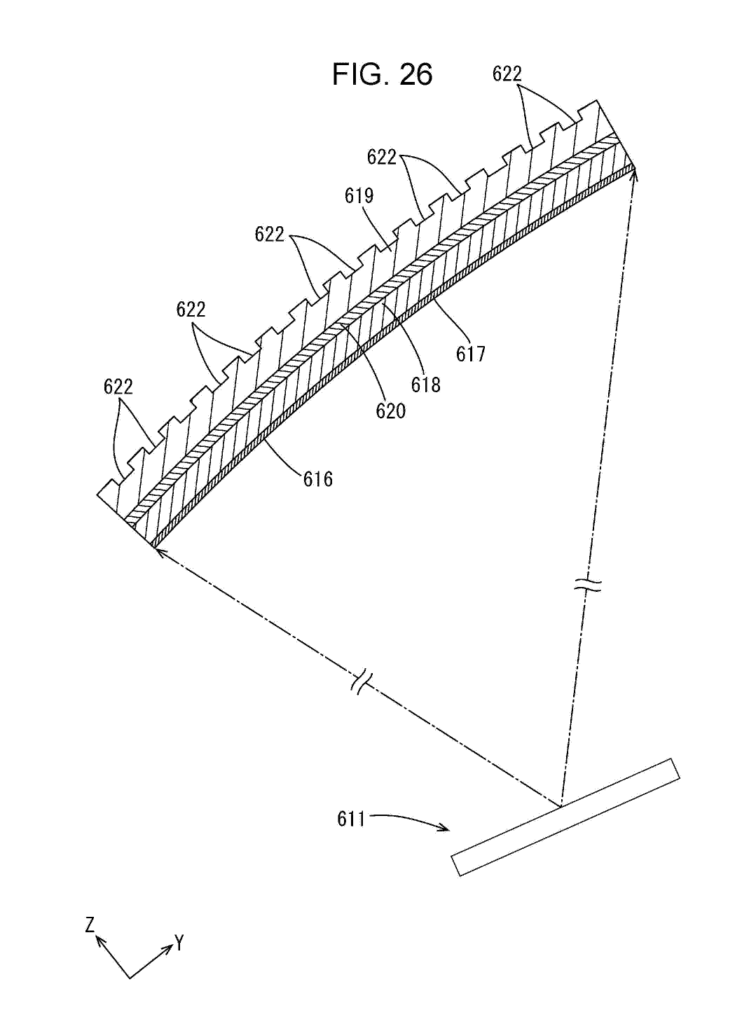

Embodiment 7 of the present invention will be described with FIG. 26. Embodiment 7 illustrates opposite arrangement of a cholesteric liquid crystal layer carrier 618 and a substrate 619 from above Embodiment 6. Duplicate descriptions of the same structures and effects as above Embodiment 6 will not be provided.

In a light reflection unit 616 according to the present embodiment, as illustrated in FIG. 26, the cholesteric liquid crystal layer carrier 618 is arranged on a side where light is supplied by a projection device 611, and the substrate 619 is arranged on the opposite side from the side where light is supplied by the projection device 611. The arrangement of the cholesteric liquid crystal layer carrier 618 and the substrate 619 is configured to be opposite to that disclosed in above Embodiment 6. That is, the light reflection unit 616 is configured by stacking a cholesteric liquid crystal layer 617, the cholesteric liquid crystal layer carrier 618, a transparent adhesive layer 620, and the substrate 619 in this order from the side where light is supplied by the projection device 611. The cholesteric liquid crystal layer 617 is arranged to be the farthest in a view from the projection device 611. A recess portion 622 is disposed in the plate surface of the substrate 619 on the opposite side from the side where light is supplied by the projection device 611.

### Embodiment 8

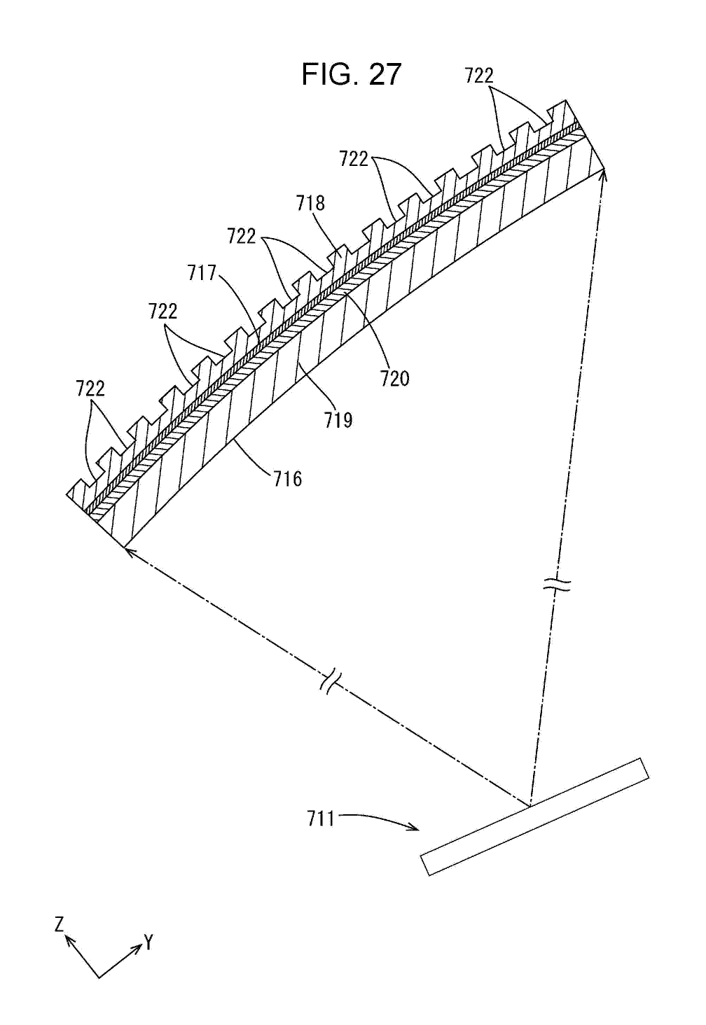

Embodiment 8 of the present invention will be described with FIG. 27. Embodiment 8 illustrates disposing a recess portion 722 in a cholesteric liquid crystal layer carrier 718 and not in a substrate 719 from above Embodiment 2. Duplicate descriptions of the same structures and effects as above Embodiment 2 will not be provided.

As illustrated in FIG. 27, the recess portion 722 for facilitating biaxial deformation is disposed in the plate surface of the cholesteric liquid crystal layer carrier 718 according to the present embodiment. The recess portion 722 is disposed in the plate surface, of both of the outer and inner plate surfaces of the cholesteric liquid crystal layer carrier 718, that is on the opposite side from a cholesteric liquid crystal layer 717 side (the opposite side from a side where light is supplied by a projection device 711). The depth dimension of the recess portion 722 is, for example, approximately 50 μm. In other words, the depth dimension of the recess portion 722 is approximately ½ of the plate thickness dimension of the cholesteric liquid crystal layer carrier 718 (for example, approximately 100 μm). Thus, the thickness dimension of a part of the cholesteric liquid crystal layer carrier 718 where the recess portion 722 is formed, that is, the recess portion formation portion, is approximately ½ (approximately 50 μm) of the plate thickness dimension of the cholesteric liquid crystal layer carrier 718. The recess portion 722 has a constant width, and the plan view shape thereof is a circularly annular shape. The recess portion 722 is arranged to have the center thereof matching the center (a position where two diagonals intersect with each other) of the plate surface of the cholesteric liquid crystal layer carrier 718, that is, concentrically arranged. Other configurations related to the recess portion 722 (the number of installations, the arrangement interval, and the like of recess portions 722 in the short edge direction and the long edge direction of the cholesteric liquid crystal layer carrier 718) are the same as disclosed in above Embodiment 2, and duplicate descriptions thereof will not be provided.

A method for manufacturing a light reflection unit 716 of such a configuration includes the recess portion forming step of forming the recess portion 722 in the plate surface of the cholesteric liquid crystal layer carrier 718, the recess portion forming step being performed prior to the cholesteric liquid crystal layer forming step (deforming step). In the recess portion forming step, the recess portion 722 illustrated by a double-dot chain line in the drawing is formed by cutting the plate surface of a single side of the manufactured cholesteric liquid crystal layer carrier 718 with the cutting device not illustrated. After the recess portion forming step is finished, the cholesteric liquid crystal layer forming step is performed to form the cholesteric liquid crystal layer 717 on the plate surface of the cholesteric liquid crystal layer carrier 718 on the opposite side from the surface where the recess portion 722 is formed. Then, the substrate bonding step is performed to bond the substrate 719 through a transparent adhesive layer 720 to the surface of the cholesteric liquid crystal layer carrier 718 where the cholesteric liquid crystal layer 717 is formed (the plate surface of the cholesteric liquid crystal layer carrier 718 on the opposite side from the surface where the recess portion 722 is formed). Then, in the deforming step, the light reflection unit 716 is sandwiched between one pair of press molds (not illustrated) and subjected to thermal pressing. At this point, since the recess portion 722 of which the plan view shape is a circularly annular shape is formed in the plate surface of the cholesteric liquid crystal layer carrier 718, biaxial deformation of the cholesteric liquid crystal layer carrier 718 is facilitated, and generation of stress is reduced. Specifically, while the cholesteric liquid crystal layer carrier 718 is subjected to biaxial deformation in such a manner that the surface thereof where the recess portion 722 is formed has a convex shape, the recess portion formation portion has a smaller thickness than the recess portion non-formation portion in the cholesteric liquid crystal layer carrier 718. Thus, biaxial deformation is easily performed along the plan view shape of the recess portion 722. The recess portion formation portion is deformed in such a manner that the interval between the parts of the recess portion non-formation portions having a protruding shape is increased, and stress that is consequently exerted is relieved.

As described heretofore, according to the present embodiment, the recess portion 722 of which the plan view shape is a circular shape, an elliptic shape, or a grid shape in the case of biaxial deformation and is a straight linear shape extending in the form of following the deformation direction or a grid shape in the case of uniaxial deformation is disposed in the cholesteric liquid crystal layer carrier 718 which is the optical functional layer carrier. Accordingly, since the plan view shape of the recess portion 722 is a circular shape, an elliptic shape, or a grid shape in the case of biaxial deformation of the cholesteric liquid crystal layer carrier 718 which is the optical functional layer carrier, biaxial deformation of the cholesteric liquid crystal layer carrier 718 which is the optical functional layer carrier can be facilitated. In the case of uniaxial deformation of the cholesteric liquid crystal layer carrier 718 which is the optical functional layer carrier, the recess portion 722 of which the plan view shape is a straight linear shape extending in the form in the deformation direction or a grid shape is disposed. Thus, the recess portion 722 can facilitate uniaxial deformation of the cholesteric liquid crystal layer carrier 718 which is the optical functional layer carrier. Accordingly, since stress that may be exerted by deformation on the cholesteric liquid crystal layer carrier 718 which is the optical functional layer carrier is relieved, creases and the like are unlikely to be generated in the cholesteric liquid crystal layer 717, which is the optical functional layer, disposed on the plate surface of the cholesteric liquid crystal layer carrier 718 which is the optical functional layer carrier.

### Embodiment 9

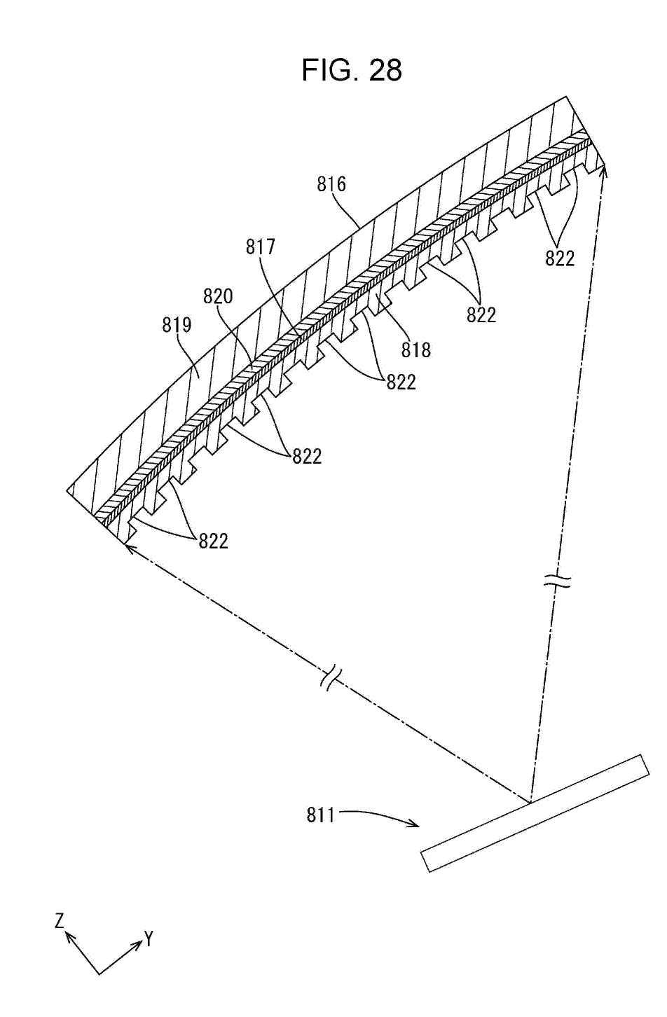

Embodiment 9 of the present invention will be described with FIG. 28. Embodiment 9 illustrates opposite arrangement of a cholesteric liquid crystal layer carrier 818 and a substrate 819 from above Embodiment 8. Duplicate descriptions of the same structures and effects as above Embodiment 8 will not be provided.

In a light reflection unit 816 according to the present embodiment, as illustrated in FIG. 28, the cholesteric liquid crystal layer carrier 818 is arranged on a side where light is supplied by a projection device 811, and the substrate 819 is arranged on the opposite side from the side where light is supplied by the projection device 811. The arrangement of the cholesteric liquid crystal layer carrier 818 and the substrate 819 is configured to be opposite to that disclosed in above Embodiment 8. That is, the light reflection unit 816 is configured by stacking the cholesteric liquid crystal layer carrier 818, a cholesteric liquid crystal layer 817, a transparent adhesive layer 820, and the substrate 819 in this order from the side where light is supplied by the projection device 811. The cholesteric liquid crystal layer carrier 818 is arranged to be the farthest in a view from the projection device 811. A recess portion 822 is disposed in the plate surface of the cholesteric liquid crystal layer carrier 818 on the side where light is supplied by the projection device 811.

### Embodiment 10

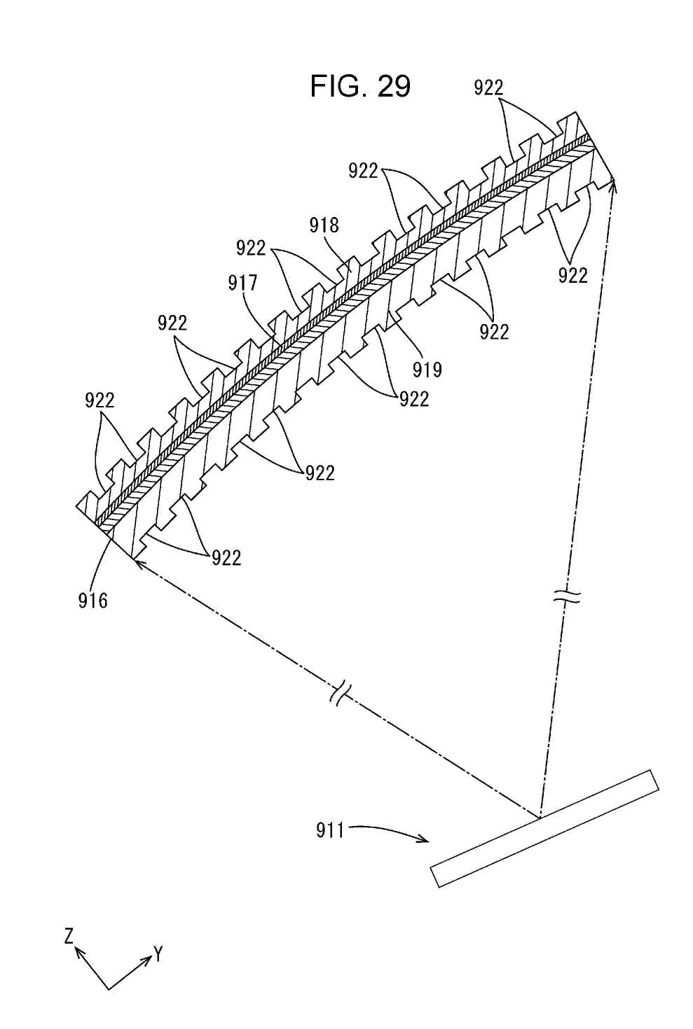

Embodiment 10 of the present invention will be described with FIG. 29. Embodiment 10 illustrates disposing a recess portion 922 in a substrate 919 and also in a cholesteric liquid crystal layer carrier 918 from above Embodiment 2. Duplicate descriptions of the same structures and effects as above Embodiment 2 will not be provided.

As illustrated in FIG. 29, the recess portion 922 is disposed in the cholesteric liquid crystal layer carrier 918 in addition to the substrate 919 in a light reflection unit 916 according to the present embodiment. Specifically, the recess portion 922 is disposed in the plate surface of the substrate 919 on a side where light is supplied by a projection device 911. Meanwhile, the recess portion 922 is disposed in the plate surface of the cholesteric liquid crystal layer carrier 918 on the opposite side from the side where light is supplied by the projection device 911 (cholesteric liquid crystal layer 917 side). The configuration of the recess portion 922 disposed in the substrate 919 is the same as disclosed in above Embodiment 2, and the configuration of the recess portion 922 disposed in the cholesteric liquid crystal layer carrier 918 is the same as disclosed in above Embodiment 8. According to such a configuration, the cholesteric liquid crystal layer carrier 918 and the substrate 919 are easily subjected to biaxial deformation by the respective recess portions 922 in the deforming step. Thus, stress by deformation is further unlikely to affect the cholesteric liquid crystal layer 917, and small deformation such as creases is further unlikely to be generated in the cholesteric liquid crystal layer 917.

### Embodiment 11

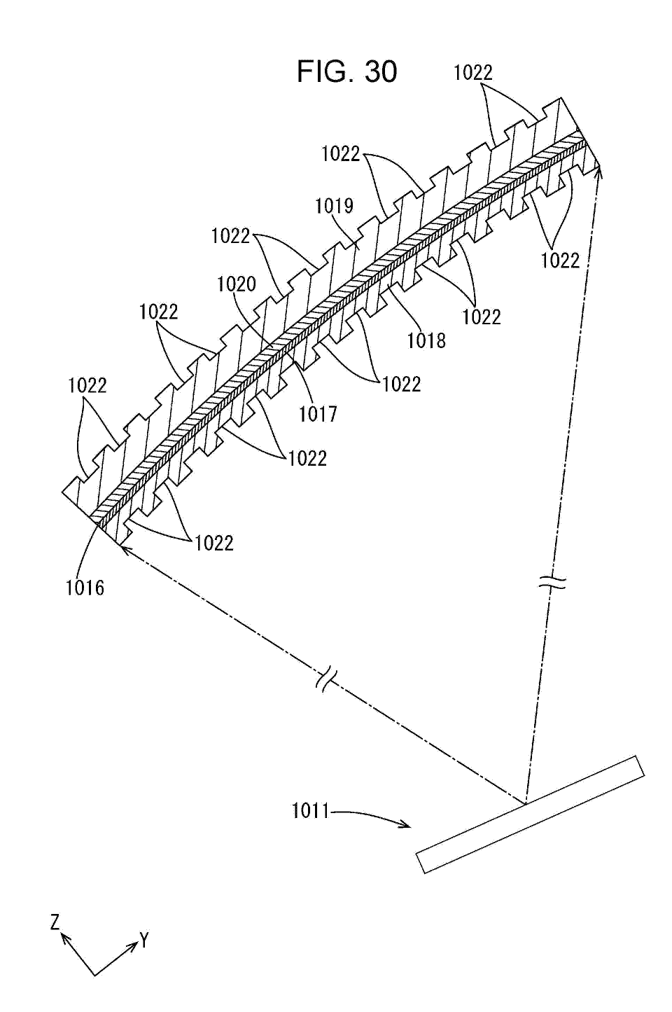

Embodiment 11 of the present invention will be described with FIG. 30. Embodiment 11 illustrates opposite arrangement of a cholesteric liquid crystal layer carrier 1018 and a substrate 1019 from above Embodiment 10. Duplicate descriptions of the same structures and effects as above Embodiment 10 will not be provided.

In a light reflection unit 1016 according to the present embodiment, as illustrated in FIG. 30, the cholesteric liquid crystal layer carrier 1018 is arranged on a side where light is supplied by a projection device 1011, and the substrate 1019 is arranged on the opposite side from the side where light is supplied by the projection device 1011. The arrangement of the cholesteric liquid crystal layer carrier 1018 and the substrate 1019 is configured to be opposite to that disclosed in above Embodiment 10. That is, the light reflection unit 1016 is configured by stacking the cholesteric liquid crystal layer carrier 1018, a cholesteric liquid crystal layer 1017, a transparent adhesive layer 1020, and the substrate 1019 in this order from the side where light is supplied by the projection device 1011. The cholesteric liquid crystal layer carrier 1018 is arranged to be the farthest in a view from the projection device 1011. A recess portion 1022 is disposed in the plate surface of the substrate 1019 on the opposite side from the side where light is supplied by the projection device 1011, and the recess portion 1022 is disposed in the plate surface of the cholesteric liquid crystal layer carrier 1018 on the side where light is supplied by the projection device 1011.

### Embodiment 12

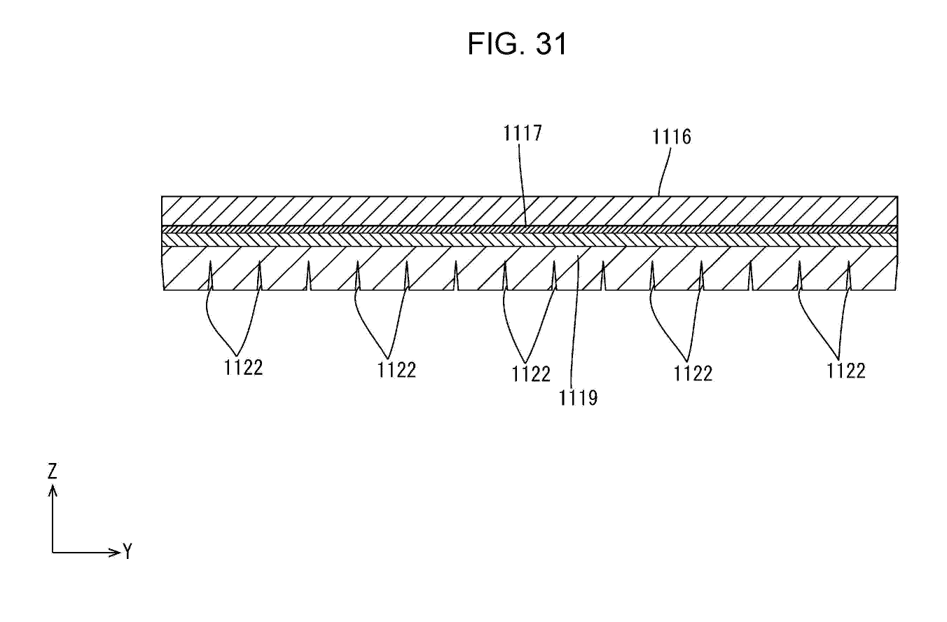

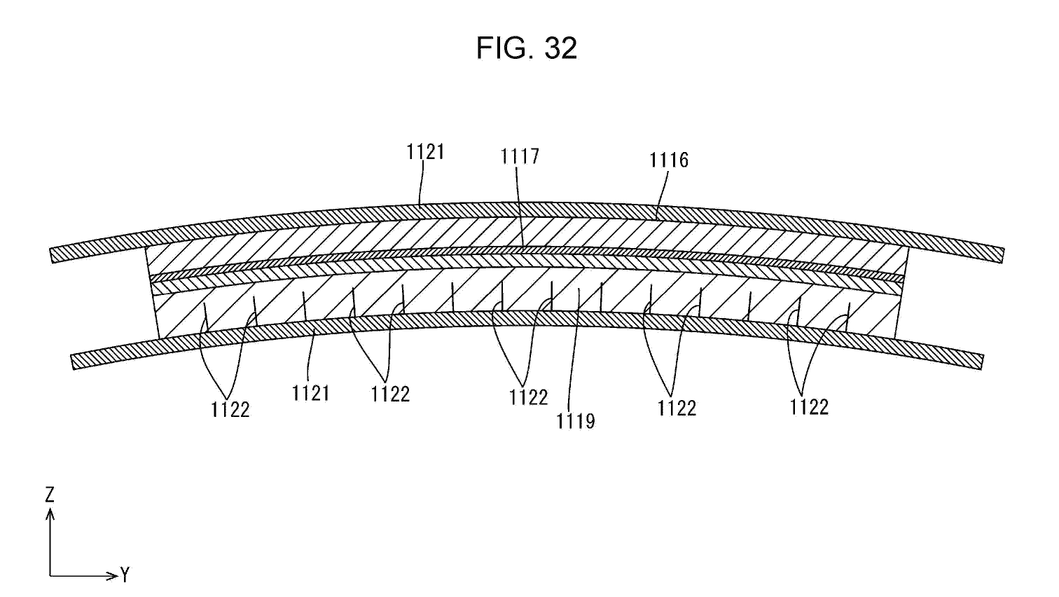

Embodiment 12 of the present invention will be described with FIG. 31 or FIG. 32. Embodiment 12 illustrates changing the sectional shape of a recess portion 1122 from above Embodiment 2. Duplicate descriptions of the same structures and effects as above Embodiment 2 will not be provided.

As illustrated in FIG. 31, the sectional shape of the recess portion 1122 according to the present embodiment is an approximately triangular shape in which the width dimension of the recess portion 1122 is smaller at a larger depth (farther from the surface where the recess portion 1122 is formed) and is conversely larger at a smaller depth (nearer the surface where the recess portion 1122 is formed) in the depth direction (Z axis direction). That is, the recess portion 1122 is formed to have an opening width that increases in a flare shape toward an opening end side. Therefore, the side surface of the recess portion 1122 has an inclined shape with respect to the depth direction. Given that the long edge dimension or the short edge dimension of a substrate 1119 is L, the radius of curvature of the substrate 1119 is r, and the number of recess portions 1122 lined up in the long edge direction or in the short edge direction is n, the inclination angle of the side surface of the recess portion 1122 with respect to the depth direction almost matches θ (the unit thereof is “rad”) that is represented by the equation “L/r(n+1)=θ”. Accordingly, when the substrate 1119 is subjected to biaxial deformation in the deforming step, the above side surfaces that face each other through the recess portion 1122 abuts each other and can control generation of further deformation (refer to FIG. 32). The plan view shape, the arrangement interval, the number of installations, and the like of recess portions 1122 are the same as in above Embodiment 2.

In the recess portion forming step that is included in a method for manufacturing a light reflection unit 1116 of such a configuration, as illustrated in FIG. 31, the recess portion 1122 of which the sectional shape is an approximately triangular shape is formed by cutting the plate surface of a single side of the manufactured substrate 1119 with the cutting device not illustrated. After the recess portion forming step is finished, the substrate bonding step is performed, and then, the deforming step is performed. In the deforming step, as illustrated in FIG. 32, the light reflection unit 1116 is sandwiched between one pair of press molds 1121 and subjected to thermal pressing. In the deforming step, while the substrate 1119 is subjected to biaxial deformation in such a manner that the surface thereof where the recess portion 1122 is formed has a concave shape, biaxial deformation of the substrate 1119 proceeds until the side surfaces that face each other through the recess portion 1122 approach each other by narrowing the recess portion 1122 and abut each other in parallel. Accordingly, since stress that is exerted on the substrate 1119 is relieved, small deformation such as creases is unlikely to be generated in the cholesteric liquid crystal layer 1117.

### Embodiment 13

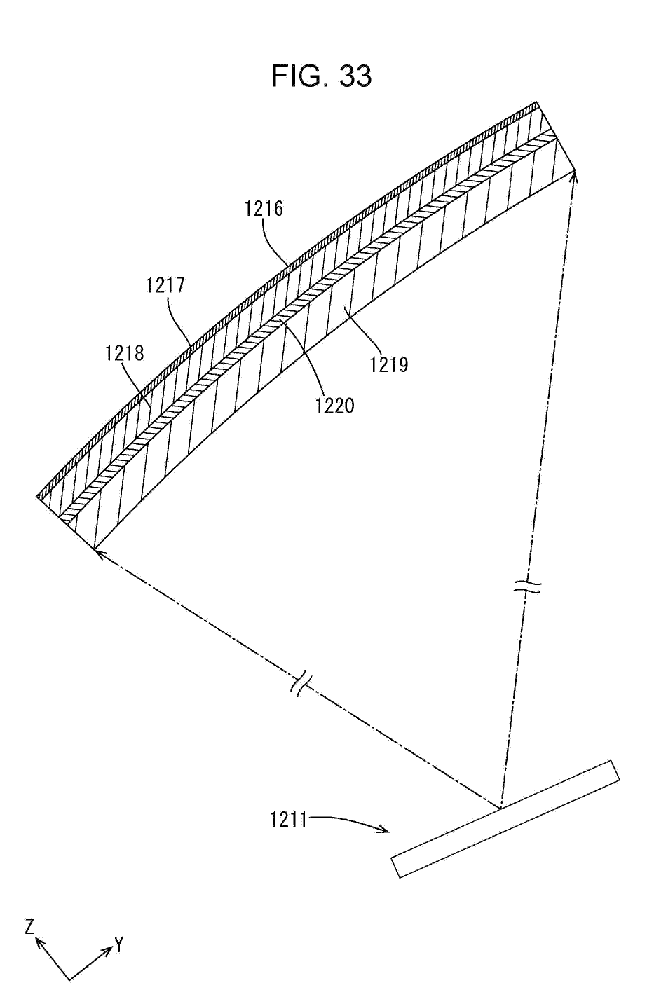

Embodiment 13 of the present invention will be described with FIG. 33. Embodiment 13 illustrates opposite arrangement of a cholesteric liquid crystal layer 1217 and a cholesteric liquid crystal layer carrier 1218 from above Embodiment 1. Duplicate descriptions of the same structures and effects as above Embodiment 1 will not be provided.

In a light reflection unit 1216 according to the present embodiment, as illustrated in FIG. 33, the cholesteric liquid crystal layer carrier 1218 is arranged on a side where light is supplied by a projection device 1211, and the cholesteric liquid crystal layer 1217 is arranged on the opposite side from the side where light is supplied by the projection device 1211. The arrangement of the cholesteric liquid crystal layer 1217 and the cholesteric liquid crystal layer carrier 1218 is configured to be opposite to that disclosed in above Embodiment 1. That is, the light reflection unit 1216 is configured by stacking a substrate 1219, a transparent adhesive layer 1220, the cholesteric liquid crystal layer carrier 1218, and the cholesteric liquid crystal layer 1217 in this order from the side where light is supplied by the projection device 1211. The cholesteric liquid crystal layer 1217 is arranged to be the farthest in a view from the projection device 1211.

### Embodiment 14

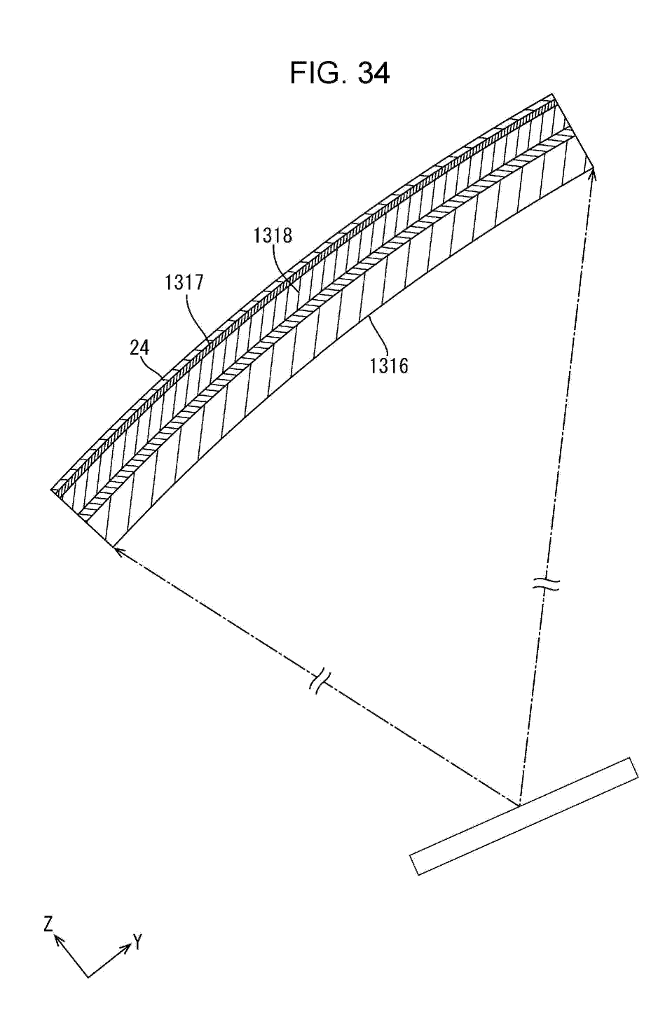

Embodiment 14 of the present invention will be described with FIG. 34. Embodiment 14 illustrates covering a cholesteric liquid crystal layer 1317 with a cover layer 24 from above Embodiment 13. Duplicate descriptions of the same structures and effects as above Embodiment 13 will not be provided.

As illustrated in FIG. 34, a light reflection unit 1316 according to the present embodiment includes the cover layer (protective layer) 24 that is arranged in the form of covering the cholesteric liquid crystal layer 1317. The cover layer 24 is configured of a transparent synthetic resin material and is arranged in the form of covering the entire area of the cholesteric liquid crystal layer 1317 on the opposite side from a cholesteric liquid crystal layer carrier 1318 side. Thus, the cholesteric liquid crystal layer 1317 can be protected. The cover layer 24 is configured of, for example, a hardcoat layer, an overcoat layer, or an oil-repellent coating layer and is formed to be stacked on the cholesteric liquid crystal layer 1317 by a technique such as vapor deposition.

### Embodiment 15

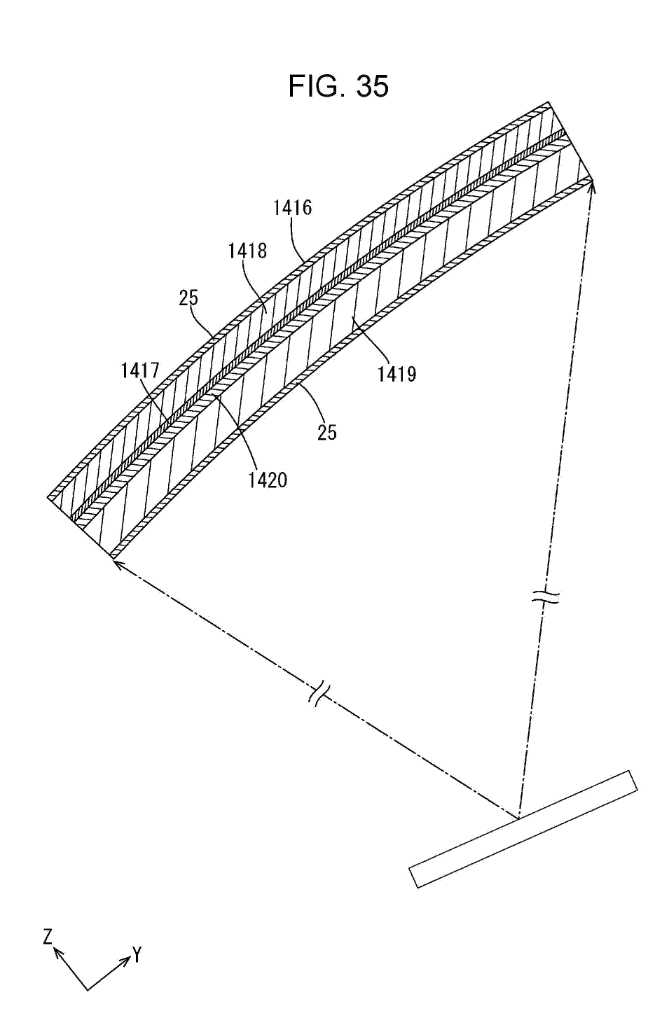

Embodiment 15 of the present invention will be described with FIG. 35. Embodiment 15 illustrates disposing an antireflection layer 25 from above Embodiment 1. Duplicate descriptions of the same structures and effects as above Embodiment 1 will not be provided.

As illustrated in FIG. 35, a light reflection unit 1416 according to the present embodiment is configured in such a manner that the antireflection layer 25 that prevents reflection of light is disposed on both of the outer and inner surfaces of the light reflection unit 1416. Since generation of surface reflection in the light reflection unit 1416 is reduced by the antireflection layers 25, the state of the observer visually recognizing a double image is unlikely to be generated. One antireflection layer 25 is arranged in the form of covering almost the entire area of the plate surface of a cholesteric liquid crystal layer carrier 1418 on the opposite side from a cholesteric liquid crystal layer 1417 side. The other antireflection layer 25 is arranged in the form of covering almost the entire area of the plate surface of a substrate 1419 on the opposite side from a transparent adhesive layer 1420 side. Each antireflection layer 25 is configured of a metal film, a dielectric multilayer film, or the like and is formed by vapor deposition directly on the plate surfaces of each of the cholesteric liquid crystal layer carrier 1418 and the substrate 1419. In addition, each antireflection layer 25 may be made as a film having a surface on which minute protrusions are formed (for example, a Motheye film (“Motheye” is a registered trademark of Dai Nippon Printing Co., Ltd.)), and the film may be bonded to the plate surfaces of each of the cholesteric liquid crystal layer carriers 1418 and the substrate 1419.

### Embodiment 16

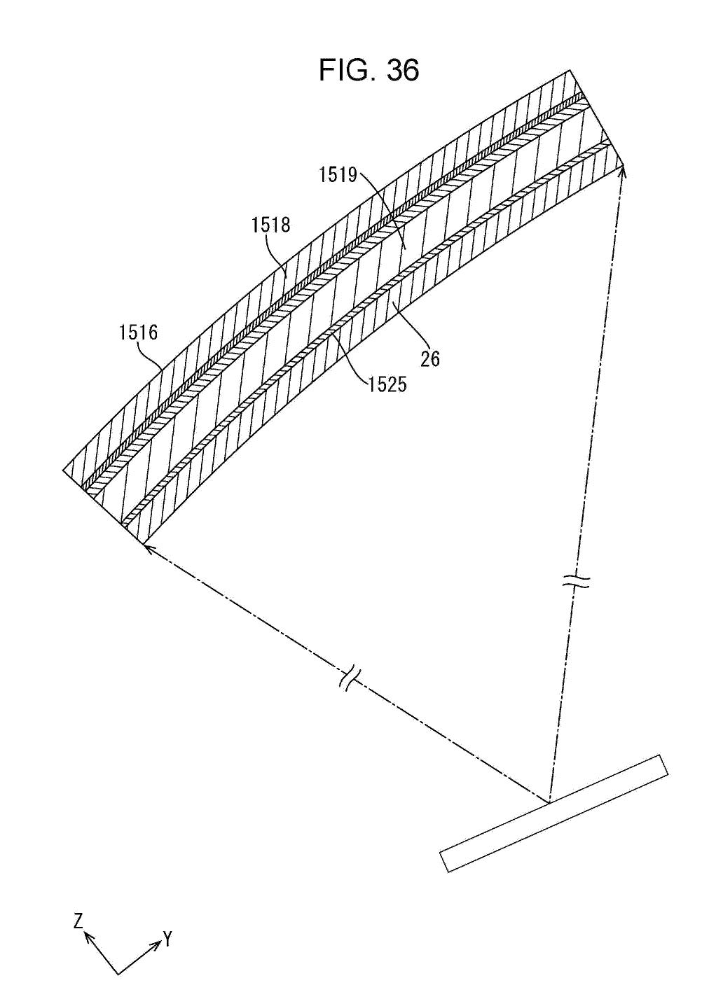

Embodiment 16 of the present invention will be described with FIG. 36. Embodiment 16 illustrates changing the number of installations or the like of antireflection layers 1525 from above Embodiment 15. Duplicate descriptions of the same structures and effects as above Embodiment 15 will not be provided.

As illustrated in FIG. 36, the antireflection layer (second optical functional layer) 1525 according to the present embodiment is installed only on a substrate 1519 side and is not installed on a cholesteric liquid crystal layer carrier 1518 side. Furthermore, the antireflection layer 1525 is not directly disposed on the plate surface of the substrate 1519 and is disposed in an antireflection layer carrier (second optical functional layer carrier) 26. The plan view shape of the antireflection layer carrier 26 is a widthwise long rectangular shape in the same manner as the light reflection unit 1516, and the antireflection layer carrier 26 has a plate shape having a predetermined plate thickness. The antireflection layer 1525 is disposed on the plate surface of the antireflection layer carrier 26 on the substrate 1519 side and is arranged to be sandwiched between the antireflection layer carrier 26 and the substrate 1519.

The antireflection layer carrier 26 is configured of a synthetic resin material such as polyethylene terephthalate (PET), has excellent light transmissivity, and is almost transparent. The antireflection layer carrier 26 is preferably configured of the same material as the cholesteric liquid crystal layer carrier 1518. The antireflection layer carrier 26 acquires high mechanical strength or the like by being subjected to stretching, so-called biaxial stretching, in two orthogonal directions along the plate surface thereof, that is, the short edge direction (Y axis direction) and the long edge direction (X axis direction). The antireflection layer carrier 26 has a stretch ratio (extensibility) varying according to two stretching directions, that is, stretch anisotropy, and has the stretch ratio in the short edge direction (Y axis direction) larger than the stretch ratio in the long edge direction (X axis direction). That is, the antireflection layer carrier 26, in the same manner as the cholesteric liquid crystal layer carrier 1518, has the short edge direction (Y axis direction) matching the high stretching direction and has the long edge direction (X axis direction) matching the low stretching direction. Furthermore, when the antireflection layer carrier 26 is subjected to biaxial stretching, the antireflection layer carrier 26 is heated to a temperature (hereinafter, referred to as a heat setting temperature) higher than the glass transition temperature thereof, and the heat setting temperature is almost the same as the heat setting temperature related to the cholesteric liquid crystal layer carrier 1518.

As described above, the antireflection layer carrier 26 has the high stretching direction and the low stretching direction at the time of biaxial stretching that respectively match the high stretching direction and the low stretching direction at the time of biaxial stretching of the cholesteric liquid crystal layer carrier 1518. Therefore, the antireflection layer carrier 26, in the same manner as the cholesteric liquid crystal layer carrier 1518, is subjected to biaxial deformation in such a manner that the large elongation amount direction in which the amount of elongation by deformation is relatively large matches the low stretching direction at the time of biaxial stretching, and that the small elongation amount direction in which the amount of elongation by deformation is relatively small matches the high stretching direction at the time of biaxial stretching. That is, the antireflection layer carrier 26, in the same manner as the cholesteric liquid crystal layer carrier 1518, has the low stretching direction at the time of biaxial stretching, that is, the direction in which the elongation potential is great, matching the large elongation amount direction and has the high stretching direction at the time of biaxial stretching, that is, the direction in which the elongation potential is small, matching the small elongation amount direction. Thus, at the time of biaxial deformation, elongation in the large elongation amount direction is smoothly performed, and elongation in the small elongation amount direction is sufficiently performed. Accordingly, since biaxial deformation is unlikely to generate creases and the like in the antireflection layer 1525 disposed on the plate surface of the antireflection layer carrier 26, the antireflection layer 1525 can properly exhibit optical performance, and display quality is more unlikely to be degraded.

As described heretofore, according to the present embodiment, included are the antireflection layer 1525 that is the second optical functional layer imparting an optical effect to light; and the antireflection layer carrier 26 that is the second optical functional layer carrier having a plate surface with the antireflection layer 1525, which is the second optical functional layer, disposed thereon, being directly or indirectly bonded to the cholesteric liquid crystal layer carrier 1518 which is the optical functional layer carrier, being subjected to biaxial stretching or uniaxial stretching in such a manner that one of two intersecting directions along the plate surface is the low stretching direction or the non-stretching direction and that the other is the high stretching direction or the stretching direction, and furthermore, being subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction. Accordingly, since the antireflection layer carrier 26 which is the second optical functional layer carrier of a plate shape in which the antireflection layer 1525, which is the second optical functional layer imparting an optical effect to light, is disposed on the plate surface is subjected to biaxial stretching or uniaxial stretching, the antireflection layer carrier 26 can acquire sufficient strength or the like. In addition, the antireflection layer carrier 26 which is the second optical functional layer carrier is directly or indirectly bonded to the cholesteric liquid crystal layer carrier 1518, which is the optical functional layer carrier, and is subjected to biaxial deformation or uniaxial deformation as follows. That is, in the case of biaxial deformation of the antireflection layer carrier 26 which is the second optical functional layer carrier, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation in the large elongation amount direction by deformation is smoothly performed, and elongation in the small elongation amount direction by deformation is sufficiently performed. Accordingly, stress that may be exerted by deformation on the antireflection layer carrier 26, which is the second optical functional layer carrier, is suitably relieved, and creases and the like are unlikely to be generated in the antireflection layer 1525 which is the second optical functional layer. In the case of uniaxial deformation of the antireflection layer carrier 26 which is the second optical functional layer carrier, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation in the deformation direction by deformation is smoothly performed. Accordingly, stress that may be exerted by deformation on the antireflection layer carrier 26, which is the second optical functional layer carrier, is suitably relieved, and creases and the like are unlikely to be generated in the antireflection layer 1525 which is the second optical functional layer. Accordingly, the optical performance of the antireflection layer 1525 which is the second optical functional layer can be favorably secured.

The second optical functional layer is configured of the antireflection layer 1525 that prevents reflection of light. Accordingly, the optical performance of the second optical functional layer configured of the antireflection layer 1525 can be favorably secured.

### Embodiment 17

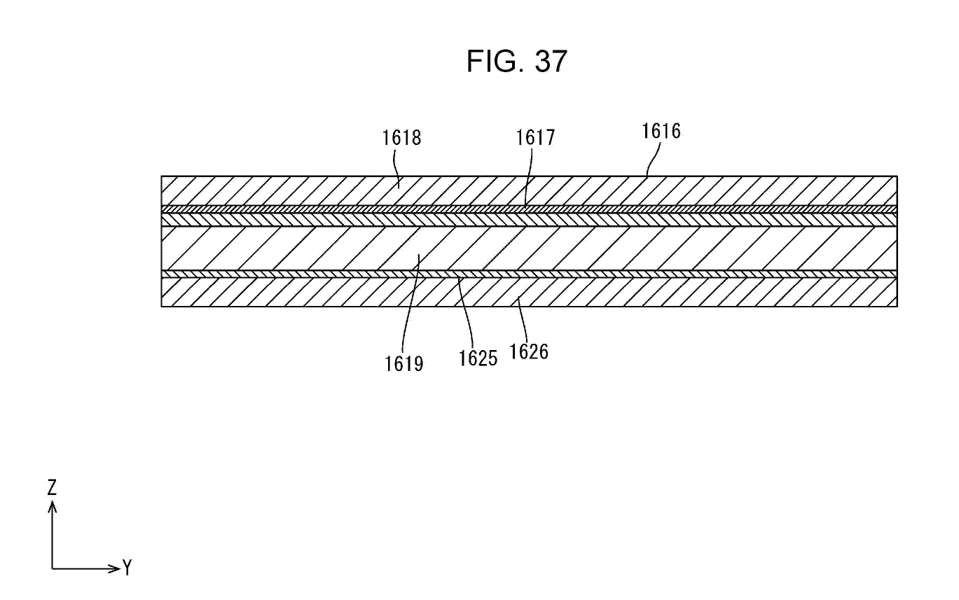

Embodiment 17 of the present invention will be described with FIG. 37 to FIG. 39. Embodiment 17 illustrates changing a method for manufacturing a light reflection unit 1616 from above Embodiment 16. Duplicate descriptions of the same structures and effects as above Embodiment 16 will not be provided.

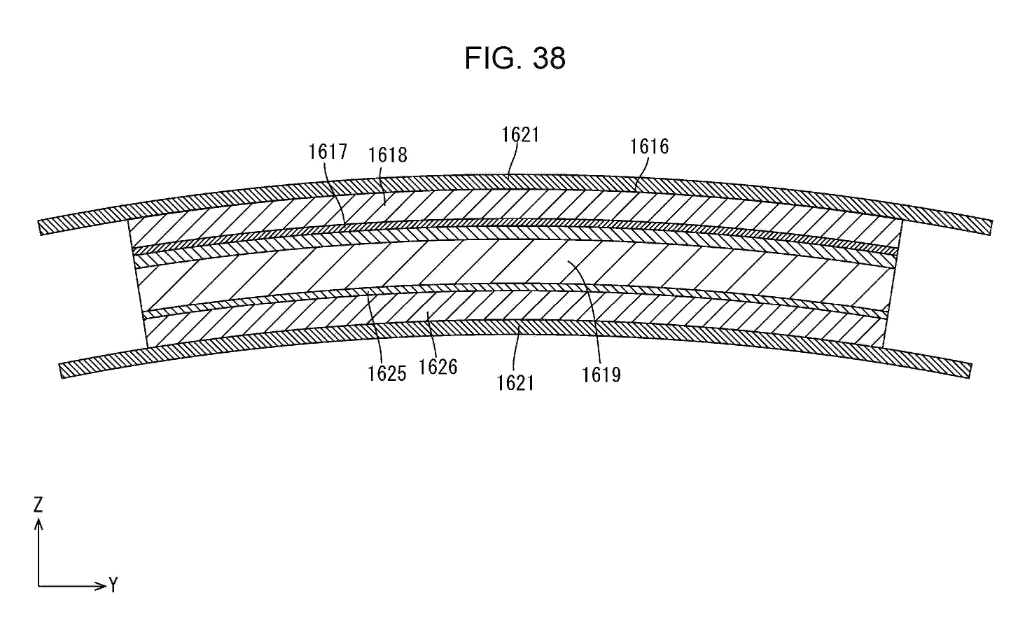

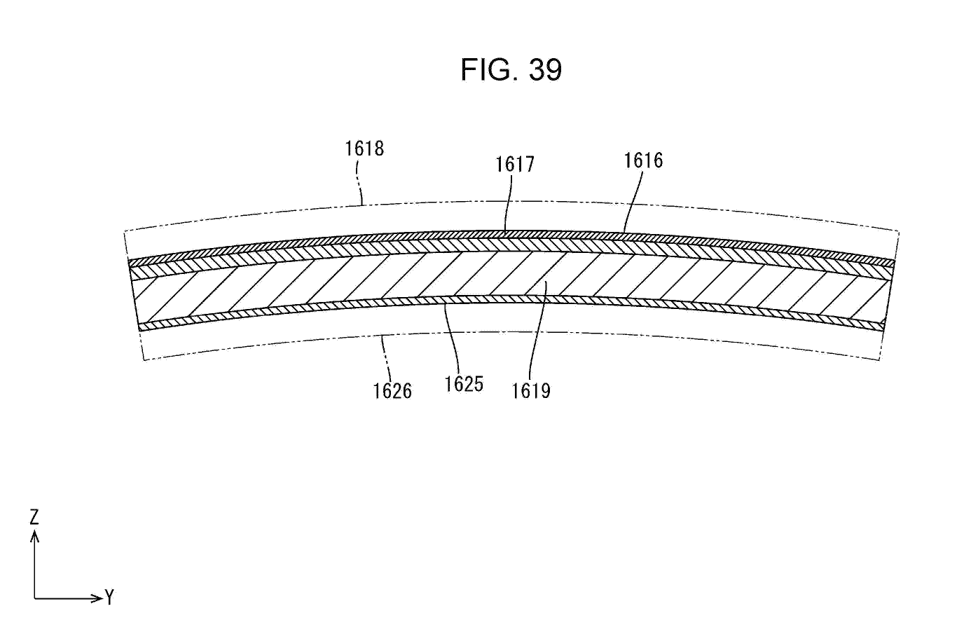

As illustrated in FIG. 37 to FIG. 39, the method for manufacturing the light reflection unit 1616 according to the present embodiment includes a carrier detaching step of detaching a cholesteric liquid crystal layer carrier 1618 and the antireflection layer carrier 1626 after at least the deforming step. Specifically, in the method for manufacturing the light reflection unit 1616, the substrate bonding step is performed to bond, as illustrated in FIG. 37, a cholesteric liquid crystal layer 1617 along with the cholesteric liquid crystal layer carrier 1618 and an antireflection layer 1625 along with an antireflection layer carrier 1626 to a substrate 1619. In the deforming step subsequent to the substrate bonding step, as illustrated in FIG. 38, the light reflection unit 1616 is sandwiched between one pair of press molds 1621 and subjected to thermal pressing, and the light reflection unit 1616 is subjected to biaxial deformation. The carrier detaching step is performed after the deforming step. In the carrier detaching step, as illustrated in FIG. 39, the cholesteric liquid crystal layer carrier 1618 is detached from the cholesteric liquid crystal layer 1617, and the antireflection layer carrier 1626 is detached from the antireflection layer 1625 (in FIG. 39, the cholesteric liquid crystal layer carrier 1618 and the cholesteric liquid crystal layer carrier 1618 detached are illustrated by a double-dot chain line). Performing the carrier detaching step allows the cholesteric liquid crystal layer 1617 and the antireflection layer 1625 to be held by the substrate 1619. Accordingly, the light reflection unit 1616 can be thin and lightweight.

As described heretofore, according to the present embodiment, included are the substrate bonding step of directly or indirectly bonding the substrate 1619 having a plate shape of a larger plate thickness than the cholesteric liquid crystal layer carrier 1618, which is the optical functional layer carrier, to the cholesteric liquid crystal layer 1617, which is the optical functional layer, the substrate bonding step being performed between the cholesteric liquid crystal layer, which is the optical functional layer, forming step and the deforming step; and the carrier detaching step of detaching the cholesteric liquid crystal layer carrier 1618, which is the optical functional layer carrier, from the cholesteric liquid crystal layer 1617, which is the optical functional layer, the carrier detaching step being performed after at least the deforming step. Accordingly, since, in the substrate bonding step, the substrate 1619 having a plate shape of a larger plate thickness than the cholesteric liquid crystal layer carrier 1618, which is the optical functional layer carrier, is directly or indirectly bonded to the cholesteric liquid crystal layer 1617 which is the optical functional layer, the cholesteric liquid crystal layer 1617 which is the optical functional layer is held by the substrate 1619 even if the carrier detaching step is performed after the deforming step to detach the cholesteric liquid crystal layer carrier 1618, which is the optical functional layer carrier, from the cholesteric liquid crystal layer 1617 which is the optical functional layer. Accordingly, the combiner can be thin and lightweight. In the deforming step, the cholesteric liquid crystal layer carrier 1618 which is the optical functional layer carrier makes creases and the like unlikely to be generated in the cholesteric liquid crystal layer 1617 which is the optical functional layer.

### Embodiment 18

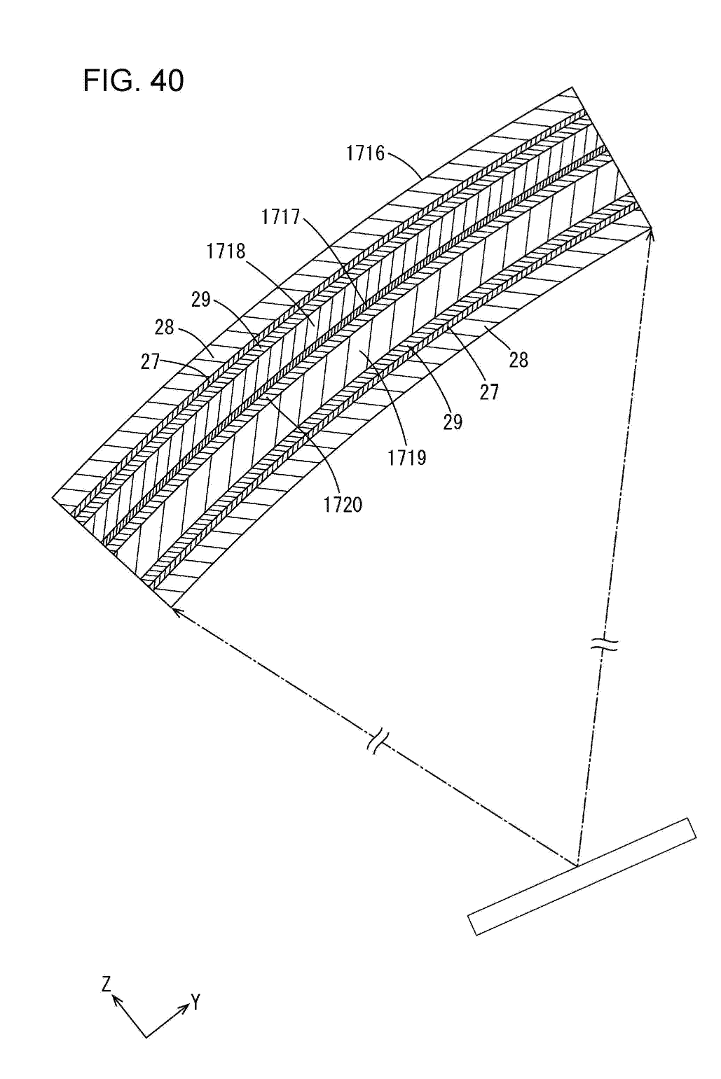

Embodiment 18 of the present invention will be described with FIG. 40. Embodiment 18 illustrates disposing an ultraviolet ray absorption layer 27 from above Embodiment 1. Duplicate descriptions of the same structures and effects as above Embodiment 1 will not be provided.

As illustrated in FIG. 40, a light reflection unit 1716 according to the present embodiment is configured in such a manner that the ultraviolet ray absorption layer (second optical functional layer) 27 that absorbs ultraviolet rays is disposed on both of the outer and inner surfaces of the light reflection unit 1716. The ultraviolet ray absorption layer 27 has the same function as the antireflection layer disclosed in above Embodiment 15 and also has antireflection function of preventing reflection of light. An ultraviolet ray absorption agent is added to the ultraviolet ray absorption layer 27, and the ultraviolet ray absorption layer 27 can exhibit ultraviolet ray absorbing function. One ultraviolet ray absorption layer 27 is arranged in the form of covering almost the entire area of the plate surface of a cholesteric liquid crystal layer carrier 1718 on the opposite side from a cholesteric liquid crystal layer 1717 side. The other ultraviolet ray absorption layer 27 is arranged in the form of covering almost the entire area of the plate surface of a substrate 1719 on the opposite side from a transparent adhesive layer 1720 side. The ultraviolet ray absorption layers 27 are not directly disposed on the plate surfaces of the cholesteric liquid crystal layer carrier 1718 and the substrate 1719 and are disposed in an ultraviolet ray absorption layer carrier (second optical functional layer carrier) 28. The plan view shape of the ultraviolet ray absorption layer carrier 28 is a widthwise long rectangular shape in the same manner as the light reflection unit 1716, and the ultraviolet ray absorption layer carrier 28 has a plate shape having a predetermined plate thickness. One ultraviolet ray absorption layer 27 is disposed on the plate surface of the ultraviolet ray absorption layer carrier 28 on the cholesteric liquid crystal layer carrier 1718 side and is bonded to the cholesteric liquid crystal layer carrier 1718 through a transparent adhesive layer 29. The other ultraviolet ray absorption layer 27 is disposed on the plate surface of the ultraviolet ray absorption layer carrier 28 on the substrate 1719 side and is bonded to the substrate 1719 through the transparent adhesive layer 29.

The ultraviolet ray absorption layer carrier 28 is configured of a synthetic resin material such as triacetylcellulose (TAC), has excellent light transmissivity, and is almost transparent. The ultraviolet ray absorption layer carrier 28 acquires high mechanical strength or the like by being subjected to stretching, so-called biaxial stretching, in two orthogonal directions along the plate surface thereof, that is, the short edge direction (Y axis direction) and the long edge direction (X axis direction). The ultraviolet ray absorption layer carrier 28 has a stretch ratio (extensibility) varying according to two stretching directions, that is, stretch anisotropy, and has the stretch ratio in the short edge direction (Y axis direction) larger than the stretch ratio in the long edge direction (X axis direction). That is, the ultraviolet ray absorption layer carrier 28, in the same manner as the cholesteric liquid crystal layer carrier 1718, has the short edge direction (Y axis direction) matching the high stretching direction and has the long edge direction (X axis direction) matching the low stretching direction. Furthermore, when the ultraviolet ray absorption layer carrier 28 is subjected to biaxial stretching, the ultraviolet ray absorption layer carrier 28 is heated to a temperature (hereinafter, referred to as a heat setting temperature) higher than the glass transition temperature thereof.

As described above, the ultraviolet ray absorption layer carrier 28 has the high stretching direction and the low stretching direction at the time of biaxial stretching that respectively match the high stretching direction and the low stretching direction at the time of biaxial stretching of the cholesteric liquid crystal layer carrier 1718. Therefore, the ultraviolet ray absorption layer carrier 28, in the same manner as the cholesteric liquid crystal layer carrier 1718, is subjected to biaxial deformation in such a manner that the large elongation amount direction in which the amount of elongation by deformation is relatively large matches the low stretching direction at the time of biaxial stretching, and that the small elongation amount direction in which the amount of elongation by deformation is relatively small matches the high stretching direction at the time of biaxial stretching. That is, the ultraviolet ray absorption layer carrier 28, in the same manner as the cholesteric liquid crystal layer carrier 1718, has the low stretching direction at the time of biaxial stretching, that is, the direction in which the elongation potential is great, matching the large elongation amount direction and has the high stretching direction at the time of biaxial stretching, that is, the direction in which the elongation potential is small, matching the small elongation amount direction. Thus, at the time of biaxial deformation, elongation in the large elongation amount direction is smoothly performed, and elongation in the small elongation amount direction is sufficiently performed. Accordingly, since biaxial deformation is unlikely to generate creases and the like in the ultraviolet ray absorption layer 27 disposed on the plate surface of the ultraviolet ray absorption layer carrier 28, the ultraviolet ray absorption layer 27 can property exhibit optical performance, and display quality is more unlikely to be degraded.

As described heretofore, according to the present embodiment, the second optical functional layer is configured of the ultraviolet ray absorption layer 27 that selectively absorbs ultraviolet rays. Accordingly, the optical performance of the second optical functional layer configured of the ultraviolet ray absorption layer 27 can be favorably secured.

### Embodiment 19

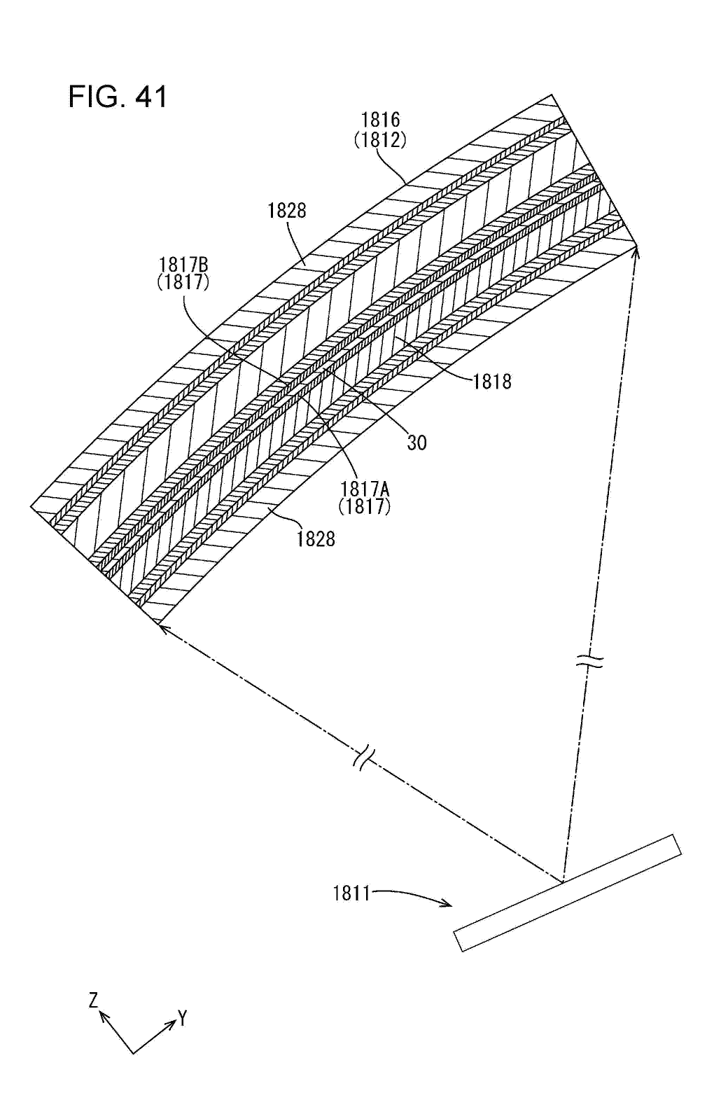

Embodiment 19 of the present invention will be described with FIG. 41. Embodiment 19 illustrates changing a configuration of a cholesteric liquid crystal layer 1817 and disposing a ½ wavelength retardation plate 30 from above Embodiment 18. Duplicate descriptions of the same structures and effects as above Embodiment 18 will not be provided.

As illustrated in FIG. 41, a light reflection unit 1816 according to the present embodiment is configured in such a manner that the cholesteric liquid crystal layer 1817 has a double layer structure and incorporates the ½ wavelength retardation plate 30. Specifically, the cholesteric liquid crystal layer 1817 has a stack structure of a first cholesteric liquid crystal layer 1817A and a second cholesteric liquid crystal layer 1817B that selectively reflects the same circularly-polarized light as the first cholesteric liquid crystal layer 1817A. The ½ wavelength retardation plate 30 is for converting any one of left handed circularly-polarized light and right handed circularly-polarized light into another and is arranged in the form of being interposed between the first cholesteric liquid crystal layer 1817A and the second cholesteric liquid crystal layer 1817B in the present embodiment. Accordingly, if both left handed circularly-polarized light and right handed circularly-polarized light are included in light that is projected from a projection device 1811 to a combiner 1812, first, only one circularly-polarized light of both of the left handed circularly-polarized light and the right handed circularly-polarized light is selectively reflected by the first cholesteric liquid crystal layer 1817A and used in display, and the other circularly-polarized light is transmitted by the second cholesteric liquid crystal layer 1817B. The other circularly-polarized light transmitted by the first cholesteric liquid crystal layer 1817A is converted into the one circularly-polarized light by the ½ wavelength retardation plate 30. Since the second cholesteric liquid crystal layer 1817B selectively reflects the same circularly-polarized light as the first cholesteric liquid crystal layer 1817A, the one circularly-polarized light converted by the ½ wavelength retardation plate 30 is reflected and used in display. Accordingly, since both of the left handed circularly-polarized light and the right handed circularly-polarized light included in the light projected from the projection device 1811 to the combiner 1812 are used in display, the efficiency of use of light is excellent.

The ½ wavelength retardation plate 30 exhibits retardation compensating function by being subjected to stretching, so-called biaxial stretching, in two orthogonal directions along the plate surface thereof, that is, the short edge direction (Y axis direction) and the long edge direction (X axis direction). The ½ wavelength retardation plate 30 is configured of a synthetic resin material such as polycarbonate (PC), has excellent light transmissivity, and is almost transparent. The ½ wavelength retardation plate 30 has a stretch ratio (extensibility) varying according to two stretching directions, that is, stretch anisotropy, and has the stretch ratio in the short edge direction (Y axis direction) larger than the stretch ratio in the long edge direction (X axis direction). That is, the ½ wavelength retardation plate 30, in the same manner as a cholesteric liquid crystal layer carrier 1818 and an ultraviolet ray absorption layer carrier 1828, has the short edge direction (Y axis direction) matching the high stretching direction and has the long edge direction (X axis direction) matching the low stretching direction. Furthermore, when the ½ wavelength retardation plate 30 is subjected to biaxial stretching, the ½ wavelength retardation plate 30 is heated to a temperature (hereinafter, referred to as a heat setting temperature) higher than the glass transition temperature thereof.

As described above, the ½ wavelength retardation plate 30 has the high stretching direction and the low stretching direction at the time of biaxial stretching that respectively match the high stretching direction and the low stretching direction at the time of biaxial stretching of the cholesteric liquid crystal layer carrier 1818 and the ultraviolet ray absorption layer carrier 1828. Therefore, the ½ wavelength retardation plate 30, in the same manner as the cholesteric liquid crystal layer carrier 1818 and the ultraviolet ray absorption layer carrier 1828, is subjected to biaxial deformation in such a manner that the large elongation amount direction in which the amount of elongation by deformation is relatively large matches the low stretching direction at the time of biaxial stretching, and that the small elongation amount direction in which the amount of elongation by deformation is relatively small matches the high stretching direction at the time of biaxial stretching. That is, the ½ wavelength retardation plate 30, in the same manner as the cholesteric liquid crystal layer carrier 1818 and the ultraviolet ray absorption layer carrier 1828, has the low stretching direction at the time of biaxial stretching, that is, the direction in which the elongation potential is great, matching the large elongation amount direction and has the high stretching direction at the time of biaxial stretching, that is, the direction in which the elongation potential is small, matching the small elongation amount direction. Thus, at the time of biaxial deformation, elongation in the large elongation amount direction is smoothly performed, and elongation in the small elongation amount direction is sufficiently performed. Accordingly, elongation generated by biaxial deformation is unlikely to cause phase modulation in the ½ wavelength retardation plate 30. In addition, biaxial deformation is unlikely to generate creases and the like in the cholesteric liquid crystal layer 1817 that is arranged in the form of being in contact with the plate surface of the ½ wavelength retardation plate 30. Accordingly, since the ½ wavelength retardation plate 30 and the cholesteric liquid crystal layer 1817 can properly exhibit optical performance, display quality related to a projected picture by light to which an optical effect is imparted by the ½ wavelength retardation plate 30 and the cholesteric liquid crystal layer 1817 is unlikely to be degraded.

As described heretofore, according to the present embodiment, the cholesteric liquid crystal layer 1817 has a stack structure of the first cholesteric liquid crystal layer 1817A and the second cholesteric liquid crystal layer 1817B selectively reflecting the same circularly-polarized light as the first cholesteric liquid crystal layer 1817A, and includes the ½ wavelength retardation plate 30 that is arranged in the form of being interposed between the first cholesteric liquid crystal layer 1817A and the second cholesteric liquid crystal layer 1817B and converts any one of left handed circularly-polarized light and right handed circularly-polarized light into another. The ½ wavelength retardation plate 30 is subjected to biaxial stretching or uniaxial stretching in such a manner that one of two intersecting directions along the plate surface thereof is the low stretching direction or the non-stretching direction and that the other is the high stretching direction or the stretching direction, and furthermore, is subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction. Accordingly, since the ½ wavelength retardation plate 30 arranged in the form of being interposed between the first cholesteric liquid crystal layer 1817A and the second cholesteric liquid crystal layer 1817B can convert any one of left handed circularly-polarized light and right handed circularly-polarized light into another circularly-polarized light, the first cholesteric liquid crystal layer 1817A and the second cholesteric liquid crystal layer 1817B that selectively reflect the same circularly-polarized light can efficiently reflect light to be used in projection, and the efficiency of use of light is excellent. In addition, in the case of biaxial deformation of the ½ wavelength retardation plate 30, the large elongation amount direction matches the low stretching direction at the time of biaxial stretching or the non-stretching direction at the time of uniaxial stretching, and the small elongation amount direction matches the high stretching direction at the time of biaxial stretching or the stretching direction at the time of uniaxial stretching. Thus, elongation generated by deformation is unlikely to cause phase modulation. In the case of uniaxial deformation of the ½ wavelength retardation plate 30, the deformation direction matches the low stretching direction at the time of biaxial stretching or the non-stretching direction at the time of uniaxial stretching, and the non-deformation direction matches the high stretching direction at the time of biaxial stretching or the stretching direction at the time of uniaxial stretching. Thus, elongation generated by deformation is unlikely to cause phase modulation. Accordingly, since the ½ wavelength retardation plate 30 can properly exhibit optical performance, display quality related to a projected picture by light to which an optical effect is imparted by the ½ wavelength retardation plate 30 is unlikely to be degraded.

### Embodiment 20

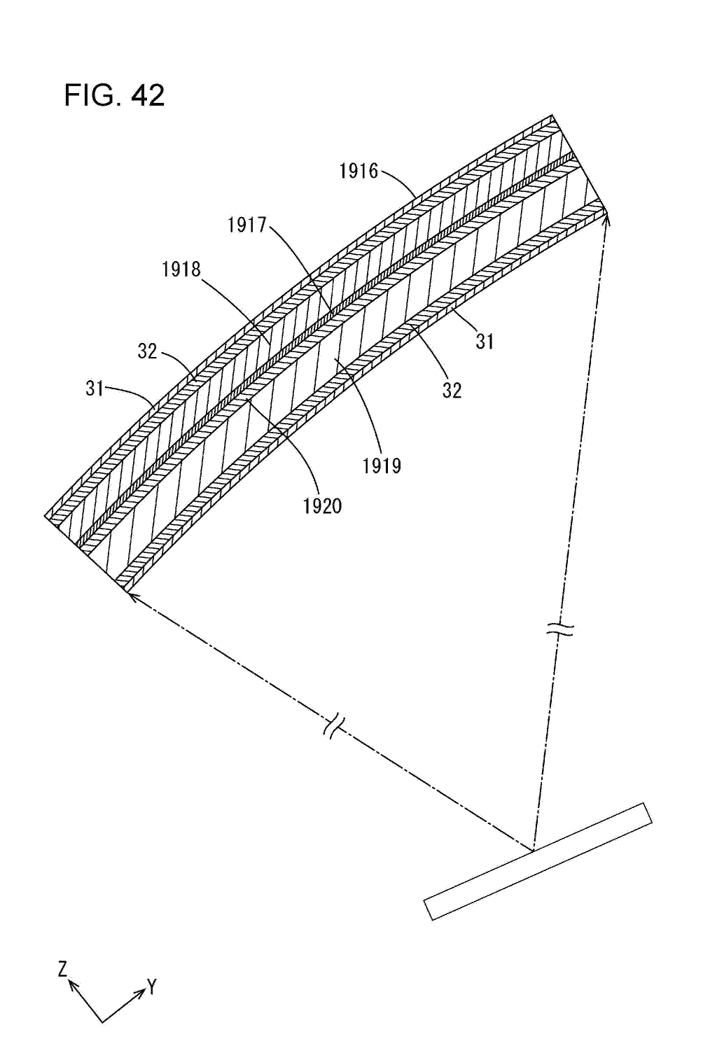

Embodiment 20 of the present invention will be described with FIG. 42. Embodiment 20 illustrates disposing an infrared ray absorption layer 31 from above Embodiment 1. Duplicate descriptions of the same structures and effects as above Embodiment 1 will not be provided.

As illustrated in FIG. 42, a light reflection unit 1916 according to the present embodiment is configured in such a manner that the infrared ray absorption layer (second optical functional layer) 31 that absorbs infrared rays is disposed on both of the outer and inner surfaces of the light reflection unit 1916. One infrared ray absorption layer 31 is arranged in the form of covering almost the entire area of the plate surface of a cholesteric liquid crystal layer carrier 1918 on the opposite side from a cholesteric liquid crystal layer 1917 side. The other infrared ray absorption layer 31 is arranged in the form of covering almost the entire area of the plate surface of a substrate 1919 on the opposite side from a transparent adhesive layer 1920 side. The infrared ray absorption layers 31 are respectively bonded to the plate surfaces of the cholesteric liquid crystal layer carrier 1918 and the substrate 1919 through a transparent adhesive layer 32.

As described heretofore, according to the present embodiment, the second optical functional layer is configured of the infrared ray absorption layer 31 that selectively absorbs infrared rays. Accordingly, the optical performance of the second optical functional layer configured of the infrared ray absorption layer 31 can be favorably secured.

### Embodiment 21

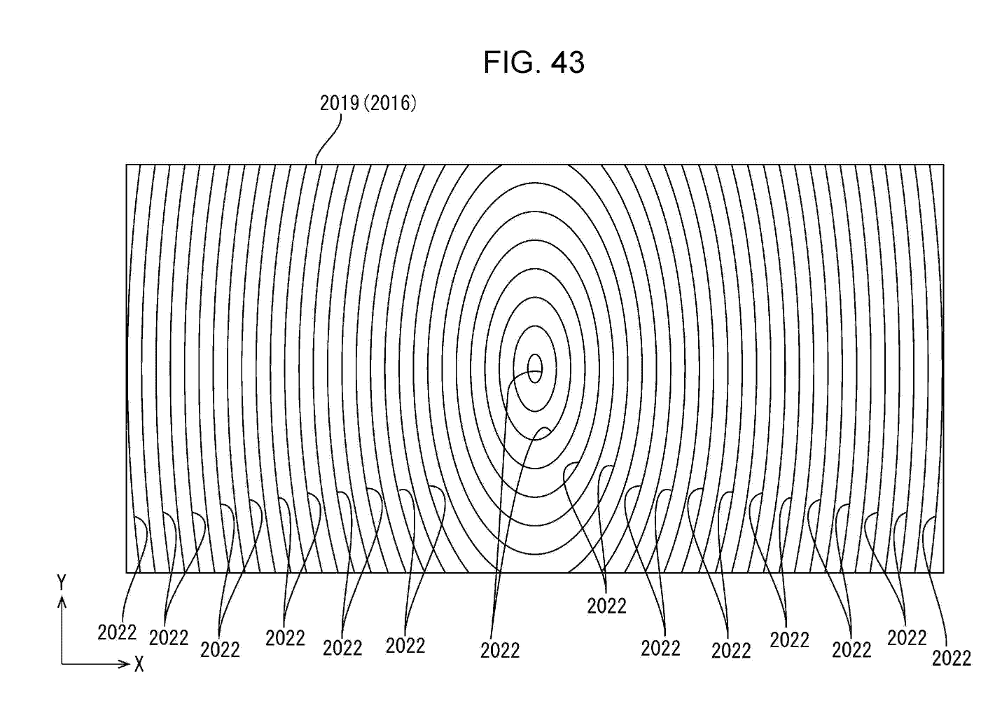

Embodiment 21 of the present invention will be described with FIG. 43 to FIG. 45. Embodiment 21 illustrates changing the three-dimensional shape of a light reflection unit 2016 and the plan view shape of a recess portion 2022 from above Embodiment 2. Duplicate descriptions of the same structures and effects as above Embodiment 2 will not be provided.

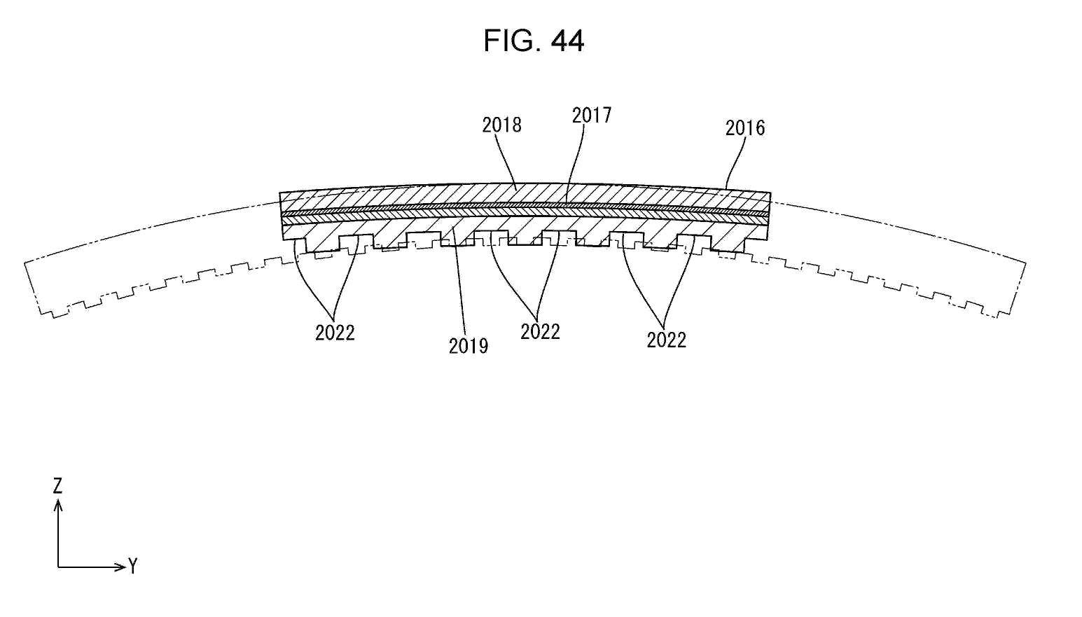

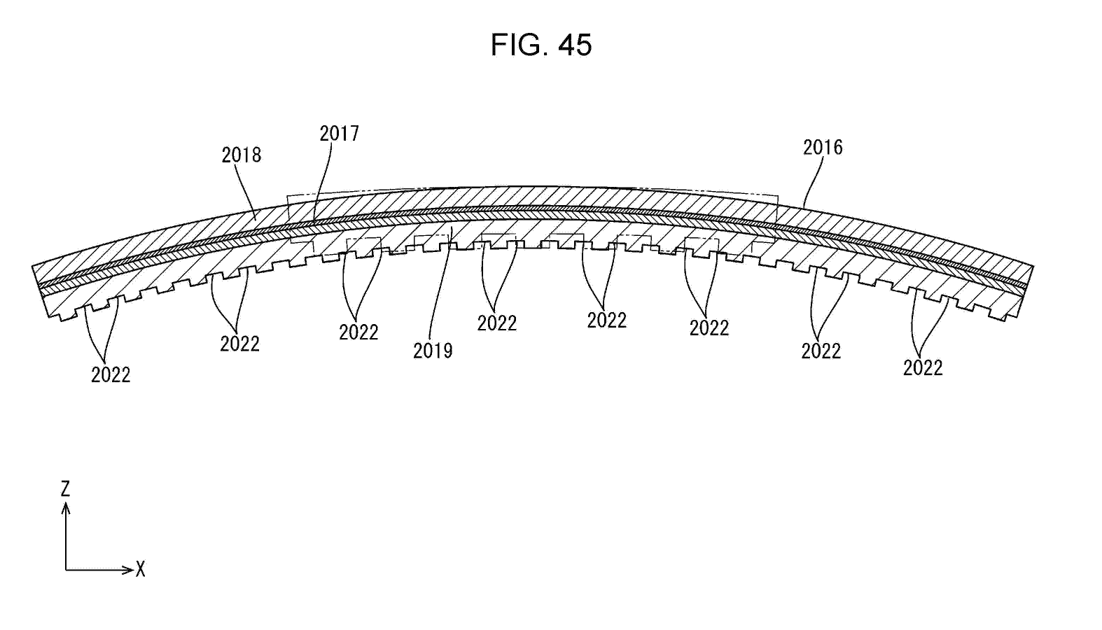

As illustrated in FIG. 43 to FIG. 45, the radius of curvature of the light reflection unit 2016 according to the present embodiment varies in the long edge direction (X axis direction) and in the short edge direction (Y axis direction). Specifically, the light reflection unit 2016 is subjected to biaxial deformation in such a manner that the radius of curvature is relatively large in the short edge direction and that the radius of curvature is relatively small in the long edge direction. Therefore, the light reflection unit 2016 has the short edge direction matching a large curvature radius direction in which the radius of curvature is relatively large, and has the long edge direction matching a small curvature radius direction in which the radius of curvature is relatively small. That is, a cholesteric liquid crystal layer carrier 2018 constituting the light reflection unit 2016 is said to be subjected to biaxial deformation in such a manner that the large elongation amount direction in which the amount of elongation by deformation is relatively large matches the long edge direction, that is, the low stretching direction at the time of biaxial stretching, and that the small elongation amount direction in which the amount of elongation by deformation is relatively small matches the short edge direction, that is, the high stretching direction at the time of biaxial stretching. The exterior shape of the light reflection unit 2016 in the long edge direction and the exterior shape of the light reflection unit 2016 in the short edge direction are respectively illustrated in FIG. 44 and FIG. 45 by double-dot chain lines.

As illustrated in FIG. 43, the plan view shape of the recess portion 2022 disposed in the substrate 2019 constituting the light reflection unit 2016 is a circularly annular shape that is heightwise long and flat, that is, an elliptically annular shape. The recess portion 2022 has a long axis direction matching the Y axis direction, that is, the small elongation amount direction and the high stretching direction of the cholesteric liquid crystal layer carrier 2018, and has a short axis direction matching the X axis direction, that is, the large elongation amount direction and the low stretching direction of the cholesteric liquid crystal layer carrier 2018. The width dimension of the recess portion 2022 successively changes in the circumferential direction. For example, the width dimension in the short axis direction is approximately half of the width dimension in the long axis direction. Biaxial deformation is likely to be generated in the substrate 2019 along the above plan view shape of the recess portion 2022, and the substrate 2019 has anisotropic deformability by the recess portion 2022. The reason of employing such a configuration is that the radius of curvature in the short edge direction is different from the radius of curvature in the long edge direction in the light reflection unit 2016 subjected to biaxial deformation. The recess portion 2022 is arranged to have the center thereof matching the center (a position where two diagonals intersect with each other) of the plate surface of the substrate 2019, that is, concentrically arranged, and is arranged in plural numbers intermittently linearly in the diameter direction. The arrangement interval of the plurality of recess portions 2022 is relatively large in the long axis direction and is relatively small in the short axis direction. The plan view shape of the recess portion 2022, of the plurality of recess portions 2022, that is arranged at the center of the plate surface of the substrate 2019 is a heightwise long elliptic shape.

A method for manufacturing the light reflection unit 2016 of such a configuration includes the recess portion forming step in the same manner as the manufacturing method disclosed in above Embodiment 2. In the deforming step, the light reflection unit 2016 is sandwiched between one pair of press molds (not illustrated) and subjected to thermal pressing. At this point, since the recess portion 2022 of which the plan view shape is a heightwise long elliptically annular shape is formed in the plate surface of the substrate 2019, biaxial deformation of the substrate 2019 is facilitated, and generation of stress is reduced. Specifically, while the substrate 2019 is subjected to biaxial deformation in such a manner that the surface thereof where the recess portion 2022 is formed has a concave shape, the recess portion formation portion has a smaller thickness than the recess portion non-formation portion in the substrate 2019. Thus, biaxial deformation is easily performed along the plan view shape of the recess portion 2022. At this point, since the long axis direction of the recess portion 2022 (a small width direction in which the width dimension is relatively small; a small arrangement interval direction in which the arrangement interval is relatively small) matches the small curvature radius direction in which the radius of curvature of the substrate 2019 is relatively small, relatively large deformation is easily generated in the substrate 2019 as illustrated in FIG. 45. Meanwhile, since the short axis direction of the recess portion 2022 (a large width direction in which the width dimension is relatively large; a large arrangement interval direction in which the arrangement interval is relatively large) matches the large curvature radius direction in which the radius of curvature of the substrate 2019 is relatively large, relatively small deformation is easily generated in the substrate 2019 as illustrated in FIG. 44. Accordingly, since biaxial deformation is unlikely to generate stress on the substrate 2019, stress on the substrate 2019 is unlikely to cause small deformation such as creases in the cholesteric liquid crystal layer 2017.

### Embodiment 22

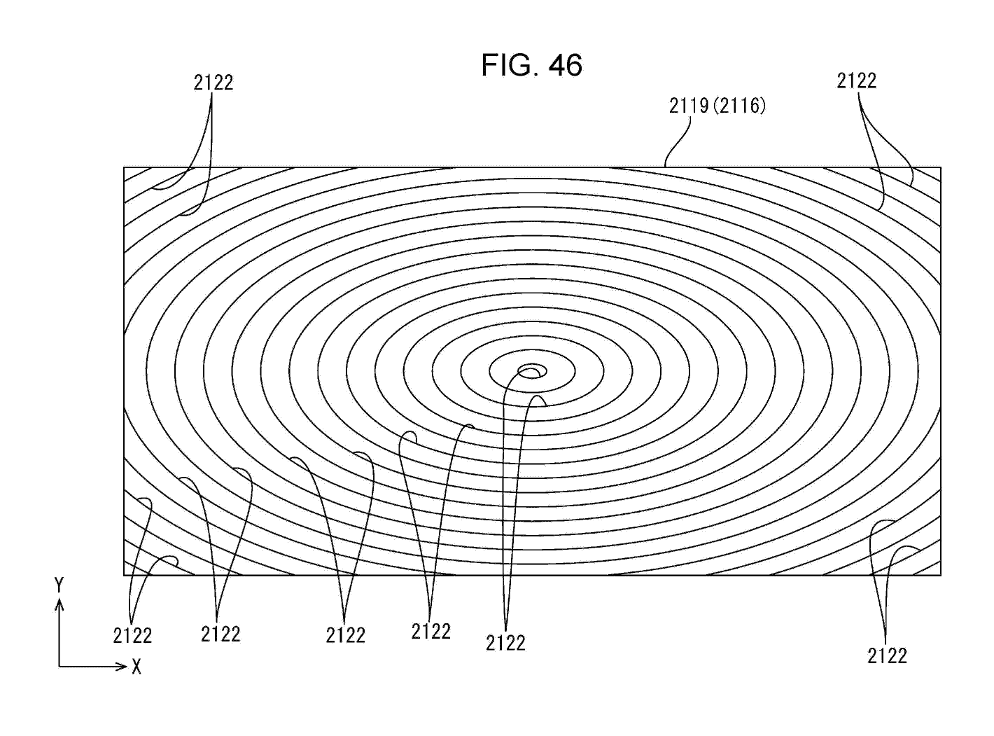

Embodiment 22 of the present invention will be described with FIG. 46 to FIG. 48. Embodiment 22 illustrates changing the three-dimensional shape of a light reflection unit 2116 and the plan view shape of a recess portion 2122 from above Embodiment 21. Duplicate descriptions of the same structures and effects as above Embodiment 21 will not be provided.

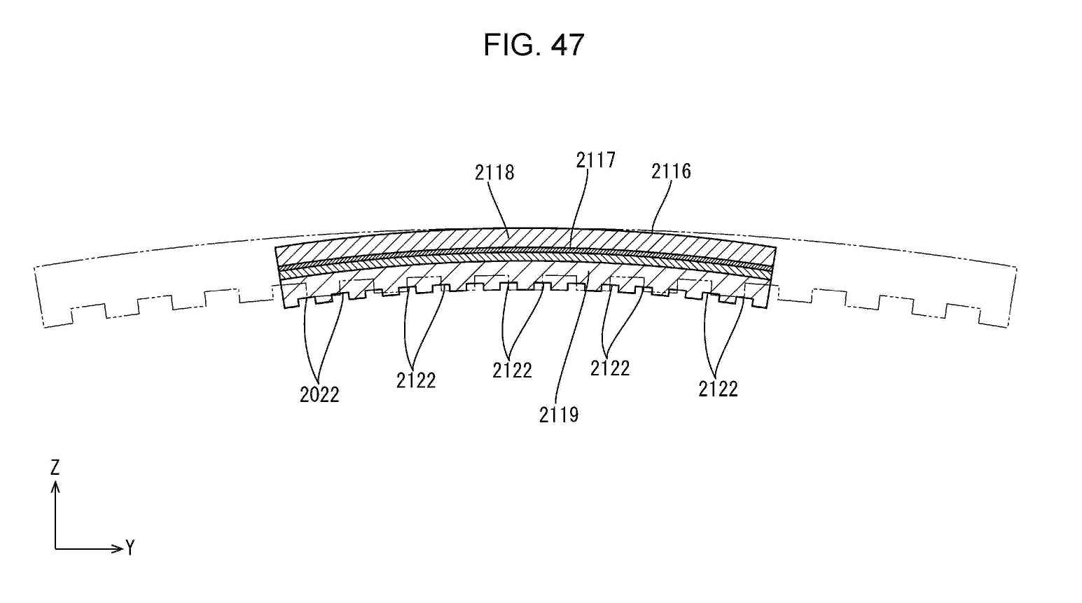

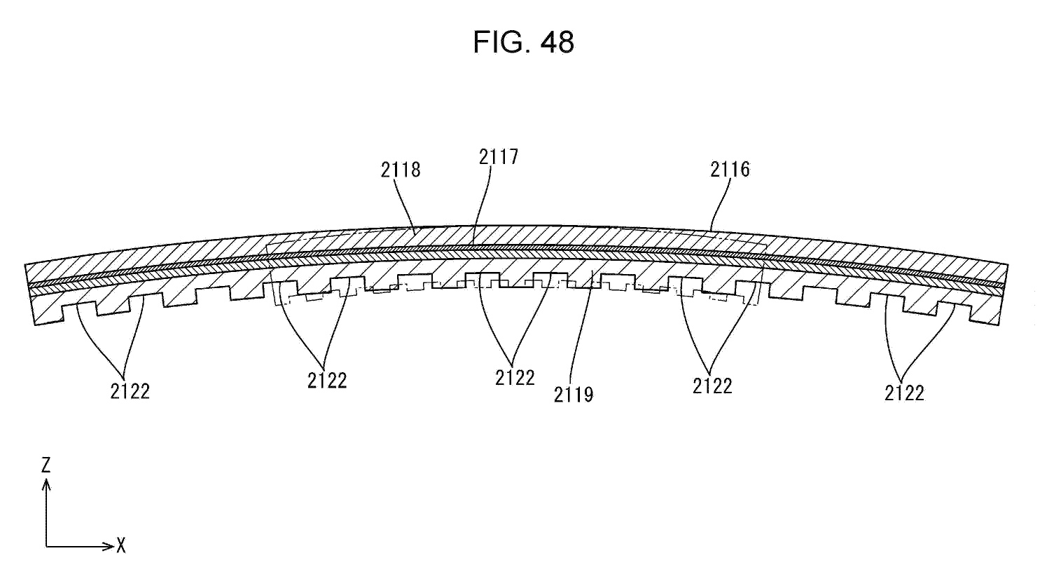

As illustrated in FIG. 46 to FIG. 48, the light reflection unit 2116 according to the present embodiment is subjected to biaxial deformation in such a manner that the radius of curvature thereof is relatively small in the short edge direction and that the radius of curvature thereof is relatively large in the long edge direction. Therefore, the light reflection unit 2116 has the short edge direction matching the small curvature radius direction in which the radius of curvature is relatively small, and has the long edge direction matching the large curvature radius direction in which the radius of curvature is relatively large. The light reflection unit 2116 does not have a large difference between the radii of curvature in the short edge direction and in the long edge direction. Accordingly, a cholesteric liquid crystal layer carrier 2118 constituting the light reflection unit 2116 is subjected to biaxial deformation in such a manner that the large elongation amount direction in which the amount of elongation by deformation is relatively large matches the long edge direction, that is, the low stretching direction at the time of biaxial stretching, and that the small elongation amount direction in which the amount of elongation by deformation is relatively small matches the short edge direction, that is, the high stretching direction at the time of biaxial stretching. The exterior shape of the light reflection unit 2116 in the long edge direction and the exterior shape of the light reflection unit 2116 in the short edge direction are respectively illustrated in FIG. 47 and FIG. 48 by double-dot chain lines.

As illustrated in FIG. 46, the plan view shape of the recess portion 2122 disposed in a substrate 2119 constituting the light reflection unit 2116 is a circularly annular shape that is widthwise long and flat, that is, an elliptically annular shape. The recess portion 2122 has a long axis direction matching the X axis direction, that is, the large elongation amount direction and the low stretching direction of the cholesteric liquid crystal layer carrier 2118, and has a short axis direction matching the Y axis direction, that is, the small elongation amount direction and the high stretching direction of the cholesteric liquid crystal layer carrier 2118. The width dimension of the recess portion 2122 successively changes in the circumferential direction. For example, the width dimension in the long axis direction is approximately half of the width dimension in the short axis direction. The arrangement interval of a plurality of the recess portions 2122 is relatively small in the long axis direction and is relatively large in the short axis direction. The plan view shape of the recess portion 2122, of the plurality of recess portions 2122, that is arranged at the center of the plate surface of the substrate 2119 is a widthwise long elliptic shape.

A method for manufacturing the light reflection unit 2116 of such a configuration includes the recess portion forming step in the same manner as the manufacturing method disclosed in above Embodiments 2 and 22. In the deforming step, the light reflection unit 2116 is sandwiched between one pair of press molds (not illustrated) and subjected to thermal pressing. At this point, since the recess portion 2122 of which the plan view shape is a widthwise long elliptically annular shape is formed in the plate surface of the substrate 2119, biaxial deformation of the substrate 2119 is facilitated, and generation of stress is reduced. Specifically, while the substrate 2119 is subjected to biaxial deformation in such a manner that the surface thereof where the recess portion 2122 is formed has a concave shape, the recess portion formation portion has a smaller thickness than the recess portion non-formation portion in the substrate 2119. Thus, biaxial deformation is easily performed along the plan view shape of the recess portion 2122. At this point, since the short axis direction of the recess portion 2122 (the small width direction in which the width dimension is relatively small; the small arrangement interval direction in which the arrangement interval is relatively small) matches the small curvature radius direction in which the radius of curvature of the substrate 2119 is relatively small, relatively large deformation is easily generated in the substrate 2119 as illustrated in FIG. 47. Meanwhile, since the long axis direction of the recess portion 2122 (the large width direction in which the width dimension is relatively large; the large arrangement interval direction in which the arrangement interval is relatively large) matches the large curvature radius direction in which the radius of curvature of the substrate 2119 is relatively large, relatively small deformation is easily generated in the substrate 2119 as illustrated in FIG. 48. Accordingly, since biaxial deformation is unlikely to generate stress on the substrate 2119, stress on the substrate 2119 is unlikely to cause small deformation such as creases in a cholesteric liquid crystal layer 2117.

### Embodiment 23

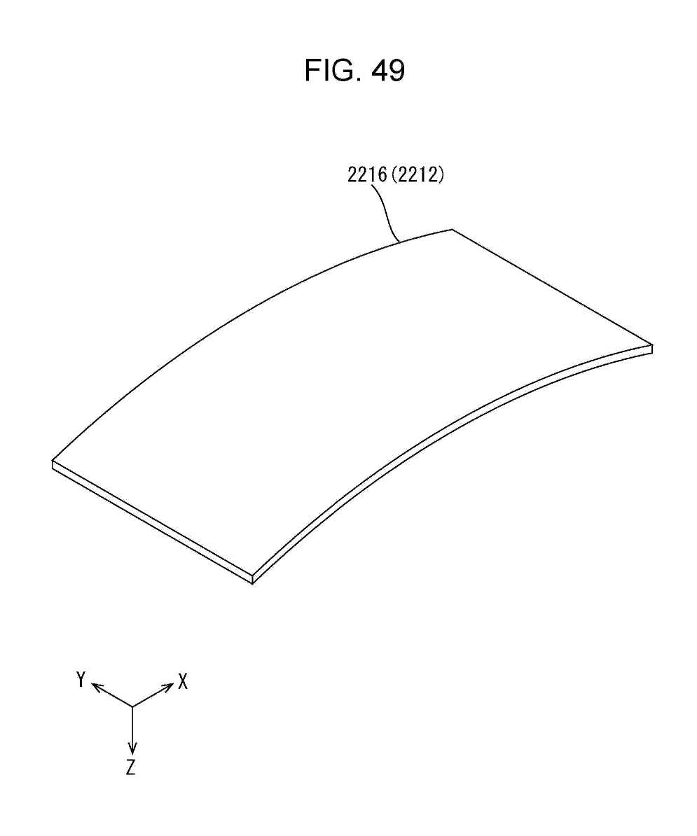

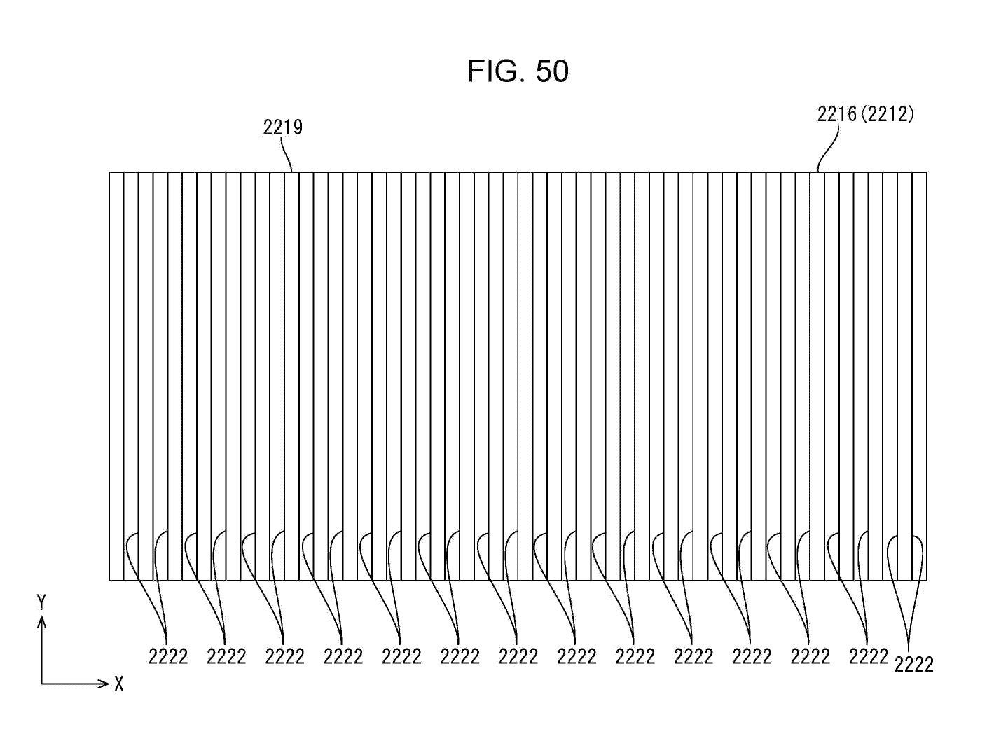

Embodiment 23 of the present invention will be described with FIG. 49 or FIG. 50. Embodiment 23 illustrates changing the three-dimensional shape of a light reflection unit 2216 and the plan view shape of a recess portion 2222 from above Embodiment 2. Duplicate descriptions of the same structures and effects as above Embodiment 2 will not be provided.

As illustrated in FIG. 49, the light reflection unit 2216 according to the present embodiment is subjected to uniaxial deformation in which the light reflection unit 2216 is not deformed in the short edge direction (Y axis direction) and is selectively deformed in only the long edge direction (X axis direction). That is, the long edge direction of the light reflection unit 2216 is the deformation direction in which deformation is generated at the time of uniaxial deformation, and the short edge direction thereof is the non-deformation direction in which deformation is not generated at the time of uniaxial deformation. Meanwhile, in the same manner as above Embodiments 1 and 2, a cholesteric liquid crystal layer carrier (not illustrated) constituting the light reflection unit 2216 has the long edge direction matching the low stretching direction at the time of biaxial stretching and has the short edge direction matching the high stretching direction at the time of biaxial stretching (refer to FIG. 9). Therefore, the cholesteric liquid crystal layer carrier is subjected to uniaxial deformation in such a manner that the deformation direction in which deformation is generated matches the long edge direction, that is, the low stretching direction at the time of biaxial stretching, and that the non-deformation direction in which deformation is not generated matches the short edge direction, that is, the high stretching direction at the time of biaxial stretching. The plate surface of the light reflection unit 2216 subjected to uniaxial deformation has an arc shape that has a curvature in only the long edge direction.

As illustrated in FIG. 50, the recess portion 2222 disposed in a substrate 2219 constituting the light reflection unit 2216 extends in the short edge direction of the substrate 2219 and has a straight linear shape of a constant width (a band shape; a stripe shape). The recess portion 2222 has an extending direction matching the Y axis direction, that is, the non-deformation direction of the substrate 2219 and the high stretching direction of the cholesteric liquid crystal layer carrier and has a width direction matching the X axis direction, that is, the deformation direction of the substrate 2219 and the low stretching direction of the cholesteric liquid crystal layer carrier. The recess portion 2222 is arranged in plural numbers intermittently linearly in the width direction at almost constant arrangement intervals. That is, the direction in which the recess portions 2222 are lined up matches the X axis direction.

A method for manufacturing the light reflection unit 2216 of such a configuration includes the recess portion forming step in the same manner as the manufacturing method disclosed in above Embodiment 2. In the deforming step, the light reflection unit 2216 is sandwiched between one pair of press molds (not illustrated) and subjected to thermal pressing. Specifically, when thermal pressing is performed, the light reflection unit 2216 with the plate surface thereof in a flat state is sandwiched in the plate thickness direction between one pair of press molds (not illustrated) having a plate surface of an arc shape that has a curvature in only the long edge direction, and is pressed with a predetermined pressure. When the light reflection unit 2216 is subjected to uniaxial deformation, the cholesteric liquid crystal layer carrier is elongated in the long edge direction (X axis direction), which is the deformation direction, and is almost not elongated in the short edge direction (Y axis direction) which is the non-deformation direction. The cholesteric liquid crystal layer carrier has the low stretching direction at the time of biaxial stretching, that is, the direction in which the elongation potential is great, matching the deformation direction and has the high stretching direction at the time of biaxial stretching, that is, the direction in which the elongation potential is small, matching the non-deformation direction. Thus, elongation in the deformation direction is smoothly performed. Accordingly, uniaxial deformation is unlikely to generate creases and the like in a cholesteric liquid crystal layer that is disposed on the plate surface of the cholesteric liquid crystal layer carrier. Small deformation such as creases being unlikely to be generated in the cholesteric liquid crystal layer makes distortion unlikely to be generated in the traveling direction of reflective light from the cholesteric liquid crystal layer. Thus, display quality related to a picture projected by a combiner 2212 is unlikely to be degraded.

In the deforming step, since the recess portion 2222 that has a straight linear shape extending in the short edge direction is formed in the plate surface of the substrate 2219, uniaxial deformation is facilitated, and generation of stress is reduced. Specifically, while the substrate 2219 is subjected to uniaxial deformation in such a manner that the surface thereof where the recess portion 2222 is formed has a concave shape, the recess portion formation portion has a smaller thickness than the recess portion non-formation portion in the substrate 2219. Thus, uniaxial deformation is easily performed along the plan view shape of the recess portion 2222. At this point, as illustrated in FIG. 50, since the extending direction of the recess portion 2222 matches the non-deformation direction of the substrate 2219 and the width direction of the recess portion 2222 (the direction in which the recess portions 2222 are lined up) matches the deformation direction of the substrate 2219, deformation is easily generated in the long edge direction in the substrate 2219 as illustrated in FIG. 49. Accordingly, since uniaxial deformation is unlikely to generate stress on the substrate 2219, stress on the substrate 2219 is unlikely to cause small deformation such as creases in the cholesteric liquid crystal layer.

### Embodiment 24

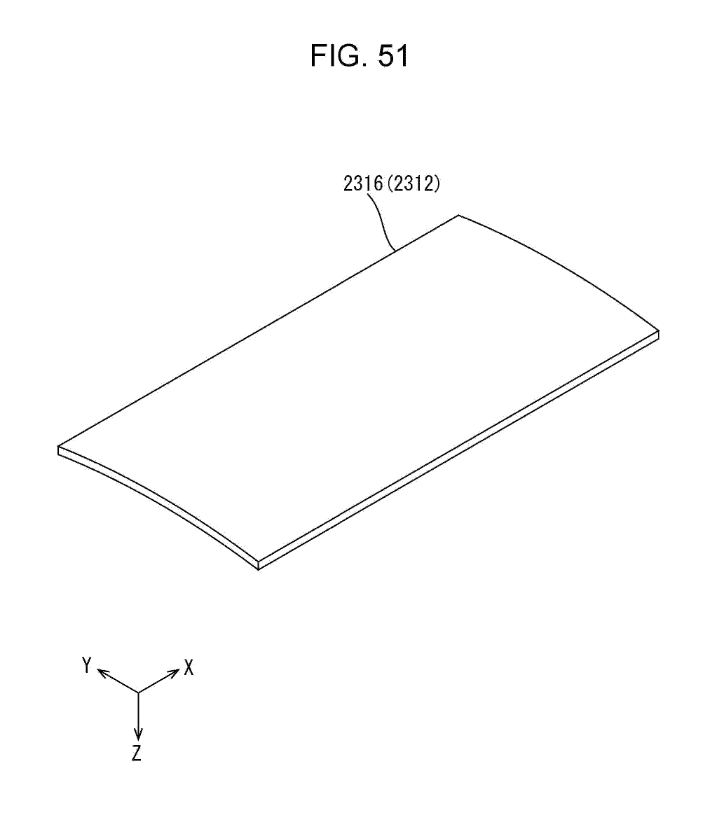

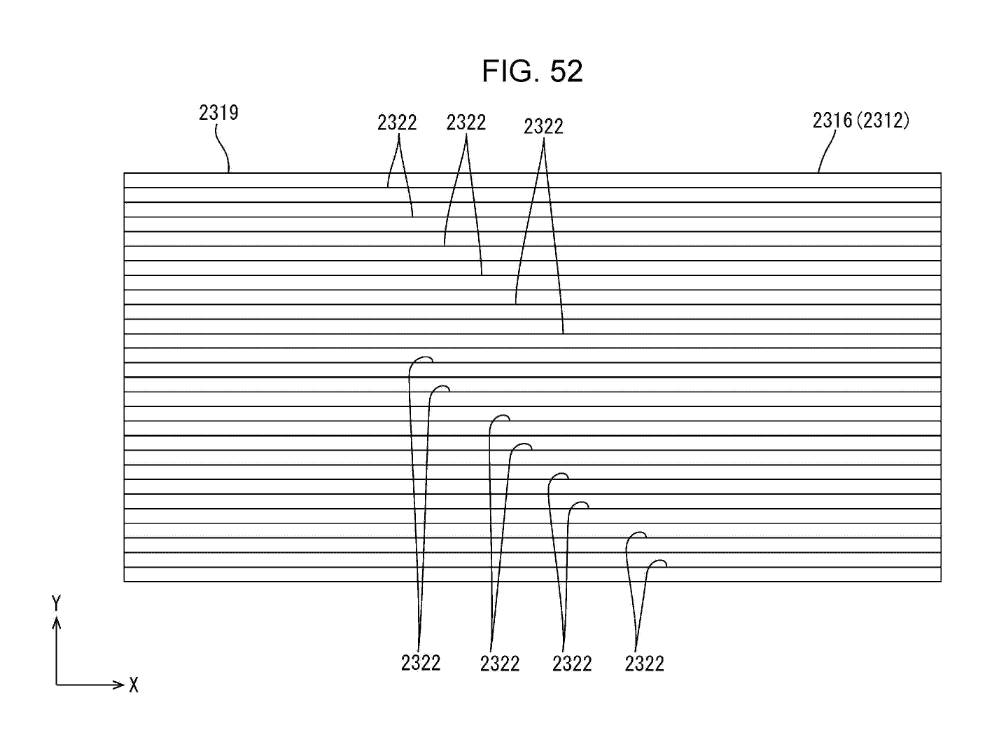

Embodiment 24 of the present invention will be described with FIG. 51 or FIG. 52. Embodiment 24 illustrates changing the three-dimensional shape of a light reflection unit 2316 and the plan view shape of a recess portion 2322 from above Embodiment 23. Duplicate descriptions of the same structures and effects as above Embodiment 23 will not be provided.

As illustrated in FIG. 51, the light reflection unit 2316 according to the present embodiment is subjected to uniaxial deformation in which the light reflection unit 2316 is not deformed in the long edge direction (X axis direction) and is selectively deformed in only the short edge direction (Y axis direction). That is, the short edge direction of the light reflection unit 2316 is the deformation direction in which deformation is generated at the time of uniaxial deformation, and the long edge direction thereof is the non-deformation direction in which deformation is not generated at the time of uniaxial deformation. Meanwhile, in the opposite manner to above Embodiments 1 and 2, a cholesteric liquid crystal layer carrier (not illustrated) constituting the light reflection unit 2316 has the low stretching direction at the time of biaxial stretching matching the short edge direction and has the high stretching direction at the time of biaxial stretching matching the long edge direction. Therefore, the cholesteric liquid crystal layer carrier is subjected to uniaxial deformation in such a manner that the deformation direction in which deformation is generated matches the short edge direction, that is, the low stretching direction at the time of biaxial stretching, and that the non-deformation direction in which deformation is not generated matches the long edge direction, that is, the high stretching direction at the time of biaxial stretching. The plate surface of the light reflection unit 2316 subjected to uniaxial deformation has an arc shape that has a curvature in only the short edge direction.

As illustrated in FIG. 52, the recess portion 2322 disposed in a substrate 2319 constituting the light reflection unit 2316 extends in the long edge direction of the substrate 2319 and has a straight linear shape of a constant width (a band shape; a stripe shape). The recess portion 2322 has an extending direction matching the X axis direction, that is, the non-deformation direction of the substrate 2319 and the high stretching direction of the cholesteric liquid crystal layer carrier and has a width direction matching the Y axis direction, that is, the deformation direction of the substrate 2319 and the low stretching direction of the cholesteric liquid crystal layer carrier. The recess portion 2322 is arranged in plural numbers intermittently linearly in the width direction at almost constant arrangement intervals. That is, the direction in which the recess portions 2322 are lined up matches the Y axis direction.

A method for manufacturing the light reflection unit 2316 of such a configuration includes the recess portion forming step in the same manner as the manufacturing method disclosed in above Embodiment 2. In the deforming step, the light reflection unit 2316 is sandwiched between one pair of press molds (not illustrated) and subjected to thermal pressing. Specifically, when thermal pressing is performed, the light reflection unit 2316 with the plate surface thereof in a flat state is sandwiched in the plate thickness direction between one pair of press molds (not illustrated) having a plate surface of an arc shape that has a curvature in only the short edge direction, and is pressed with a predetermined pressure. When the light reflection unit 2316 is subjected to uniaxial deformation, the cholesteric liquid crystal layer carrier is elongated in the short edge direction (Y axis direction), which is the deformation direction, and is almost not elongated in the long edge direction (X axis direction) which is the non-deformation direction. The cholesteric liquid crystal layer carrier has the low stretching direction at the time of biaxial stretching, that is, the direction in which the elongation potential is great, matching the deformation direction and has the high stretching direction at the time of biaxial stretching, that is, the direction in which the elongation potential is small, matching the non-deformation direction. Thus, elongation in the deformation direction is smoothly performed. Accordingly, uniaxial deformation is unlikely to generate creases and the like in a cholesteric liquid crystal layer that is disposed on the plate surface of the cholesteric liquid crystal layer carrier. Small deformation such as creases being unlikely to be generated in the cholesteric liquid crystal layer makes distortion unlikely to be generated in the traveling direction of reflective light from the cholesteric liquid crystal layer. Thus, display quality related to a picture projected by a combiner 2312 is unlikely to be degraded.

In the deforming step, since the recess portion 2322 that has a straight linear shape extending in the long edge direction is formed in the plate surface of the substrate 2319, uniaxial deformation is facilitated, and generation of stress is reduced. Specifically, while the substrate 2319 is subjected to uniaxial deformation in such a manner that the surface thereof where the recess portion 2322 is formed has a concave shape, the recess portion formation portion has a smaller thickness than the recess portion non-formation portion in the substrate 2319. Thus, uniaxial deformation is easily performed along the plan view shape of the recess portion 2322. At this point, as illustrated in FIG. 52, since the extending direction of the recess portion 2322 matches the non-deformation direction of the substrate 2319 and the width direction of the recess portion 2322 (the direction in which the recess portions 2322 are lined up) matches the deformation direction of the substrate 2319, deformation is easily generated in the short edge direction in the substrate 2319 as illustrated in FIG. 51. Accordingly, since uniaxial deformation is unlikely to generate stress on the substrate 2319, stress on the substrate 2319 is unlikely to cause small deformation such as creases in the cholesteric liquid crystal layer.

### Embodiment 25

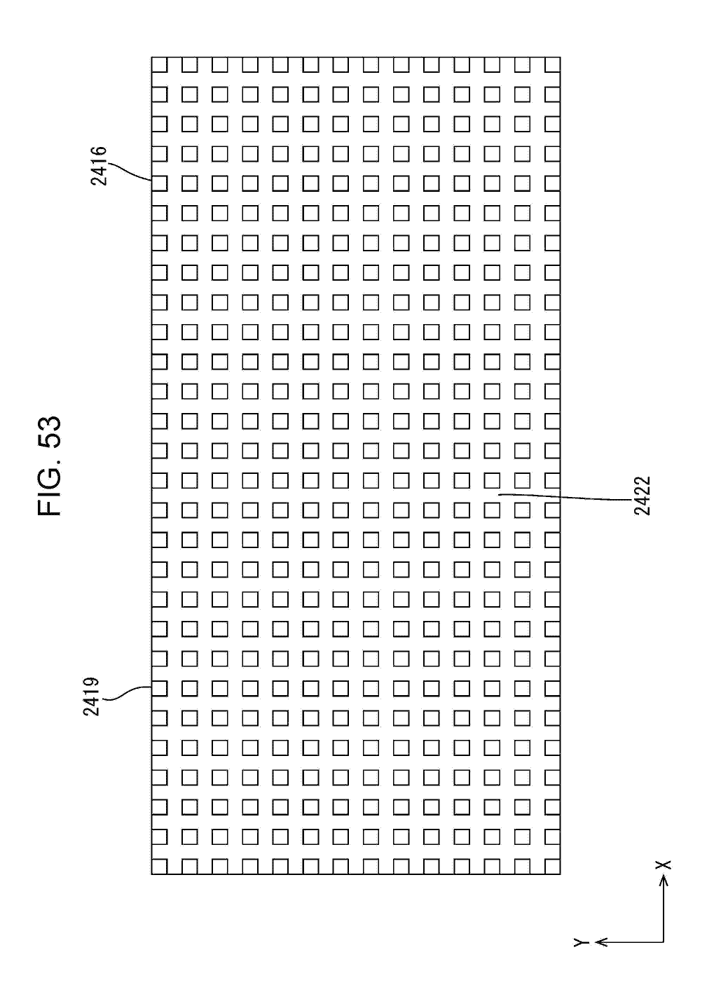

Embodiment 25 of the present invention will be described with FIG. 53. Embodiment 25 illustrates changing the plan view shape of a recess portion 2422 from above Embodiment 2. Duplicate descriptions of the same structures and effects as above Embodiment 2 will not be provided.

The plan view shape of the recess portion 2422 that is disposed in a substrate 2419 constituting a light reflection unit 2416 according to the present embodiment is a grid shape as illustrated in FIG. 53. Specifically, the plan view shape of the recess portion 2422 is a grid shape in which intersecting parts of a part extending in the long edge direction (X axis direction) of the substrate 2419 and a part extending in the short edge direction (Y axis direction) of the substrate 2419 are connected to each other. With such a configuration, deformation of the substrate 2419 is facilitated in any of a light reflection unit that is subjected to biaxial deformation in the form of having the same radius of curvature in the long edge direction and in the short edge direction as in above Embodiment 2, a light reflection unit that is subjected to biaxial deformation in the form of having a radius of curvature varying in the long edge direction and in the short edge direction as in above Embodiments 21 and 22, and a light reflection unit that is subjected to uniaxial deformation in only one of the long edge direction and the short edge direction as in above Embodiments 23 and 24. That is, in the case of manufacturing multiple types of light reflection units having various three-dimensional shapes, this case can be dealt with if one type of substrate 2419 including the recess portion 2422 is prepared, and manufacturing cost related to the substrate 2419 and the light reflection unit 2416 can be reduced.

### OTHER EMBODIMENTS

The present invention is not limited to the above embodiments described with the drawings. The following embodiments, for example, are also included in the technical scope of the present invention.

(1) While above each embodiment illustrates the case of manufacturing the cholesteric liquid crystal layer carrier by biaxial stretching, the present invention can be applied to manufacturing of the cholesteric liquid crystal layer carrier by uniaxial stretching. In this case, the cholesteric liquid crystal layer carrier is subjected to uniaxial stretching in the form of having the stretching direction in which stretching is performed and the non-stretching direction in which stretching is not performed. In the case of biaxial deformation of the light reflection unit, it is preferable to perform biaxial deformation of the cholesteric liquid crystal layer carrier in the form of a large elongation direction and a small elongation direction respectively matching the non-stretching direction and the stretching direction. Meanwhile, in the case of uniaxial deformation of the light reflection unit, it is preferable to perform uniaxial deformation of the cholesteric liquid crystal layer carrier in the form of the deformation direction and the non-deformation direction respectively matching the non-stretching direction and the stretching direction.

(2) In addition to above each embodiment, specific numerical values such as each dimension of the combiner (light reflection unit), each radius of curvature of the combiner (light reflection unit), each percentage of elongation required at the time of biaxial deformation of the cholesteric liquid crystal layer carrier, each glass transition temperature of the substrate and the cholesteric liquid crystal layer carrier, the heat setting temperature of the cholesteric liquid crystal layer carrier, and each stretch ratio at the time of biaxial stretching of the cholesteric liquid crystal layer carrier can be appropriately changed.

(3) In addition to above Embodiments 2 to 7, 10 to 12, and 21 to 25, the plan view shape of the recess portion, the arrangement interval of the recess portion, the width dimension of the recess portion, the rate of change of the width dimension of the recess portion in the depth direction, and the like can be appropriately changed according to the three-dimensional shape of the light reflection unit subjected to biaxial deformation or uniaxial deformation.

(4) While above Embodiments 2 to 7, 10 to 12, and 21 to 25 illustrate the case of performing the recess portion forming step of forming the recess portion in the substrate by cutting after the substrate is manufactured, for example, the substrate may be manufactured by injection molding, and the recess portion may be formed at the time of injection molding. That is, the recess portion forming step can be merged into manufacturing steps of the substrate. Specifically, the recess portion may be formed along with manufacturing of the substrate by forming a recess portion formation pattern on a molding surface of an injection mold for injection molding of the substrate and by transferring the recess portion formation pattern to the plate surface of the substrate at the time of injection molding.

(5) While above Embodiments 8 to 11 illustrate the case of performing the recess portion forming step of forming the recess portion in the cholesteric liquid crystal layer carrier by cutting after the cholesteric liquid crystal layer carrier is manufactured, for example, the cholesteric liquid crystal layer carrier may be manufactured by injection molding, and the recess portion may be formed at the time of injection molding. That is, the recess portion forming step can be merged into manufacturing steps of the cholesteric liquid crystal layer carrier. Specifically, the recess portion may be formed along with manufacturing of the cholesteric liquid crystal layer carrier by forming the recess portion formation pattern on the molding surface of the injection mold for injection molding of the cholesteric liquid crystal layer carrier and by transferring the recess portion formation pattern to the plate surface of the cholesteric liquid crystal layer carrier at the time of injection molding.

(6) It is obviously possible to employ a configuration of filling the recess portion formed in the substrate disclosed in Embodiments 5 to 7, 10 to 12, and 21 to 25 with the transparent resin material disclosed in above Embodiment 3.

(7) It is obviously possible to employ a configuration of filling the recess portion formed in the cholesteric liquid crystal layer carrier disclosed in Embodiments 8 to 11 with the transparent resin material disclosed in above Embodiment 3.

(8) It is obviously possible to apply the method for manufacturing the light reflection unit including the recess portion removing step disclosed in above Embodiment 4 to Embodiments 5 to 12 and 21 to 25.

(9) Embodiment 14 may be applied to above Embodiments 6 and 7 to cover the cholesteric liquid crystal layer with the cover layer.

(10) While above Embodiment 12 illustrates the case of the inclination angle of the side surface of the recess portion with respect to the depth direction having a value that almost matches θ represented by the equation “L/r(n+1)=θ”, the inclination angle of the side surface of the recess portion with respect to the depth direction can obviously have a value larger than θ.

(11) It is obviously possible to apply the form of the recess portion disposed in the substrate disclosed in above Embodiment 12 to the recess portion formed in the cholesteric liquid crystal layer carrier disclosed in Embodiments 8 to 11. Similarly, it is obviously possible to apply the form of the recess portion disposed in the substrate disclosed in above Embodiment 12 to the recess portion formed in the substrate disclosed Embodiments 3, 5 to 8, 10, 11, and 21 to 25.

(12) While above Embodiment 15 illustrates arranging one pair of antireflection layers, any one antireflection layer may not be provided.

(13) While above Embodiment 16 illustrates the case of arranging the antireflection layer and the antireflection layer carrier in the form of being bonded to the substrate, the antireflection layer and the antireflection layer carrier can be arranged in the form of being bonded to the cholesteric liquid crystal layer. In addition, one pair of antireflection layers and one pair of antireflection layer carriers can be arranged in the same manner as above Embodiment 15.

(14) While above Embodiment 17 illustrates the case of performing the carrier detaching step of detaching the cholesteric liquid crystal layer carrier and the antireflection layer carrier after the deforming step in the method for manufacturing the light reflection unit that includes the antireflection layer which is an additional optical functional layer, the carrier detaching step of detaching at least the cholesteric liquid crystal layer carrier after the deforming step may be performed in the same manner as Embodiment 17 in the method for manufacturing the light reflection unit that does not include the antireflection layer (the method for manufacturing the light reflection unit that includes the ultraviolet ray absorption layer or the infrared ray absorption layer as another additional optical functional layer, or the method for manufacturing the light reflection unit that includes an additional optical functional layer). In this case, if the antireflection layer carrier exists, the antireflection layer carrier may be detached along with the cholesteric liquid crystal layer carrier in the carrier detaching step.

(15) While above Embodiments 18 and 19 illustrate arranging one pair of ultraviolet ray absorption layers and one pair of ultraviolet ray absorption layer carriers, any one ultraviolet ray absorption layer and one ultraviolet ray absorption layer carrier may not be provided.

(16) While above Embodiment 19 illustrates the configuration of the cholesteric liquid crystal layer having a double layer structure with the ½ wavelength retardation plate interposed between the layers in the light reflection unit that includes the ultraviolet ray absorption layer which is an additional optical functional layer, it is possible to employ, in the light reflection unit that does not include the ultraviolet ray absorption layer (the light reflection unit that includes the antireflection layer or the infrared ray absorption layer as another additional optical functional layer, or the light reflection unit that includes an additional optical functional layer), the configuration of the cholesteric liquid crystal layer having a double layer structure with the ½ wavelength retardation plate interposed between the layers as in Embodiment 19.

(17) While above Embodiments 15 to 18 illustrate the case of disposing the antireflection layer, the ultraviolet ray absorption layer, and the infrared ray absorption layer in the light reflection unit, another additional optical functional layer such as an anti-glare (AG) layer may be disposed in the light reflection unit.

(18) It is obviously possible to apply the form of the recess portion disposed in the substrate disclosed in above Embodiments 21 to 25 to the recess portion formed in the cholesteric liquid crystal layer carrier disclosed in Embodiments 8 to 11. Similarly, it is obviously possible to apply the form of the recess portion disposed in the substrate disclosed in above Embodiments 21 to 25 to the recess portion formed in the substrate disclosed Embodiments 3, 5 to 8, 10, and 11.

(19) While above each embodiment illustrates the manufacturing method in which the light reflection unit constituting the combiner is individually subjected to biaxial deformation or uniaxial deformation, it is possible to employ a manufacturing method in which the light reflection unit constituting the combiner is stacked and subjected to biaxial deformation or uniaxial deformation in a batched manner in the stacked state.

(20) While above each embodiment illustrates the case of orthogonal stretching axes in the cholesteric liquid crystal layer carrier subjected to biaxial stretching, the stretching axes in the cholesteric liquid crystal layer carrier subjected to biaxial stretching may intersect with each other at an angle other than 90 degrees.

(21) While above each embodiment illustrates the case of orthogonal deformation axes in the light reflection unit subjected to biaxial deformation, the deformation axes in the light reflection unit subjected to biaxial deformation may intersect with each other at an angle other than 90 degrees.

(22) While above each embodiment illustrates the case of the configuration in which the stretching axes in the cholesteric liquid crystal layer carrier subjected to biaxial stretching and the deformation axes in the light reflection unit subjected to biaxial deformation respectively matching the long edge direction and the short edge direction of the light reflection unit (cholesteric liquid crystal layer carrier), it is possible to use a configuration in which at least any one stretching axis in the cholesteric liquid crystal layer carrier subjected to biaxial stretching and one deformation axis in the light reflection unit subjected to biaxial deformation intersect with the long edge direction and the short edge direction of the light reflection unit (cholesteric liquid crystal layer carrier) without matching.

(23) While above each embodiment illustrates the light reflection unit as including the substrate, the substrate may not be provided.

(24) While above each embodiment illustrates the case of using the cholesteric liquid crystal layers that respectively selectively reflect red light, green light, and blue light, it is possible to use a cholesteric liquid crystal layer that selectively reflects light of a color other than the above three colors (for example, gold light).

(25) While above each embodiment illustrates the combiner that includes three light reflection units, the number of light reflection units included in the combiner can be less than or equal to two or larger than or equal to four.

(26) While above each embodiment illustrates the combiner that performs color displaying by including three light reflection units respectively selectively reflecting red light, green light, and blue light, the present invention can be applied to a combiner that performs single color displaying (for example, greyscale displaying) with only one light reflection unit.

(27) While above each embodiment illustrates the case of using, as the light reflection layer, the cholesteric liquid crystal layer which is one type of wavelength-selective light reflection layer, a dielectric multilayer film can be used as another wavelength-selective light reflection layer.

(28) While above each embodiment illustrates the case of using, as the light reflection layer, the cholesteric liquid crystal layer which is one type of wavelength-selective light reflection layer, a half mirror can be used as the combiner by using, as another light reflection layer, a reflection film that does not have wavelength selectivity (non-wavelength-selective light reflection layer).

(29) In above each embodiment, it is possible to employ a configuration in which a field lens is interposed between the screen and the combiner.

(30) In addition to above each embodiment, a liquid crystal display apparatus that is configured of a liquid crystal panel and a backlight device can be used as the projection device.

(31) While above each embodiment illustrates the case of using a laser diode as the illuminant of the projection device, an LED, an organic EL, or the like can also be used.

(32) While above each embodiment illustrates the case of arranging the combiner separately from the windshield by supporting the combiner with a sun visor or the like, the combiner can be arranged to be bonded to the windshield. In addition, for example, in the case of configuring the windshield by stacking two sheets of glass, the combiner can be arranged in the form of being sandwiched between the two sheets of glass constituting the windshield.

(33) While above each embodiment illustrates the configuration in which the projection device is accommodated in the dashboard, the projection device may be supported by a sun visor or the like, or the projection device may be suspended from the ceiling in the automobile.

(34) While above each embodiment illustrates the case of using a MEMS mirror element as the display element of the projection device, a digital micromirror device (DMD) display element or a liquid crystal on silicon (LCOS) can be used.

(35) While above each embodiment illustrates the case of using a cholesteric liquid crystal panel as the combiner, a holographic element or a half mirror can also be used as the combiner.

(36) While above each embodiment illustrates the head-up display mounted in the automobile, the present invention can be applied to a head-up display that is mounted in an aircraft, an automatic bicycle, a boarding amusement apparatus, and the like.

(37) While above each embodiment illustrates the head-up display, the present invention can be applied to a head-mounted display.

(38) While above each embodiment illustrates the case of performing thermal pressing in the deforming step included in the method for manufacturing the combiner, in-mold molding, insert molding, three dimension overlay method (TOM) molding, laminate molding, and the like can be performed in the deforming step instead of thermal pressing. In this case, the substrate bonding step and the deforming step can be performed at the same time. In addition, the transparent adhesive layer that bonds the cholesteric liquid crystal layer carrier (optical functional layer carrier) and the substrate may not be provided. In the case of performing the recess portion forming step of forming the recess portion in the substrate, the recess portion forming step can be performed at the same time as the deforming step.

(39) While above each embodiment illustrates the case of disposing the bonding layer between the plurality of light reflection units of each color, the bonding layer may not be provided. In this case, for example, a plurality of cholesteric liquid crystal layers of each color can be stacked in order on one cholesteric liquid crystal layer carrier.

(40) In addition to above each embodiment, the stacking order of the plurality of light reflection units respectively reflecting light of each color can be appropriately changed.

### REFERENCE SIGNS LIST

12, 112, 1812, 2212, 2312 COMBINER (PROJECTION MEMBER)
17, 117, 317, 417, 517, 617, 717, 817, 917, 1017, 1117, 1217, 1317, 1417, 1617, 1717, 1817, 1917, 2017, 2117 CHOLESTERIC LIQUID CRYSTAL LAYER (OPTICAL FUNCTIONAL LAYER, LIGHT REFLECTION LAYER)
18, 118, 318, 418, 518, 618, 718, 818, 918, 1018, 1218, 1318, 1418, 1518, 1618, 1718, 1818, 1918, 2018, 2118 CHOLESTERIC LIQUID CRYSTAL LAYER CARRIER (OPTICAL FUNCTIONAL LAYER CARRIER)
19, 119, 219, 319, 419, 519, 619, 719, 819, 919, 1019, 1119, 1219, 1419, 1519, 1619, 1719, 1919, 2019, 2119, 2219, 2319, 2419 SUBSTRATE
22, 222, 322, 422, 622, 722, 822, 922, 1022, 1122, 2022, 2122, 2222, 2322, 2422 RECESS PORTION
23 TRANSPARENT RESIN MATERIAL
25, 1525, 1625 ANTIREFLECTION LAYER (SECOND OPTICAL FUNCTIONAL LAYER)
26, 1626 ANTIREFLECTION LAYER CARRIER (SECOND OPTICAL FUNCTIONAL LAYER CARRIER)
27 ULTRAVIOLET RAY ABSORPTION LAYER (SECOND OPTICAL FUNCTIONAL LAYER)
28, 1828 ULTRAVIOLET RAY ABSORPTION LAYER CARRIER (SECOND OPTICAL FUNCTIONAL LAYER CARRIER)
29 ½ WAVELENGTH RETARDATION PLATE INFRARED RAY ABSORPTION LAYER (SECOND OPTICAL FUNCTIONAL LAYER)
1817A FIRST CHOLESTERIC LIQUID CRYSTAL LAYER
1817B SECOND CHOLESTERIC LIQUID CRYSTAL LAYER

1. A projection member comprising:
an optical functional layer that imparts an optical effect to light; and
an optical functional layer carrier of a plate shape that has a plate surface with the optical functional layer disposed thereon, is subjected to biaxial stretching or uniaxial stretching in such a manner that one of two intersecting directions along the plate surface is a low stretching direction in which a stretch ratio is relatively low or a non-stretching direction in which stretching is not performed and that the other is a high stretching direction in which the stretch ratio is relatively high or a stretching direction in which stretching is performed, and is subjected to biaxial deformation or uniaxial deformation to have the plate surface deformed into a curved shape in such a manner that a large elongation amount direction in which the amount of elongation by deformation is relatively large or a deformation direction in which deformation is generated matches the low stretching direction or the non-stretching direction and that a small elongation amount direction in which the amount of elongation by deformation is relatively small or a non-deformation direction in which deformation is not generated matches the high stretching direction or the stretching direction.

2. The projection member according to claim 1,
wherein the optical functional layer is a light reflection layer that reflects light.

3. The projection member according to claim 2,
wherein the light reflection layer is configured of a cholesteric liquid crystal layer that selectively reflects any one of left handed circularly-polarized light and right handed circularly-polarized light in a specific wavelength range.

4. The projection member according to claim 3,
wherein the cholesteric liquid crystal layer
has a stack structure of a first cholesteric liquid crystal layer and a second cholesteric liquid crystal layer selectively reflecting the same circularly-polarized light as the first cholesteric liquid crystal layer, and
includes a ½ wavelength retardation plate that is arranged in a form of being interposed between the first cholesteric liquid crystal layer and the second cholesteric liquid crystal layer and converts any one of left handed circularly-polarized light and right handed circularly-polarized light into another circularly-polarized light, and
wherein the ½ wavelength retardation plate is subjected to biaxial stretching or uniaxial stretching in such a manner that one of two intersecting directions along a plate surface thereof is the low stretching direction or the non-stretching direction and that the other is the high stretching direction or the stretching direction, and furthermore, is subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction.

5. The projection member according to claim 1, further comprising:
a second optical functional layer that imparts an optical effect to light; and
a second optical functional layer carrier that has a plate surface with the second optical functional layer disposed thereon, is directly or indirectly bonded to the optical functional layer carrier, is subjected to biaxial stretching or uniaxial stretching in such a manner that one of two intersecting directions along the plate surface is the low stretching direction or the non-stretching direction and that the other is the high stretching direction or the stretching direction, and furthermore, is subjected to biaxial deformation or uniaxial deformation in such a manner that the large elongation amount direction or the deformation direction matches the low stretching direction or the non-stretching direction and that the small elongation amount direction or the non-deformation direction matches the high stretching direction or the stretching direction.

6. The projection member according to claim 5,
wherein the second optical functional layer is configured of any of an antireflection layer that prevents reflection of light, an ultraviolet ray absorption layer that selectively absorbs ultraviolet rays, and an infrared ray absorption layer that selectively absorbs infrared rays.

7. The projection member according to claim 1, further comprising:
a substrate of a plate shape that has a larger plate thickness than the optical functional layer carrier, is directly or indirectly bonded to the optical functional layer carrier or the optical functional layer, and is subjected to biaxial deformation or uniaxial deformation in such a manner that one of two intersecting directions along a plate surface thereof is the large elongation amount direction or the deformation direction and that the other is the small elongation amount direction or the non-deformation direction.

8. The projection member according to claim 7,
wherein a recess portion of which a plan view shape is a circular shape, an elliptic shape, or a grid shape in a case of the biaxial deformation of the substrate and of which the plan view shape is a straight linear shape extending in a form of following the deformation direction or a grid shape in a case of the uniaxial deformation of the substrate is disposed in the substrate.

9. The projection member according to claim 8,
wherein the recess portion is filled with a transparent resin material that has the same refractive index as the substrate or the optical functional layer carrier.

10. The projection member according to claim 8,
wherein the substrate or the optical functional layer carrier, in which the recess portion is disposed, is arranged on the opposite side of the optical functional layer from a side where the light is supplied.

11. The projection member according to claim 1,
wherein a recess portion of which the plan view shape is a circular shape, an elliptic shape, or a grid shape in a case of the biaxial deformation of the optical functional layer carrier and of which the plan view shape is a straight linear shape extending in a form of following the deformation direction or a grid shape in a case of the uniaxial deformation of the optical functional layer carrier is disposed in the optical functional layer carrier.

12. A method for manufacturing a projection member, the method comprising:
a stretching step of performing biaxial stretching or uniaxial stretching of an optical functional layer carrier of a plate shape in such a manner that one of two intersecting directions along a plate surface of the optical functional layer carrier is a low stretching direction in which a stretch ratio is relatively low or a non-stretching direction in which stretching is not performed and that the other is a high stretching direction in which the stretch ratio is relatively high or a stretching direction in which stretching is performed;
an optical functional layer forming step of forming an optical functional layer on the plate surface of the optical functional layer carrier in a flat state; and
a deforming step of deforming the optical functional layer carrier along with the optical functional layer to make the plate surface have a curved shape by biaxial deformation or uniaxial deformation in such a manner that a large elongation amount direction in which the amount of elongation by deformation is relatively large or a deformation direction in which deformation is generated matches the low stretching direction or the non-stretching direction and that a small elongation amount direction in which the amount of elongation by deformation is relatively small or a non-deformation direction in which deformation is not generated matches the high stretching direction or the stretching direction.

13. The method for manufacturing a projection member according to claim 12, further comprising:
a substrate bonding step of directly or indirectly bonding the optical functional layer to a substrate of a plate shape having a larger plate thickness than the optical functional layer carrier, the substrate bonding step being performed between the optical functional layer forming step and the deforming step; and
a carrier detaching step of detaching the optical functional layer carrier from the optical functional layer, the carrier detaching step being performed after at least the deforming step has been performed.

14. The method for manufacturing a projection member according to claim 12, further comprising:
a substrate bonding step of directly or indirectly bonding the optical functional layer carrier or the optical functional layer to a substrate of a plate shape having a larger plate thickness than the optical functional layer carrier, the substrate bonding step being performed between the optical functional layer forming step and the deforming step;
a recess portion forming step of forming a recess portion in at least any one of a plate surface of the optical functional layer carrier on the opposite side from the optical functional layer side and a plate surface of the substrate on the opposite side from the optical functional layer carrier or optical functional layer side, the recess portion forming step being performed prior to at least the deforming step, the plan view shape of the recess portion being a circular shape, an elliptic shape, or a grid shape in a case of the biaxial deformation in the deforming step, and the plan view shape of the recess portion being a straight linear shape extending in a form of following the deformation direction or a grid shape in a case of the uniaxial deformation in the deforming step; and
a recess portion removing step of removing the recess portion, the recess portion removing step being performed after at least the deforming step has been performed.

15. The method for manufacturing a projection member according to any one of claim 12,
wherein in the stretching step, the optical functional layer carrier is heated to a predetermined heat setting temperature, and
in the deforming step, the optical functional layer carrier and the optical functional layer are subjected to thermal pressing in a temperature environment of higher than or equal to a glass transition temperature of the optical functional layer carrier and less than or equal to the heat setting temperature in the stretching step.
